(19) United States
(12) Patent Application Publication
(10) Pub. No.: US 2026/0213984 A1
(43) Pub. Date: Jul. 23, 2026

(54) OOK MODULATION-BASED SYMBOL GENERATION METHOD, OOK MODULATION-BASED SYMBOL RECEIVING METHOD, DEVICE, AND MEDIUM

(71) Applicant: GUANGDONG OPPO MOBILE TELECOMMUNICATIONS CORP., LTD., Dongguan (CN)

(72) Inventors: Shengjiang CUI, Dongguan (CN); Weijie XU, Dongguan (CN)

(21) Appl. No.: 19/569,929

(22) Filed: Mar. 17, 2026

Related U.S. Application Data
(63) Continuation of application No. PCT/CN2023/126585, filed on Oct. 25, 2023.

(51) Int. Cl. H04L 27/02; H04L 1/00; H04L 27/26

(52) U.S. Cl. CPC H04L 27/02; H04L 1/0008; H04L 1/0071; H04L 27/2639

(57) ABSTRACT

An OOK modulation-based symbol generation method includes: obtaining a first sequence with a length of M, M being a positive integer; and performing OOK modulation on the first sequence to obtain M OOK symbols. The OOK modulation includes performing phase randomization during modulation.

### CROSS-REFERENCE TO RELATED APPLICATION

This application is a Continuation Application of International Application No. PCT/CN 2023/126585 filed Oct. 25, 2023, which is incorporated herein by reference in its entirety.

### TECHNICAL FIELD

The embodiments of the present disclosure relate to the field of wireless communications, and in particular, to an on off keying (OOK) modulation-based symbol generation method, an OOK modulation-based symbol receiving method, a device, and a medium.

### BACKGROUND

Ambient internet of things (IoT) devices obtain power for communications by harvesting ambient energy, which may be energy such as radio frequency, solar energy, thermal energy, and mechanical energy. Compared to traditional terminals with batteries, the communications of the ambient IoT devices can be affected by their energy states.

How to design a waveform for the ambient IoT device to transmit or receive is an unsolved technical problem.

### SUMMARY

The embodiments of the present disclosure provide an OOK modulation-based symbol generation method, an OOK modulation-based symbol receiving method, a device, and a medium. The technical solutions are as follows.

In an aspect, embodiments of the present disclosure provide an OOK modulation-based symbol generation method, and the method includes:
obtaining a first sequence with a length of M, M being a positive integer; and
performing OOK modulation on the first sequence to obtain M OOK symbols;
where the OOK modulation includes performing phase randomization during modulation.

In another aspect, embodiments of the present disclosure provide a terminal, and the terminal includes a memory, and a processor, where the memory is configured to store a program, and the program, when executed by the processor, enables the terminal to perform:
obtaining a first sequence with a length of M, M being a positive integer; and
performing OOK modulation on the first sequence to obtain M OOK symbols;
where the OOK modulation includes performing phase randomization during modulation.

In another aspect, embodiments of the present disclosure provide a chip, and the chip includes a programmable logic circuit and/or program instructions; when run on a terminal or a network device, the chip is configured to implement the OOK modulation-based symbol generation method.

### BRIEF DESCRIPTION OF THE DRAWINGS

FIG. 1 shows a schematic diagram of a communication system provided in the related technologies;

FIG. 2 shows a schematic diagram of radio frequency power harvesting provided in the related technologies;

FIG. 3 shows a schematic diagram of a backscattering communication process provided in the related technologies;

FIG. 4 shows a schematic diagram of resistive load modulation provided in the related technologies;

FIG. 5 shows a schematic diagram of encoding methods provided in the related technologies;

FIG. 6 shows a schematic structural diagram of a cellular communication system provided in embodiments of the present disclosure;

FIG. 7 shows a schematic structural diagram of a WIFI system provided in embodiments of the present disclosure;

FIG. 8 shows a flowchart of an OOK modulation-based symbol generation method provided in embodiments of the present disclosure;

FIG. 9 shows a flowchart of an OOK modulation-based symbol generation method provided in embodiments of the present disclosure;

FIG. 10 shows a flowchart of an OOK modulation-based symbol generation method provided in embodiments of the present disclosure;

FIG. 11 shows a flowchart of an OOK modulation-based symbol generation method provided in embodiments of the present disclosure;

FIG. 12 shows a flowchart of an OOK modulation-based symbol generation method provided in embodiments of the present disclosure;

FIG. 13 shows a flowchart of an OOK modulation-based symbol generation method provided in embodiments of the present disclosure;

FIG. 14 shows a flowchart of an OOK modulation-based symbol generation method provided in embodiments of the present disclosure;

FIG. 15 shows a flowchart of an OOK modulation-based symbol generation method provided in embodiments of the present disclosure;

FIG. 16 shows a flowchart of an OOK modulation-based symbol generation method provided in embodiments of the present disclosure;

FIG. 17 shows a flowchart of an OOK modulation-based symbol generation method provided in embodiments of the present disclosure;

FIG. 18 shows a flowchart of an OOK modulation-based symbol generation method provided in embodiments of the present disclosure;

FIG. 19 shows a flowchart of an OOK modulation-based symbol generation method provided in embodiments of the present disclosure;

FIG. 20 shows a flowchart of an OOK modulation-based symbol generation method provided in embodiments of the present disclosure;

FIG. 21 shows a flowchart of an OOK modulation-based symbol generation method provided in embodiments of the present disclosure;

FIG. 22 shows a flowchart of an OOK modulation-based symbol generation method provided in embodiments of the present disclosure;

FIG. 23 shows a flowchart of an OOK modulation-based symbol generation method provided in embodiments of the present disclosure;

FIG. 24 shows a flowchart of an OOK modulation-based symbol generation method provided in embodiments of the present disclosure;

FIG. 25 shows a flowchart of an OOK modulation-based symbol receiving method provided in embodiments of the present disclosure;

FIG. 26 shows a structural block diagram of an OOK modulation-based symbol generation device provided in embodiments of the present disclosure;

FIG. 27 shows a structural block diagram of an OOK modulation-based symbol generation device provided in embodiments of the present disclosure;

FIG. 28 shows a structural block diagram of an OOK modulation-based symbol generation device provided in embodiments of the present disclosure;

FIG. 29 shows a structural block diagram of an OOK modulation-based symbol generation device provided in embodiments of the present disclosure;

FIG. 30 shows a structural block diagram of an OOK modulation-based symbol receiving device provided in embodiments of the present disclosure; and

FIG. 31 shows a schematic structural diagram of a communication device provided in embodiments of the present disclosure.

### DETAILED DESCRIPTION

The technical solutions in the embodiments of the present disclosure will be described below with reference to the accompanying drawings in the embodiments of the present disclosure. Obviously, the described embodiments are merely some but not all embodiments of the present disclosure. All other embodiments obtained by a person of ordinary skill in the art without paying creative efforts shall be included in the protection scope of the present disclosure.

The technical solutions described in some embodiments of the present disclosure can be applied to various communication systems, such as a global system of mobile communication (GSM), a code division multiple access (CDMA) system, a wideband code division multiple access (WCDMA) system, a general packet radio service (GPRS) system, a long term evolution (LTE) system, an advanced long term evolution (LTE-A) system, a new radio (NR) system, an evolution system of the NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN) system, a wireless fidelity (WIFI) system, a 5th-generation (5G) communication system, a cellular IoT system, a cellular passive IoT system, or can be applied to a subsequent evolution system of a 5G NR system, as well as a 6G system and a subsequent evolution system of the 6G system.

It should be understood that, in some embodiments of the present disclosure, “5G” may also be referred to as “5G NR” or “NR”.

It should be understood that, in the description of the embodiments of the present disclosure, the term “correspond” may indicate a direct or indirect correspondence between the two, or an association relationship between the two, or indicate a relationship such as indicating and being indicated, or configuring and being configured.

In the embodiments of the present disclosure, “pre-defined” may be implemented by pre-storing corresponding codes, tables or other methods that can be used to indicate related information in devices (e.g., including a terminal device and a network device), and its specific implementation is not limited in the present disclosure. For example, “pre-defined” may refer to what is defined in the protocol.

In the embodiments of the present disclosure, “protocol” may refer to standard protocols in the field of communications, which may include, for example, an LTE protocol, an NR protocol, an IoT protocol, and related protocols applied in future communication systems, and the present disclosure does not limit this.

The terminal device involved in the embodiments of the present disclosure can be an active device, which is a device that has its own power supply and is capable of actively generating and transmitting signals, such as a mobile phone, a computer, a smartwatch, a smart bracelet; or the terminal device can be a passive device, which is a device that does not require power supply or is capable of working by receiving energy from other devices, and can be referred to as a zero-power device, a zero-power terminal, a low-power device, or a low-power terminal; or the terminal device can be a device that obtains energy from the environment, and can be referred to as an ambient IoT device; or the terminal device can be a device deployed in a fixed location, and can be referred to as a zero-power station or a low-power station; or the terminal device can be a terminal with a low-power wake-up receiver (LP-WUR) in a cellular system, or a station (STA) with a wake-up receiver (WUR) in a WIFI system.

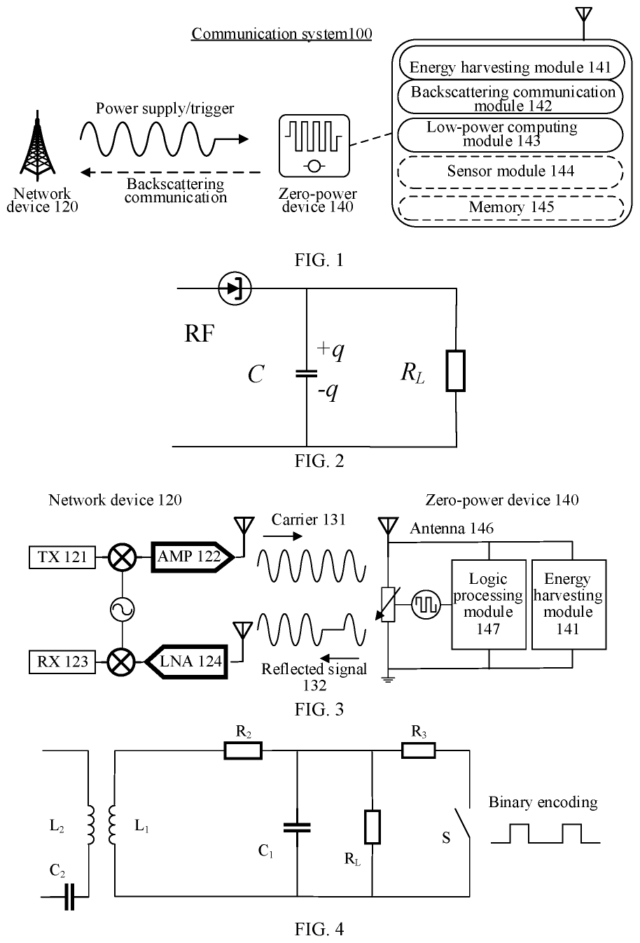

FIG. 1 shows a schematic diagram of a communication system 100 provided in the related technologies. The communication system 100 includes network device(s) 120 and zero-power devices 140.

The network device 120 is configured to transmit wireless power supply signals and downlink communication signals to the zero-power devices 140, and to receive backscattering signals from the zero-power devices 140. The zero-power device 140, also referred to as an ambient IoT device or AMP device, includes an energy harvesting module 141, a backscattering communication module 142 and a low-power computing module 143. The energy harvesting module 141 can harvest energy carried in radio waves (wireless signals) in space, to drive the low-power computing module 143 of the zero-power device 140 and complete the backscattering communication. After obtaining the energy, the zero-power device 140 can receive control signalling from the network device 120 and transmit data to the network device 120 by backscattering according to the control signalling. The transmitted data may be data stored in the zero-power device 140 itself (for example, identification or pre-written information such as the production date, brand, and manufacturer of the product).

The zero-power device 140 may further include a sensor module 144 and a memory 145. The sensor module 144 can include various sensors, and the zero-power device 140 can report the data collected by the various sensors based on the zero-power mechanism. The memory 145 is configured to store some basic information (such as item identification) or to obtain sensor data such as ambient temperature and humidity.

The zero-power device 140 does not require a battery by itself, and uses the low-power computing module 143 to perform simple operations such as signal demodulation, decoding or encoding, and modulation. Therefore, the zero-power module only requires a very simple hardware design, which enables the zero-power device 140 to be very low in cost and small in size.

The network device 120 includes, but is not limited to, a cellular network device (e.g., a 5G/6G network device or a base station device), or a WIFI/WLAN network device (e.g., an access point (AP), a router, a mobile access point, etc., where the mobile access point is, for example, a mobile phone).

The zero-power devices 140 include, but are not limited to, handheld devices, wearable devices, in-vehicle devices, and IoT devices. The zero-power devices 140 may be at least one of the following: mobile phones, tablets, e-book readers, laptop computers, desktop computers, televisions, game consoles, augmented reality (AR) terminals, virtual reality (VR) terminals, mixed reality (MR) terminals, wearable devices, handles, electronic tags, or controllers.

The key technologies of the zero-power communication will be introduced below.

### Radio Frequency Power Harvesting

FIG. 2 shows a schematic diagram of radio frequency power harvesting provided in the related technologies. The radio frequency power harvesting is based on the principle of electromagnetic induction. The radio frequency power harvesting utilizes a radio frequency (RF) module for the electromagnetic induction and is connected to a capacitor C and a load resistor RL that are connected in parallel, to harvest electromagnetic energy in space and obtain the energy required to drive the zero-power device (e.g., to drive a low-power demodulation module, a modulation module, sensors, and memory access. Therefore, the zero-power device does not require the traditional battery.

### Backscattering Communication (Back Scattering)

FIG. 3 shows a schematic diagram of a backscattering communication process provided in the related technologies. The zero-power device 140 receives a wireless signal carrier 131 transmitted by a transmitting module (transmit, TX) 121 of the network device 120 using an amplifier (AMP) 122, modulates the wireless signal carrier 131, loads information to be transmitted using a logic processing module 147, and harvests radio frequency power using the energy harvesting module 141. The zero-power device 140 radiates a modulated reflected signal 132 using an antenna 146, and this information transmission process is called backscattering communication. A receiving module (receive, RX) 123 of the network device 120 receives the modulated reflected signal 132 using a low noise amplifier (LNA) 124. The backscattering and load modulation functions are inseparable. The load modulation adjusts and controls circuit parameters of an oscillation circuit of the zero-power device 140 according to the rhythm of the data stream, thereby changing parameters such as a magnitude of the impedance of the electronic tag and completing the modulation process.

The load modulation technology mainly includes resistive load modulation and capacitive load modulation. FIG. 4 shows a schematic diagram of the resistive load modulation provided in the related technologies. In the resistive load modulation, the load resistor RL is connected in parallel to the third resistor R3, and the switch S controlled based on the binary encoding controls the connection or disconnection of the third resistor R3. The voltage on the circuit can be changed by the connection or disconnection of the third resistor R3. The load resistor RL is connected in parallel to the first capacitor C1 and is connected in series to the second resistor R2, and the second resistor R2 is connected in series to the first inductor L1. The first inductor L1 is coupled to the second inductor L2, and the second inductor L2 is connected in series to the second capacitor C2. This can implement amplitude shift keying (ASK) modulation, i.e., implement signal modulation and transmission by adjusting a magnitude of an amplitude of the backscattering signal of the zero-power device. Similarly, in the capacitive load modulation, a resonant frequency of the circuit can be changed by the connection or disconnection of the capacitor, which implements frequency shift keying (FSK) modulation, i.e., implements signal modulation and transmission by adjusting an operating frequency of the backscattering signal of the zero-power device.

The zero-power device performs information modulation on incoming wave signals by means of load modulation, thereby implementing the backscattering communication process. The zero-power device has significant advantages that: it does not actively transmit signals, and thus a complex RF link is not required (for example, a power amplifier (PA) and a RF filter are not required; it does not actively generate high-frequency signals, and thus a high-frequency crystal oscillator is not required; and it does not consume energy of the zero-power device itself by means of the backscattering communication during signal transmission.

### Ultra-Low-Power Active Transmission Technology

The zero-power device can also use the ultra-low-power active transmission technology. Unlike backscattering, when the zero-power device transmits data using the ultra-low-power active transmission technology, the zero-power device generates an RF carrier using a relatively simple and low-power oscillator and then modulates information to be transmitted onto the RF carrier. Based on current research, the power consumption of an ultra-low-power active transmitter may be as low as hundreds of microwatts, and thus ultra-low-power data transmission may be achieved.

Next, encoding methods for the zero-power communication will be introduced.

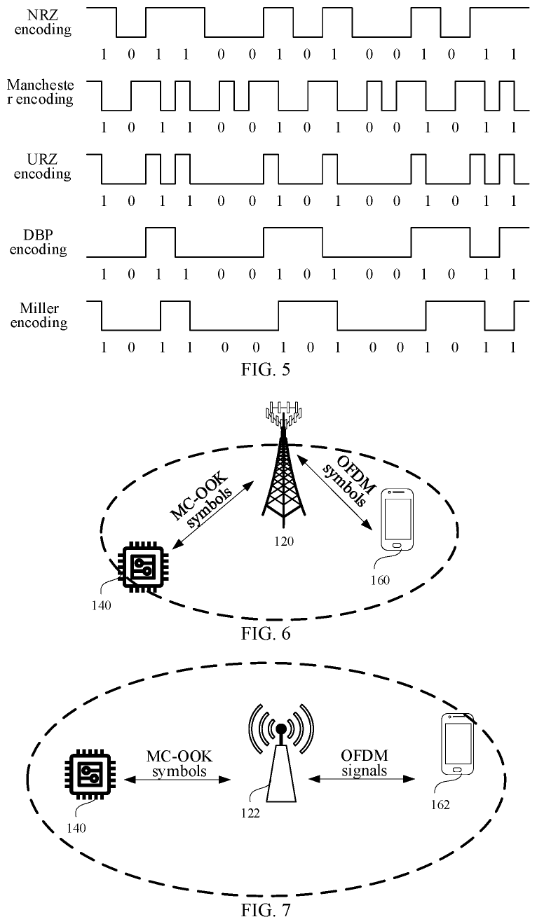

FIG. 5 shows a schematic diagram of encoding methods provided in the related technologies. For the data transmitted by electronic tags, different forms of codes can be used to represent binary “1” and “0”. The RF identification system usually uses one of the following encoding methods: non-return-to-zero (NRZ) encoding, Manchester encoding, unipolar return-to-zero (URZ) encoding, differential binary phase (DBP) encoding, Miller encoding, and differential encoding. That is, different pulse signals can be used to represent 0 and 1.
NRZ encoding: NRZ encoding uses a high level to represent binary “1” and uses a low level to represent binary “0”. NRZ encoding in FIG. 5 illustrates levels of binary data 101100101001011 encoded using the NRZ method.
Manchester encoding: Manchester encoding is also referred to as split-phase coding. In Manchester encoding, a value of a bit is represented by a change in a level (increase/decrease) at half of a bit period within a bit length. A negative jump at the half of the bit period represents binary “1”, and a positive jump at the half of the bit period represents binary “0”. Data transmission error means that when data bits simultaneously transmitted by multiple electronic tags have different values, a received increasing edge and a received decreasing edge cancel each other out, resulting in an uninterrupted carrier signal throughout the entire bit length. Within the bit length of Manchester encoding, there cannot be a state that remains unchanged. The reader can use this error to determine the exact location where the collision occurs. Manchester encoding is helpful in detecting errors in data transmission and is commonly used for data transmission from electronic tags to readers when using carrier load modulation or backscattering modulation. Manchester encoding in FIG. 5 illustrates levels of binary data 101100101001011 encoded using the Manchester method.
URZ encoding: in URZ encoding, a high level in a first half of a bit period indicates binary “1”, and a low level signal that is present throughout the entire bit period indicates binary “0”. URZ encoding in FIG. 5 illustrates levels of binary data 101100101001011 encoded using the URZ method.
DBP encoding: in DBP encoding, any edge within half of a bit period indicates binary “0”, and any non-edge indicates binary “1”. In addition, the levels are inverted at the beginning of each bit period. For the receiver, a bit beat may be reconstructed more easily. DBP encoding in FIG. 5 illustrates levels of binary data 101100101001011 encoded using the DBP method.
Miller encoding: in Miller encoding, any edge within half of a bit period indicates binary “1”, and a level that is unchanged when experiencing a next bit period indicates binary “0”. The level is changed at the beginning of the bit period. Therefore, for the receiver, a bit beat may be reconstructed more easily. Miller encoding in FIG. 5 illustrates levels of binary data 101100101001011 using the Miller method.
Differential encoding: in differential encoding, each binary “1” to be transmitted causes a change in the signal level, while for binary “0”, the signal level remains unchanged.

Next, the classification of zero-power devices will be introduced.

Based on energy sources and usage manners of zero-power devices, the zero-power devices can be classified into the following types.

### Passive Zero-Power Device

The zero-power device does not require a built-in battery. When the zero-power device approaches a network device (e.g., a reader/writer of a radio frequency identification (RFID) system), the zero-power device is within a near-field range formed by radiation of an antenna of the network device. The antenna of the zero-power device generates an induced current through electromagnetic induction, and the induced current drives a low-power chip circuit of the zero-power device, to implement signal demodulation of a forward link, signal modulation of a backward link, etc. For a backscattering link, the zero-power device can transmit signals in a backscattering manner or an ultra-low-power active transmission manner. The passive zero-power device does not require the built-in battery to drive either the forward link or the backward link, and is a true zero-power device. The passive zero-power device does not require the battery, and an RF circuit and a baseband circuit of the passive zero-power device are both very simple. For example, the passive zero-power device does not require an LNA, a PA, a crystal oscillator, an analog-to-digital converter (ADC), etc. Therefore, the passive zero-power device has many advantages such as small size, light weight, very low price, and long service life.

### Semi-Passive Zero-Power Device

The semi-passive zero-power device itself is not equipped with a conventional battery, but can use an RF power harvesting module to harvest radio wave energy; and simultaneously, the semi-passive zero-power device stores the harvested energy in an energy storage unit (such as a capacitor). The energy storage unit, after obtaining the energy, can drive a low-power chip circuit of the zero-power device, to implement signal demodulation of a forward link, signal modulation of a backward link, etc. For a backscattering link, the zero-power device can transmit signals in a backscattering manner or an ultra-low-power active transmission manner.

The semi-passive zero-power device does not require the built-in battery to drive either the forward link or the backward link. The energy stored in the capacitor is used in operation, and comes from the radio energy harvested by the RF power harvesting module. Therefore, the semi-passive zero-power device is a true zero-power device. The semi-passive zero-power device inherits many of the advantages of the passive zero-power device such as small size, light weight, very low price, and long service life.

### Active Zero-Power Device

The zero-power device used in some scenarios may also be an active zero-power device. This type of zero-power devices can have built-in batteries. The battery is used to drive a low-power chip circuit of the zero-power device, to implement signal demodulation of a forward link, signal modulation of a backward link, etc. However, for a backscattering link, the zero-power device transmits signals in a backscattering manner or an ultra-low-power active transmission manner. Therefore, the zero power of the active zero-power device is mainly reflected in the fact that the signal transmission of the backward link does not consume the power of the zero-power device itself, but uses the backscattering manner. The active zero-power device has the built-in battery for supplying power to the RFID chip, so as to increase a reading and write distance of a tag, thereby improving communication reliability. Therefore, the active zero-power device may be applied in some scenarios with relatively high requirements for a communication distance, a reading delay, etc.

Next, the classification of zero-power devices based on types of transmitters will be introduced.

### (1) Zero-Power Device Based on Backscattering

This type of zero-power devices transmits uplink data using the above backscattering manner. This type of zero-power devices is not equipped with an active transmitter for active transmission, but only equipped with a transmitter for backscattering. Therefore, in a case where this type of zero-power devices transmits uplink data, the network device is required to provide a carrier, and this type of zero-power devices performs backscattering based on the carrier to implement uplink data transmission.

### (2) Zero-Power Device Based on Active Transmitter

This type of zero-power devices transmits uplink data using an active transmitter with active transmission capability. Therefore, when transmitting uplink data, this type of zero-power devices can transmit uplink data using their own active transmitters without requiring the network device to provide a carrier. The active transmitter suitable for the zero-power device may be, for example, an ultra-low-power ASK transmitter, an ultra-low-power FSK transmitter, or the like. Based on current implementations, in a case where a signal of 100 μW is transmitted, the overall power consumption of this type of transmitters may be reduced to 400 μW to 600 μW.

### (3) Zero-Power Device With Both Backscattering and Active Transmitter

This type of zero-power devices can support both backscattering and an active transmitter. The zero-power device can determine, depending on different situations (e.g., different power level conditions, different available ambient energy conditions, etc.) or based on scheduling of the network device, whether to use the backscattering manner or the active transmitter for active transmission.

Next, cellular IoT will be introduced.

The cellular IoT is booming. For example, the 3rd-generation partnership project (3GPP) has standardized IoT technologies such as narrowband-internet of things (NB-IoT), machine-type communication (MTC), and RedCap. However, IoT communication requirements in various scenarios remain unmet, as described below.

### Harsh Communication Environment

Certain IoT scenarios may face extreme environments, such as high temperature, extremely low temperature, high humidity, high pressure, high radiation, or high-speed movement. Examples include ultra-high voltage substations, high-speed train track monitoring, environmental monitoring in high-cold areas, industrial production lines, etc. In these scenarios, IoT terminal devices cannot work due to the limitation of working environments of conventional power supplies. In addition, extreme working environments are also detrimental to the maintenance of the IoT terminal devices, e.g., battery replacement.

### Terminal Form Requirements With Extremely Small Size

Sizes of terminals are required to be extremely small in certain IoT communication scenarios, such as food traceability, commodity circulation, and smart wearables, to facilitate use in these scenarios. For example, IoT terminal devices used for commodity management in the circulation process usually take a form of electronic tags, which are embedded in the commodity packaging in a very small form. For another example, lightweight wearable IoT terminal devices may enhance user experience while meeting user needs.

### IoT Communication Requirements With Extremely Low-Cost

Cost of IoT terminal devices is required to be sufficiently low in numerous IoT communication scenarios, thereby enhancing competitiveness thereof relative to other alternative technologies. For example, in logistics or warehousing scenarios, to facilitate the management of the large number of circulating items, an IoT terminal device may be attached to each item, so that the accurate management of the entire logistics process and lifecycle may be completed through the communication between the IoT terminal device and a logistics network. Prices of IoT terminal devices are required to be sufficiently competitive in these scenarios.

Therefore, in order to fulfill these unmet IoT communication requirements, it is also necessary to develop IoT with ultra-low-cost, extremely small size, battery-free/maintenance-free in the cellular IoT, and zero-power IoT may exactly meet these requirements.

Zero-power IoT is also known as ambient IoT or passive IoT. Ambient IoT devices refer to IoT devices capable of using kinds of ambient energy (such as RF power, light energy, solar energy, thermal energy, mechanical energy) to drive themselves. This type of devices can have no energy storage capability or can have very limited energy storage capability (e.g., using capacitors with a capacitance of tens of microfarads). Compared to existing IoT devices, ambient IoT devices have a lot of advantages, such as no conventional batteries, maintenance-free, small size, low complexity, low cost, and long service life cycle.

Zero-power IoT may be used in at least the following four types of scenarios:
(1) object recognition, such as management of logistics and production line product, and supply chain management;
(2) environmental monitoring, such as monitoring of temperature, humidity and harmful gases in working environments and natural environments;
(3) positioning, such as indoor positioning, intelligent object search, and production line item positioning; and
(4) intelligent control, such as intelligent control of various electrical appliances in smart homes (turning air conditioners on/off and adjusting temperature), and intelligent control of various facilities in agricultural greenhouses (automatic irrigation and fertilization).

### Ambient IoT devices

In NR and WIFI systems, the battery-free and low-cost of devices enables low-cost and mass deployment of devices (e.g., IoT devices) and maintenance-free. The current standard is researching how to support ambient energy-based IoT devices (referred to as ambient IoT devices or AMP IoT devices) in the NR and WIFI systems. The energy required for their operations comes from ambient energy harvesting, and the sources of the ambient energy can be wireless signals, solar energy, thermal energy, etc. This type of devices are similar to passive or semi-passive devices in zero-power communications.

A research project on ambient IoT devices is carried out in 3GPP RAN, in which the ambient IoT devices are roughly divided into three types of devices: device A, device B and device C, each with corresponding complexity and communication capability.
Device A: It does not have energy storage capacity and cannot independently transmit signals; that is, it uses a backscattering transmission manner.
Device B: It has energy storage capacity but cannot independently transmit signals; that is, it uses a backscattering transmission manner and can use the stored energy to amplify backscattering signals.
Device C: It has energy storage capacity and is capable of transmitting signals independently; that is, it has active transmission capability.

Device A has the lowest complexity and power consumption, and the power consumption may be as low as 1 μW, but its communication distance is limited, generally only a few meters. Device A requires the network device to provide carrier signals for backscattering transmission. Device C generally has a large-capacity capacitor to store energy from environments, can support power consumption of several hundred μW, can support active signal transmission, and has a long communication distance. Device C does not require the network device to provide carrier signals due to the active transmission. The complexity and power consumption of device B are between those of device A and device C.

In addition, zero-power terminals can support harvesting various types of ambient energy, such as RF, solar energy, thermal energy, and mechanical energy. Zero-power terminals based on RF power harvesting may require the network to provide RF power supply signals.

FIG. 6 shows a schematic structural diagram of a cellular communication system provided in an exemplary embodiment of the present disclosure. The cellular communication system includes: a network device 120, an ambient IoT device 140, and a terminal device 160.

The network device 120 may be an access network device in the cellular communication system, such as a base station. Transmission is performed between the network device 120 and the terminal device 160 through orthogonal frequency-division multiplexing (OFDM) symbols. Transmission is performed between the ambient IoT device 140 and the network device 120 through OOK symbols. Transmission is performed between the ambient IoT device 140 and the terminal device 160 through OOK symbols.

FIG. 7 shows a schematic structural diagram of a WIFI system provided in an exemplary embodiment of the present disclosure. The WIFI system includes: an AP 122, an ambient IoT device 140, and a STA 162.

Transmission is performed between the AP 122 and the STA 162 through OFDM symbols. Transmission is performed between the ambient IoT device 140 and the AP 122 through OOK symbols. Transmission is performed between the ambient IoT device 140 and the STA 162 through OOK symbols.

The method provided in the embodiments of the present disclosure can be applied to uplink data transmission (ambient IoT device=>network device/AP), downlink data transmission (network device/AP=>ambient IoT device), and sidelink data transmission. The sidelink data transmission includes at least one of the following four forms: ambient IoT device=>other terminal device, other terminal device=>ambient IoT device, ambient IoT device=>ambient IoT device, or other terminal device=>other terminal device.

In some embodiments, the method provided in the embodiments of the present disclosure can be applied not only to ambient IoT devices, but also to LP-WUR/WUS scenarios. That is, for the low-power wake-up signal (LP-WUS) sent by the network device to the LP-WUR, the method provided in the embodiments of the present disclosure can also be used.

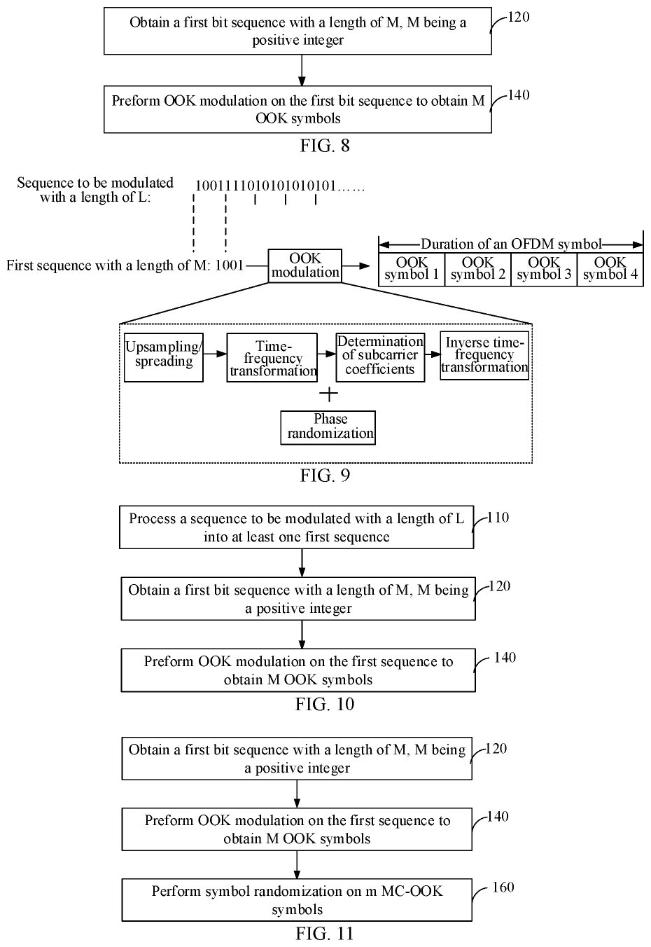

FIG. 8 shows a flowchart of an OOK modulation-based symbol generation method provided in an exemplary embodiment of the present disclosure. The method is executed by a network device, an AP, an ambient IoT device, or a terminal device, and the method includes the following steps.

In step 120, a first sequence with a length of M is obtained, M being a positive integer.

M is the number of OOK symbols transmitted within a preset duration. The preset duration is determined by the basic time-domain unit in the cellular communication system or WIFI system. In some embodiments, the preset duration is 1 OFDM symbol, and 1 OFDM symbol can transmit M OOK symbols. M is the number of OOK symbols transmitted within an OFDM symbol.

In some embodiments, M may be agreed upon by a protocol, or configured by a network device, or determined by a terminal device based on a preset mapping relationship.

In some embodiments, there are multiple candidate values for M, e.g., M={1, 2, 4, 6, 8}.

In some embodiments, referring to FIG. 9, the sequence to be modulated is a sequence with a length of L, and the sequence to be modulated is preprocessed according to the principle of every M bits forming a single first sequence, to obtain multiple first sequences, each first sequence including M bits. OOK modulation is performed on each first sequence.

In step 140, OOK modulation is performed on the first sequence to obtain M OOK symbols.

The OOK modulation is a process of modulating a digital sequence into a wireless signal with a multicarrier on off keying (MC-OOK) waveform. The OOK modulation is performed on the first sequence to obtain M OOK symbols.

The OOK modulation includes performing phase randomization during modulation. The phase randomization is a process of processing the first sequence or intermediate data using a phase randomization factor or a phase randomization sequence. The intermediate data is intermediate process data generated during the OOK modulation of the first sequence.

In the embodiments, the phase randomization is added in the OOK modulation process, which can flatten the spectrum energy and improve frequency selectivity and anti-interference capability.

In some embodiments, referring to FIG. 9, the OOK modulation includes at least one of: first processing (upsampling/spreading), time-frequency transformation, determination of subcarrier coefficients, or inverse time-frequency transformation.

The first processing is to convert each bit (also referred to as a logical bit) or element in a sequence into a sequence with a length of K, K being a positive integer greater than 1. The first processing includes at least one of upsampling or spreading. Taking spreading as an example, the spreading refers to a process of repeating each bit or element in a sequence K times. For example, a sequence is {1, 0, 0, 1}, a spreading factor K is equal to 4 (i.e., K=4), and then a second sequence is {1, 1, 1, 1, 0, 0, 0, 0, 0, 0, 0, 0, 1, 1, 1, 1}.

The time-frequency transformation, also known as discrete Fourier transform (DFT), refers to a process of transforming a sequence in the time-domain into frequency-domain data of a plurality of samples.

The determination of subcarrier coefficients refers to a process of determining coefficients of multiple subcarriers during transmission based on the frequency-domain data of the plurality of samples. That is, the determination of subcarrier coefficients is a process of modulating the frequency-domain data after the time-frequency transformation onto the multiple subcarriers.

The inverse time-frequency transformation, also known as inverse DFT (IDFT), refers to a process of converting the frequency-domain data of the plurality of samples into time-domain data of the plurality of samples.

In the embodiments of the present disclosure, the phase randomization is further added in the OOK modulation process. In some embodiments, there may be multiple optional designs for processing timing of the phase randomization.

Optional design 1: the phase randomization is performed before the first processing.

First phase randomization, the first processing, the time-frequency transformation, the determination of subcarrier coefficients, and the inverse time-frequency transformation are sequentially performed on the first sequence to obtain M OOK symbols.

Optional design 2: the phase randomization is performed after the first processing and before the time-frequency transformation.

The first processing, second phase randomization, the time-frequency transformation, the determination of subcarrier coefficients, and the inverse time-frequency transformation are sequentially performed on the first sequence to obtain the M OOK symbols.

Optional design 3: the phase randomization is performed after the inverse time-frequency transformation.

The first processing, the time-frequency transformation, the determination of subcarrier coefficients, the inverse time-frequency transformation, and third phase randomization are sequentially performed on the first sequence to obtain the M OOK symbols.

Optional design 4: the phase randomization is performed after the determination of subcarrier coefficients and before the inverse time-frequency transformation.

The first processing, the time-frequency transformation, the determination of subcarrier coefficients, fourth phase randomization, and the inverse time-frequency transformation are sequentially performed on the first sequence to obtain the M OOK symbols.

Optional design 5: the phase randomization is incorporated into the first processing, and sequence mapping is used to complete the first processing.

The sequence mapping, the time-frequency transformation, the determination of subcarrier coefficients, and the inverse time-frequency transformation are sequentially performed on the first sequence to obtain the M OOK symbols. The sequence mapping is a mapping process that maps bits in the first sequence to a phase randomization sequence.

In some embodiments, optional design 3 can also be combined with optional design 1, optional design 2, optional design 4 and optional design 5 to form new embodiments. That is, after the inverse time-frequency transformation in optional design 1, optional design 2, optional design 4 and optional design 5, the third phase randomization is performed, the description is as follows.

Optional design 6: the first phase randomization, the first processing, the time-frequency transformation, the determination of subcarrier coefficients, the inverse time-frequency transformation, and the third phase randomization are sequentially performed on the first sequence to obtain the M OOK symbols.

Optional design 7: the first processing, the second phase randomization, the time-frequency transformation, the determination of subcarrier coefficients, the inverse time-frequency transformation, and the third phase randomization are sequentially performed on the first sequence to obtain the M OOK symbols.

Optional design 8: the first processing, the time-frequency transformation, the determination of subcarrier coefficients, the fourth phase randomization, the inverse time-frequency transformation, and the third phase randomization are sequentially performed on the first sequence to obtain the M OOK symbols.

Optional design 9: the sequence mapping, the time-frequency transformation, the determination of subcarrier coefficients, the inverse time-frequency transformation, and the third phase randomization are sequentially performed on the first sequence to obtain the M OOK symbols.

In a further embodiment based on the embodiment shown in FIG. 8, the first sequence with the length of M is obtained by preprocessing a sequence to be modulated, which has a length of L. As shown in FIG. 10, the above method further includes the following step.

In step 110, a sequence to be modulated with a length of L is processed into at least one first sequence, L being greater than or equal to M.

The sequence to be modulated can be of any length. Normally, L is greater than or equal to M, but the possibility of L being less than M cannot be ruled out.

In some embodiments, the sequence to be modulated with the length of L is any one of the following sequences:
an original sequence;
a first encoded sequence obtained by encoding the original sequence;
a first padding sequence with a length being an integer multiple of M obtained by performing bit-padding on the original sequence;
a second padding sequence with a length being an integer multiple of M obtained by performing bit-padding on the first encoded sequence;
a second encoded sequence obtained by encoding the first padding sequence;
a sequence obtained by interleaving the original sequence;
a sequence obtained by interleaving the first encoded sequence;
a sequence obtained by interleaving the first padding sequence;
a sequence obtained by interleaving the second padding sequence; or
a sequence obtained by interleaving the second encoded sequence.

Bit-padding refers to a process of adding a bit with a preset value to the beginning or end of a sequence, e.g., adding a bit with a value of 0 or a bit with a value of 1 to the end of the sequence.

Interleaving is a process that swaps or scrambles bits located at different bit positions in a sequence. For symbols that are adjacent before interleaving, after interleaving, the minimum distance between the symbols is referred to as the interleaving depth; and for symbols that are adjacent after interleaving, before interleaving, the minimum distance between the symbols is referred to as the interleaving width.

In some embodiments, M is agreed upon by a communication protocol, or configured by a network device, or determined based on a preset mapping relationship. For example, different values of M are used depending on different lengths of L. For example, L is less than 200, and M=2; or L is greater than 200 and less than 400, and M=4. In some embodiments, the value(s) of M include at least one of 1, 2, 4, 6, or 8.

In some embodiments, in a case where L is an integer multiple of M, the sequence to be modulated with the length of L is divided into a plurality of first sequences according to a dividing manner of every M bits.

In some embodiments, in a case where L is not an integer multiple of M, the sequence to be modulated with the length of L is processed into a sequence with a length of L′, L′ being an integer multiple of M; and the sequence with the length of L′ is divided into a plurality of sequences with the length of M. For example, the sequence to be modulated with the length of L is processed into the sequence with the length of L′ through bit-padding and/or encoding.

In some embodiments, the value of M can be changed or adjusted to enable L to be an integer multiple of M. That is, in a case where L is not an integer multiple of M, M is updated to be a divisor of L.

In summary, in the method provided in the embodiments, variable rate is achieved by flexibly controlling the value of M. M=2 represents 1 OFDM symbol transmitting 2 OOK symbols; M=4 represents 1 OFDM symbol transmitting 4 OOK symbols; and M=8 represents 1 OFDM symbol transmitting 8 OOK symbols. That is, when the duration of an OFDM symbol is the same, the transmission rates of OOK symbols are different depending on different values of M.

In a further embodiment based on the above embodiment shown in FIG. 8 or 10, as shown in FIG. 11, the method further includes the following step.

In step 160, symbol randomization (symbol randomizer) is performed on m OOK symbols.

The symbol randomization can effectively eliminate spectral lines in power spectral density (PSD). In a case where multiple OOK symbols are transmitted for the duration of each OFDM symbol, m OOK symbols are generated each time through allocated N subcarriers.

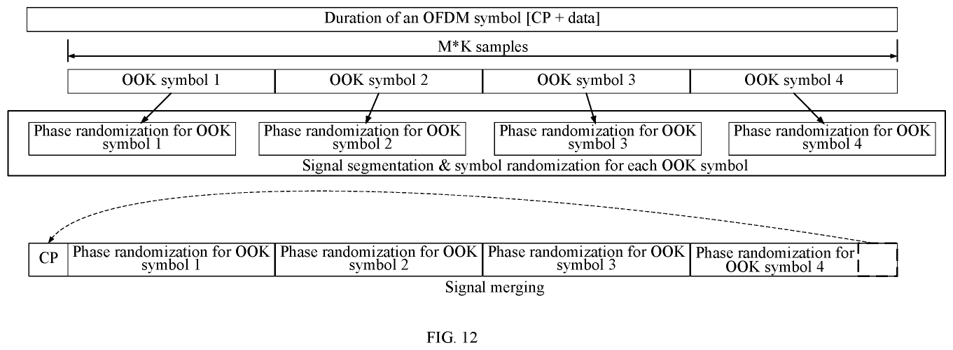

In some embodiments, referring to FIG. 12, the symbol randomization may be performed using either of the following two methods.

Method 1: the symbol randomization is performed on each of the m OOK symbols.

The symbol randomization is performed individually on each of the m OOK symbols.

The m OOK symbols undergo the symbol randomization symbol by symbol. That is, a first OOK symbol undergoes the symbol randomization first, and then a second OOK symbol undergoes the symbol randomization; after that, a third OOK symbol undergoes the symbol randomization, and so on.

Method 2: the OOK symbols are divided into first-type symbols and second-type symbols, and the symbol randomization is performed on each of the first-type symbols in the m OOK symbols.

The first-type symbol is an OOK symbol corresponding to a bit with a first value, also known as an “OOK-on” symbol. The second-type symbol is an OOK symbol corresponding to a bit with a second value, also known as an “OOK-off” symbol. For example, the first value is 1, and the second value is 0.

The “OOK-on” symbols in the m OOK symbols undergo the symbol randomization symbol by symbol.

In some embodiments, referring to FIG. 12, before step 160, the method further includes: performing signal segmentation on an entire time-domain signal corresponding to the m OOK symbols, to obtain time-domain signal segments corresponding to the m OOK symbols. In step 160, the time-domain signal segments corresponding to the m OOK symbols undergo the symbol randomization on a per symbol basis or on a per “OOK-on” symbol basis. After step 160, the method further includes: merging the time-domain signal segments (after undergoing the symbol randomization) corresponding to the m OOK symbols.

In some embodiments, the symbol randomization includes at least one of the following operations:
phase randomization;
cyclic shift; or
symbol inversion.

In the symbol randomization process, the phase randomization means that point multiplication is performed on a time-domain signal segment corresponding to a single OOK symbol and a phase randomization sequence, and the phase randomization sequences associated with different OOK symbols are the same or different. The cyclic shift refers to a process of cyclically shifting a time-domain signal segment corresponding to a single OOK symbol, and the cyclic shift values associated with different OOK symbols are the same or different. The symbol inversion means that the symbol inversion or (pseudo) random symbol inversion is performed on a time-domain signal segment corresponding to a single OOK symbol.

### Phase Randomization

Optionally, different OOK symbols use the same phase randomization sequence, and the modulus of each phase randomization factor in the phase randomization sequence is 1. Optionally, different OOK symbols use different phase randomization sequences, and the modulus of each phase randomization factor in the phase randomization sequence is 1. Optionally, some OOK symbols use the same phase randomization sequence, and other OOK symbols use different phase randomization sequences.

In some embodiments, OOK symbols belonging to different groups use different phase randomization sequences, and each group of OOK symbols includes M OOK symbols.

In some embodiments, different phase randomization sequences are obtained by cyclically shifting the same initial phase randomization sequence. Different OOK symbols use the same initial randomization sequence, and when the phase randomization is implemented in practice, the initial randomization sequence undergoes different cyclic shifts, and the cyclically shifted phase randomization sequences are used for processing.

In some embodiments, the phase randomization sequence used is updated on a per OOK symbol basis, or the phase randomization sequence used is updated on a per “OOK-On” symbol basis, or the phase randomization sequence used is updated every M OOK symbols.

### Cyclic Shift

Optionally, different OOK symbols use the same cyclic shift value; or different OOK symbols use different cyclic shift values; or different “OOK-On” symbols use different cyclic shift values; or OOK symbols belonging to different groups use different cyclic shift values, OOK symbols belonging to the same group use the same cyclic shift value, and each group of OOK symbols includes M OOK symbols.

In some embodiments, the cyclic shift values used for different OOK symbols are determined based on a pseudo-random manner. In the case where the cyclic shift values are determined using the pseudo-random manner, the cyclic shift values used for different OOK symbols are completely different, or are partially the same and partially different, or are all the same, each of which may occur.

### Symbol Inversion

Optionally, different OOK symbols use random symbol inversion; or different OOK symbols use regular symbol inversion; or OOK symbols belonging to different groups use random symbol inversion, OOK symbols belonging to the same group use the same symbol inversion, and each group of OOK symbols includes M OOK symbols.

For example, the random symbol inversion may be that a pseudo-random generator is used to generate “1” and “−1”, to determine whether to perform the phase inversion on the OOK symbol. For example, point multiplication is performed on the time-domain signal segment corresponding to the OOK symbol and “1” or “−1” determined by the pseudo-random generator.

For example, the regular symbol inversion may be that the symbol inversion is performed at intervals on “OOK-On” symbols. For example, the (2k+1)-th OOK-On symbol undergoes the phase inversion, while the 2k-th OOK-On symbol does not undergo the phase inversion.

In summary, in the method provided in the embodiments, spectral lines in PSD can be eliminated by using the symbol randomization. In some communication systems (e.g., 802.11) that require the elimination of spectral lines, after processing the OOK symbols through the above symbol randomization, the spectral lines in PSD can be eliminated to meet the communication requirements of these communication systems, and thus ambient IoT devices can be deployed in these communication systems.

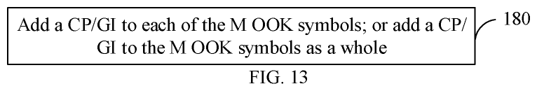

In a further embodiment based on the above embodiment shown in FIGS. 8, 10, or 11, as shown in FIG. 13, the method further includes the following step.

In step 180, a cyclic prefix (CP)/guard interval (GI) is added to each of the M OOK symbols; or a CP/GI is added to the M OOK symbols as a whole.

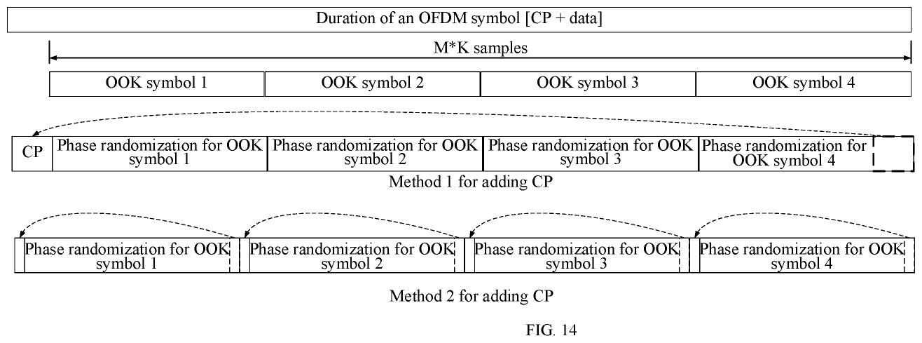

In some embodiments, as shown in Method 1 of FIG. 14, after performing time-domain segmentation (and symbol randomization) on the M OOK symbols, signal merging is performed first, and then the CP/GI is added at the beginning of the entire time-domain signal corresponding to the M OOK symbols.

In some embodiments, as shown in Method 2 of FIG. 14, after performing time-domain segmentation (and symbol randomization) on the M OOK symbols, the CP/GI is added to the time-domain signal segment corresponding to each OOK symbol, and then signal merging is performed on the time-domain signal segments corresponding to the M OOK symbols.

In summary, in the method provided in the embodiments, multipath transmission interference received during the transmission of OOK symbols can be reduced or eliminated by adding the CP/GI to each symbol or to the symbols as a whole, thereby improving the reception quality of OOK symbols.

In a further embodiment based on the above embodiment shown in FIGS. 8, 10, 11, or 13, various optional designs are introduced as follows.

### Optional Design 1

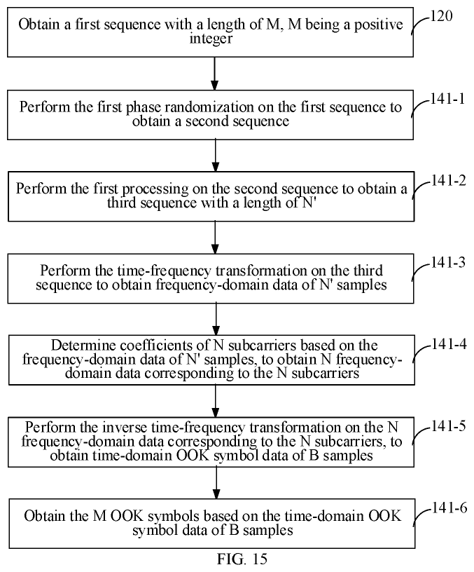

FIG. 15 shows a flowchart of an OOK modulation-based symbol generation method provided in an exemplary embodiment of the present disclosure. The method is executed by a network device, an AP, a zero-power device (e.g., an ambient IoT device), or a terminal device, and the method includes the following steps.

In step 120, a first sequence with a length of M is obtained, M being a positive integer.

M is the number of OOK symbols transmitted within a preset duration. The preset duration is determined by the basic time-domain unit in the cellular communication system or WIFI system. In some embodiments, the preset duration is 1 OFDM symbol, and 1 OFDM symbol can transmit M OOK symbols. M is the number of OOK symbols transmitted within an OFDM symbol.

The first sequence with the length of M is obtained by preprocessing a sequence to be modulated. The number of first sequences with the length of M may be one or multiple, the multiple first sequences being ordered sequentially. The embodiments describe the OOK modulation process for a single first sequence, and the OOK modulation process for multiple first sequences may be deduced by analogy.

The process of performing OOK modulation on a single first sequence to obtain M OOK symbols includes at least one of the following steps 141-1 to 141-6.

In step 141-1, the first phase randomization is performed on the first sequence to obtain a second sequence.

The first sequence includes M bits.

In some embodiments, the first phase randomization may be performed in any one of the following three methods.

Method 1: the phase randomization is performed on each of the M bits.

The phase randomization is performed individually on each of the M bits, with the bit as the execution granularity. An associated phase randomization factor is generated individually for each of the M bits, and the phase randomization factor associated with each bit is independent; each bit is processed based on the associated phase randomization factor. For example, each bit is multiplied by the associated phase randomization factor.

In some embodiments, an i-th phase randomization factor is generated for an i-th bit in the M bits, the i-th bit is associated with the i-th phase randomization factor, and the i-th bit is multiplied by the i-th phase randomization factor. A value of i is in a range of 0 to M−1, or the value of i is in a range of 1 to M.

In some embodiments, the modulus of each phase randomization factor is 1. Each phase randomization factor can be any one of the following: 1, −1, or a complex number containing both a real part and an imaginary part.

For example, the first sequence includes 4 bits, which are {1, 0, 0, 1}; the phase randomization factor associated with the first bit is x₁, the phase randomization factor associated with the second bit is x₂, the phase randomization factor associated with the third bit is x₃, and the phase randomization factor associated with the fourth bit is x₄. Then, the second sequence is {x₁, 0, 0, x₄}.

Method 2: the phase randomization is performed on each target bit in the M bits, the target bit being a bit with a first value.

In some embodiments, the target bit is a bit with a value of 1. Since a bit with a value of 0 will still be 0 after being multiplied by a phase randomization factor, it may be considered that the phase randomization is performed only on the bit(s) with the value of 1.

The phase randomization is performed individually on each target bit in the M bits, with the target bit as the execution granularity. An associated phase randomization factor is generated individually for each target bit in the M bits, and the phase randomization factor associated with each target bit is independent; and each target bit is multiplied by the associated phase randomization factor. For example, an associated phase randomization factor is generated individually for each bit with the value of 1 among the M bits, and each bit with the value of 1 is multiplied by its associated phase randomization factor.

In some embodiments, the modulus of each phase randomization factor is 1. Each phase randomization factor can be any one of the following: 1, −1, or a complex number containing both a real part and an imaginary part.

For example, the first sequence includes 4 bits, which are {1, 0, 0, 1}, and 2 bits have the value of 1; the phase randomization factor associated with the first bit with the value of 1 is x₁, and the phase randomization factor associated with the second bit with the value of 1 is x₂. Then, the second sequence is {x₁, 0, 0, x₂}.

Method 3: the phase randomization is performed on the M bits.

The phase randomization is performed on the M bits as a whole. The M bits are processed using a phase randomization sequence with a length of M. For example, point multiplication is performed on the M bits and the phase randomization sequence with the length of M. The phase randomization sequence with the length of M includes M phase randomization factors.

In some embodiments, the modulus of each phase randomization factor is 1. Each phase randomization factor can be any one of the following: 1, −1, or a complex number containing both a real part and an imaginary part.

For example, the first sequence includes 4 bits, which are {1, 0, 0, 1}, and the phase randomization sequence with the length of M is {x₁, x₂, x₃, x₄}. Then, the second sequence is {x₁, 0, 0, x₄}.

The phase randomization sequence includes M phase randomization factors; or the phase randomization sequence is a PN sequence; or the phase randomization sequence is a ZC sequence; or the phase randomization sequence is an m-sequence; or the phase randomization sequence is a sequence with a peak to average power ratio (PAPR) less than a threshold, also known as a low PAPR sequence.

In step 141-2, the first processing is performed on the second sequence to obtain a third sequence with a length of N′.

By performing the first processing on each element in the second sequence, the third sequence with the length of N′ is obtained, where N′≥N, and N is the number of subcarriers.

The first processing is to convert each element in the second sequence into a sequence with a length of K, K being a positive integer greater than 1. The first processing includes at least one of upsampling or spreading. Taking spreading as an example, the spreading refers to a process of repeating each element in a sequence K times.

In some embodiments, each element is repeated the same number of times; or each element is repeated a different number of times; or some elements are repeated the same number of times and some elements are repeated different numbers of times.

In some embodiments, in an example where the number of spreading times is K and each element is repeated the same number of times, the third sequence with the length of N′ is obtained by continuously repeating each element in the second sequence K times, where N′=K*M. In the third sequence, every K consecutive elements are obtained by repeating a single element in the second sequence K times.

In some embodiments, in an example where the number of spreading times is K and the first M−1 elements are repeated the same number of times, the third sequence with the length of N′ is obtained by continuously repeating each of the first M−1 elements in the second sequence K times and repeating the last element N′−K*(M−1) times. In the third sequence, each of the first M−1 groups of sequences (each group having K consecutive elements) is obtained by spreading a single element in the second sequence, and the last group of sequences (having N′−K*(M−1) consecutive elements) is obtained by spreading the last element in the second sequence.

In step 141-3, the time-frequency transformation is performed on the third sequence to obtain frequency-domain data of N′ samples.

The discrete Fourier transform is performed on the third sequence with the length of N′ to obtain the frequency-domain data of N′ samples.

In step 141-4, coefficients of N subcarriers are determined based on the frequency-domain data of N′ samples, to obtain N frequency-domain data corresponding to the N subcarriers.

When N′=N, a coefficient of a j-th subcarrier is determined based on frequency-domain data of a j-th sample, where a value of j is in a range of 0 to N−1 or in a range of 1 to N; and the N frequency-domain data corresponding to the N subcarriers are obtained.

When N′>N, the frequency-domain data of N′ samples is truncated to frequency-domain data of N samples (for example, only frequency-domain data of the first or last N samples are taken); a coefficient of a j-th subcarrier is determined based on frequency-domain data of a j-th sample, where a value of j is in a range of 0 to N−1 or in a range of 1 to N; and the N frequency-domain data corresponding to the N subcarriers are obtained.

The process of determining the coefficients of N subcarriers during transmission based on the frequency-domain data of N samples means that the frequency-domain data of N samples after the time-frequency transformation is modulated onto the N subcarriers.

In step 141-5, the inverse time-frequency transformation is performed on the N frequency-domain data corresponding to the N subcarriers, to obtain time-domain OOK symbol data of B samples.

The discrete inverse Fourier transform is performed on the N frequency-domain data corresponding to the N subcarriers, to obtain the time-domain OOK symbol data of B samples.

In some embodiments, B is greater than or equal to N. In some embodiments, B is an integer multiple of M. In some embodiments, B is a power of 2. For example, N represents 48 subcarriers, and B represents time-domain OOK symbol data of 1024 samples.

In step 141-6, the M OOK symbols are obtained based on the time-domain OOK symbol data of B samples.

Taking B as an integer multiple of M as an example, each OOK symbol carries time-domain OOK symbol data of B/M samples.

In summary, in the method provided in the embodiments, energy flattening at the subcarrier level or bit level is achieved by performing the first phase randomization with the bit in the first sequence as the granularity, thereby improving frequency selectivity and anti-interference capability.

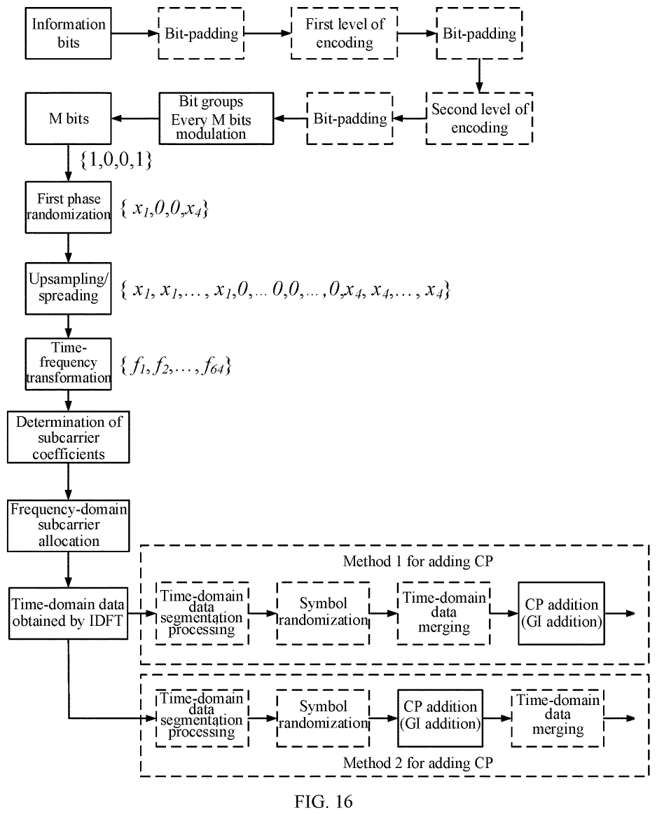

As an exemplary embodiment of Optional design 1, referring to FIG. 16, a sender device obtains M bits. For example, the sender device first obtains information bits in a sequence to be modulated, performs the first bit-padding according to requirements of the first level of encoding, and completes the first encoding after the first bit-padding; then the sender device performs the second bit-padding according to requirements of the second level of encoding, and completes the second encoding after the second bit-padding; after that, the sender device performs the third bit-padding according to the requirement that L and M are divisible, and after the third bit-padding, the information bits with the length of L are divided into bit groups to obtain the first sequences each having the length of M; and every M bits are used for subsequent OOK modulation.

It is assumed that the M bits are {1, 0, 0, 1} and the phase randomization sequence is {x₁, x₂, x₃, x₄}, the first phase randomization is performed on the M bits to obtain the second sequence {x₁, 0, 0, x₄}, and then upsampling/spreading is performed on the second sequence. In an example where each element in the second sequence is repeated 16 times, the third sequence with the length of 64 is obtained, i.e., {x₁, . . . , x₁, 0, . . . , 0, 0, . . . , 0, x₄, . . . , x₄}.

The time-frequency transformation is performed on the third sequence with the length of 64 to obtain the frequency-domain sequence with the length of 64, i.e., {f₁, f₂, . . . , f₆₄}. In an example where the number of subcarriers allocated for transmitting OOK symbols is 64 (i.e., N=64), coefficients of the 64 subcarriers are determined based on the frequency-domain sequence with the length of 64. Frequency-domain signals are generated based on the determined coefficients of the subcarriers on the N subcarriers used for signal transmission. Then, the inverse time-frequency transformation is used to obtain time-domain data of 64 samples (short for time-domain OOK symbol data).

Optionally, symbol randomization and CP addition are performed on the time-domain data of the 64 samples. Either of the two methods is used.

Method 1 for adding CP: the time-domain data of the 64 samples is segmented first according to M=4, to obtain time-domain data segments of 4 OOK symbols, and then the symbol randomization is performed on each time-domain data segment. After the symbol randomization, the 4 OOK symbols are merged, and the CP is added to the entire time-domain data after merging.

Method 2 for adding CP: the time-domain data of the 64 samples is segmented first according to M=4, to obtain time-domain data segments of 4 OOK symbols, and then the symbol randomization is performed on each time-domain data segment. After the symbol randomization, the CP is added to each of the 4 OOK symbols, and each OOK symbol corresponds a respective CP. Then, the 4 OOK symbols are merged to obtain the entire time-domain data after merging.

### Optional Design 2

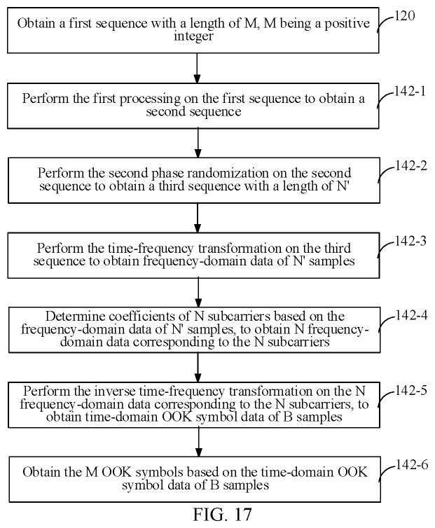

FIG. 17 shows a flowchart of an OOK modulation-based symbol generation method provided in an exemplary embodiment of the present disclosure. The method is executed by a network device, an AP, an ambient IoT device, or a terminal device, and the method includes the following steps.

In step 120, a first sequence with a length of M is obtained, M being a positive integer.

M is the number of OOK symbols transmitted within a preset duration. The preset duration is determined by the basic time-domain unit in the cellular communication system or WIFI system. In some embodiments, the preset duration is 1 OFDM symbol, and 1 OFDM symbol can transmit M OOK symbols. M is the number of OOK symbols transmitted within an OFDM symbol.

In some embodiments, the first sequence with the length of M is obtained by preprocessing a sequence to be modulated. The number of first sequences with the length of M may be one or multiple, the multiple first sequences being ordered sequentially. The embodiments describe the OOK modulation process for a single first sequence, and the OOK modulation process for multiple first sequences may be deduced by analogy.

In some embodiments, the process of performing OOK modulation on a single first sequence to obtain M OOK symbols includes at least one of the following steps 142-1 to 142-6.

In step 142-1, the first processing is performed on the first sequence to obtain a second sequence.

The first processing is performed on the first sequence to obtain the second sequence with a length of N′.

By performing the first processing on each bit in the first sequence, the second sequence with the length of N′ is obtained, where N′≥N, and N is the number of subcarriers.

The first processing is to convert each bit (also referred to as a logical bit) in the first sequence into a sequence with a length of K, K being a positive integer greater than 1. The first processing includes at least one of upsampling or spreading. Taking spreading as an example, the spreading refers to a process of repeating each bit in a sequence K times.

In some embodiments, each bit is repeated the same number of times; or each bit is repeated a different number of times; or some bits are repeated the same number of times and some bits are repeated different numbers of times.

In some embodiments, in an example where the number of spreading times is K and each bit is repeated the same number of times, the second sequence with the length of N′ is obtained by continuously repeating each bit in the first sequence K times, where N′=K*M. In the second sequence, every K consecutive bits are obtained by repeating a single bit in the first sequence K times (which means that every K consecutive bits are obtained by upsampling or spreading).

For example, the first sequence includes 4 bits, which are {1, 0, 0, 1}, and the number of spreading times is 4. Then, the second sequence includes 16 bits, i.e., {1, 1, 1, 1, 0, 0, 0, 0, 0, 0,0, 0, 1, 1, 1, 1}.

In some embodiments, in an example where the number of spreading times is K and the first M−1 bits are repeated the same number of times, the second sequence with the length of N′ is obtained by continuously repeating each of the first M−1 bits in the first sequence K times and repeating the last bit N′−K*(M−1) times. In the second sequence, each of the first M−1 groups of sequences (each group having K consecutive bits) is obtained by spreading a single bit in the first sequence, and the last group of sequences (having N′−K*(M−1) consecutive bits) is obtained by spreading the last bit in the first sequence.

In step 142-2, the second phase randomization is performed on the second sequence to obtain a third sequence.

The second sequence includes M groups of sequences, and each group of sequences includes K bits, or each of the first M−1 groups of sequences includes K bits, and the last group of sequences includes N′−K*(M−1) bits.

The second sequence is obtained by performing the first processing on the first sequence, and each group of sequences is obtained by performing the first processing on a single bit in the first sequence.

In some embodiments, the second phase randomization may be performed in any one of the following three methods.

Method 1: the phase randomization is performed on each group of sequences in the second sequence.

The phase randomization is performed individually on each group of sequences in the second sequence.

In some embodiments, an associated phase randomization sequence is determined for each group of sequences in the second sequence, and the phase randomization sequence associated with each group of sequences is independent; each group of sequences is processed using the associated phase randomization sequence. For example, point multiplication is performed on each group of sequences and the associated phase randomization sequence.

In an example where the second sequence includes M groups of sequences, an i-th phase randomization sequence is generated for an i-th group of sequences in the M groups of sequences, the i-th group of sequences is associated with the i-th phase randomization sequence, and the i-th group of sequences is multiplied by the i-th phase randomization sequence. A value of i is in a range of 0 to M−1, or the value of i is in a range of 1 to M.

Each phase randomization sequence includes at least two phase randomization factors, and a length of each phase randomization sequence is the same as that of the group of sequences associated with the phase randomization sequence. In some embodiments, the length of each phase randomization sequence is K. In some embodiments, the lengths of the phase randomization sequences associated with the first M−1 groups of sequences are K, and the length of the phase randomization sequence associated with the last group of sequences is N′−K*(M−1). In some other embodiments, the modulus of each phase randomization factor is 1.

For example, the second sequence includes 16 bits, which are {1, 1, 1, 1, 0, 0, 0, 0, 0, 0, 0, 0, 1, 1, 1, 1}; the phase randomization sequence associated with the first group of sequences {1, 1, 1, 1} is {x₁, x₂, x₃, x₄}, the phase randomization sequence associated with the second group of sequences {0, 0, 0, 0} is {x₅, x₆, x₇, x₈}, the phase randomization sequence associated with the third group of sequences {0, 0, 0, 0} is {x₉, x₁₀, x₁₁, x₁₂}, and the phase randomization sequence associated with the fourth group of sequences {1, 1, 1, 1} is {x₁₃, x₁₄, x₁₅, x₁₆}. Then, the second sequence after the phase randomization is {x₁, x₂, x₃, x₄, 0, 0, 0, 0, 0, 0, 0, 0, x₁₃, x₁₄, x₁₅, x₁₆}.

In some embodiments, an associated phase randomization factor is determined for each group of sequences in the second sequence, and the phase randomization factor associated with each group of sequences is independent; each group of sequences is processed using the associated phase randomization factor. For example, point multiplication is performed on each group of sequences and the associated phase randomization factor. In an example where the second sequence includes M groups of sequences, an i-th phase randomization factor is generated for an i-th group of sequences in the M groups of sequences, the i-th group of sequences is associated with the i-th phase randomization factor, and the i-th group of sequences is multiplied by the i-th phase randomization factor. A value of i is in a range of 0 to M−1, or the value of i is in a range of 1 to M.

In some embodiments, the modulus of each phase randomization factor is 1.

For example, the second sequence includes 16 bits, which are {1, 1, 1, 1, 0, 0, 0, 0, 0, 0, 0, 0, 1, 1, 1, 1}; the phase randomization factor associated with the first group of sequences {1, 1, 1, 1} is {x₁}, the phase randomization factor associated with the second group of sequences {0, 0, 0, 0} is {x₂}, the phase randomization factor associated with the third group of sequences {0, 0, 0, 0} is {x₃}, and the phase randomization factor associated with the fourth group of sequences {1, 1, 1, 1} is {x₄}. Then, the second sequence after the phase randomization is {x₁, x₁, x₁, x₁, 0, 0, 0, 0, 0, 0, 0, 0, x₄, x₄, x₄, x₄}.

Method 2: the phase randomization is performed on each group of target sequences in the second sequence, the group of target sequences being a bit sequence with a first value.

The phase randomization is performed on each group of target sequences in the second sequence.

In some embodiments, an associated phase randomization sequence is determined for each group of target sequences in the second sequence, and the phase randomization sequence associated with each group of target sequences is independent; and each group of target sequences is processed using the associated phase randomization sequence. For example, point multiplication is performed on each group of target sequences and the associated phase randomization sequence.

In an example where the second sequence includes M groups of sequences, an i-th phase randomization sequence is generated for an i-th group of target sequences in the M groups of sequences, the i-th group of target sequences is associated with the i-th phase randomization sequence, and the i-th group of target sequences is multiplied by the i-th phase randomization sequence. A value of i is in a range of 0 to D−1, or the value of i is in a range of 1 to D. D is the number of groups of target sequences with the first value among the M groups of sequences.

Each phase randomization sequence includes at least two phase randomization factors, and a length of each phase randomization sequence is the same as that of the sequence associated with the phase randomization sequence. In some embodiments, the modulus of each phase randomization factor is 1.

For example, the second sequence includes 16 bits, which are {1, 1, 1, 1, 0, 0, 0, 0, 0, 0, 0, 0, 1, 1, 1, 1}, the first and fourth groups of sequences each are a sequence with the value of 1, i.e., {1, 1, 1, 1}; the phase randomization sequence associated with the first group of sequences {1, 1, 1, 1} is {x₁, x₂, x₃, x₄}, and the phase randomization sequence associated with the fourth group of sequences {1, 1, 1, 1} is {x₅, x₆, x₇, x₈}. Then, the second sequence after the phase randomization is {x₁, x₂, x₃, x₄, 0, 0, 0, 0, 0, 0, 0, 0, x₅, x₆, x₇, x₈}.

In some embodiments, an associated phase randomization factor is determined for each group of target sequences in the second sequence, and the phase randomization factor associated with each group of target sequences is independent; and each group of target sequences is processed using the associated phase randomization factor. For example, point multiplication is performed on each group of target sequences and the associated phase randomization factor.

In an example where the second sequence includes M groups of sequences, an i-th phase randomization factor is generated for an i-th group of target sequences in the M groups of sequences, the i-th group of target sequences is associated with the i-th phase randomization factor, and the i-th group of target sequences is multiplied by the i-th phase randomization factor. A value of i is in a range of 0 to D−1, or the value of i is in a range of 1 to D. D is the number of groups of target sequences with the first value among the M groups of sequences.

In some embodiments, the modulus of each phase randomization factor is 1.

For example, the second sequence includes 16 bits, which are {1, 1, 1, 1, 0, 0, 0, 0, 0, 0, 0, 0, 1, 1, 1, 1}; the phase randomization factor associated with the first group of sequences {1, 1,1, 1} is {x₁}, and the phase randomization factor associated with the fourth group of sequences {1, 1, 1, 1} is {x₂}. Then, the second sequence after the phase randomization is {x₁, x₁, x₁, x₁, 0, 0, 0, 0, 0, 0, 0, 0, x₂, x₂, x₂, x₂}.

Method 3: the phase randomization is performed on all bits in the second sequence.

In some embodiments, the phase randomization is performed on all bits in the second sequence as a whole.

The N′ bits in the second sequence are processed using a phase randomization sequence with a length of N′. For example, point multiplication is performed on the N′ bits in the second sequence and the phase randomization sequence with the length of N′. The phase randomization sequence with the length of N′ includes N′ phase randomization factors.

In some embodiments, the modulus of each phase randomization factor is 1.

For example, the second sequence includes 4 bits, which are {1, 0, 0, 1}, and the phase randomization sequence with the length of N′ is {x₁, x₂, x₃, x₄}. Then, the second sequence is {x₁, 0, 0, x₄}.

The phase randomization sequence includes N′ phase randomization factors; or the phase randomization sequence is a ZC sequence; or the phase randomization sequence is an N′ sequence; or the phase randomization sequence is a sequence with a peak to average power ratio (PAPR) less than a threshold, also known as a low PAPR sequence.

In step 142-3, the time-frequency transformation is performed on the third sequence to obtain frequency-domain data of N′ samples.

The discrete Fourier transform is performed on the third sequence with the length of N′ to obtain the frequency-domain data of N′ samples.

In step 142-4, coefficients of N subcarriers are determined based on the frequency-domain data of N′ samples, to obtain N frequency-domain data corresponding to the N subcarriers.

When N′=N, a coefficient of a j-th subcarrier is determined based on frequency-domain data of a j-th sample, where a value of j is in a range of 0 to N−1 or in a range of 1 to N; and the N frequency-domain data corresponding to the N subcarriers are obtained.

When N′>N, the frequency-domain data of N′ samples is truncated to frequency-domain data of N samples (for example, only frequency-domain data of the first or last N samples are taken); a coefficient of a j-th subcarrier is determined based on frequency-domain data of a j-th sample, where a value of j is in a range of 0 to N−1 or in a range of 1 to N; and the N frequency-domain data corresponding to the N subcarriers are obtained.

The process of determining the coefficients of N subcarriers during transmission based on the frequency-domain data of N samples means that the frequency-domain data of N samples after the time-frequency transformation is modulated onto the N subcarriers.

In step 142-5, the inverse time-frequency transformation is performed on the N frequency-domain data corresponding to the N subcarriers, to obtain time-domain OOK symbol data of B samples.

The discrete inverse Fourier transform is performed on the N frequency-domain data corresponding to the N subcarriers, to obtain the time-domain OOK symbol data of B samples.

In some embodiments, B is greater than or equal to N. In some embodiments, B is an integer multiple of M. In some embodiments, B is a power of 2. For example, N represents 48 subcarriers, and B represents time-domain OOK symbol data of 1024 samples.

In step 142-6, the M OOK symbols are obtained based on the time-domain OOK symbol data of B samples.

Taking B as an integer multiple of M as an example, each OOK symbol carries time-domain OOK symbol data of B/M samples.

In summary, in the method provided in the embodiments, energy flattening at the subcarrier level or bit level is achieved by performing the second phase randomization with the bit in the second sequence as the granularity, thereby improving frequency selectivity and anti-interference capability.

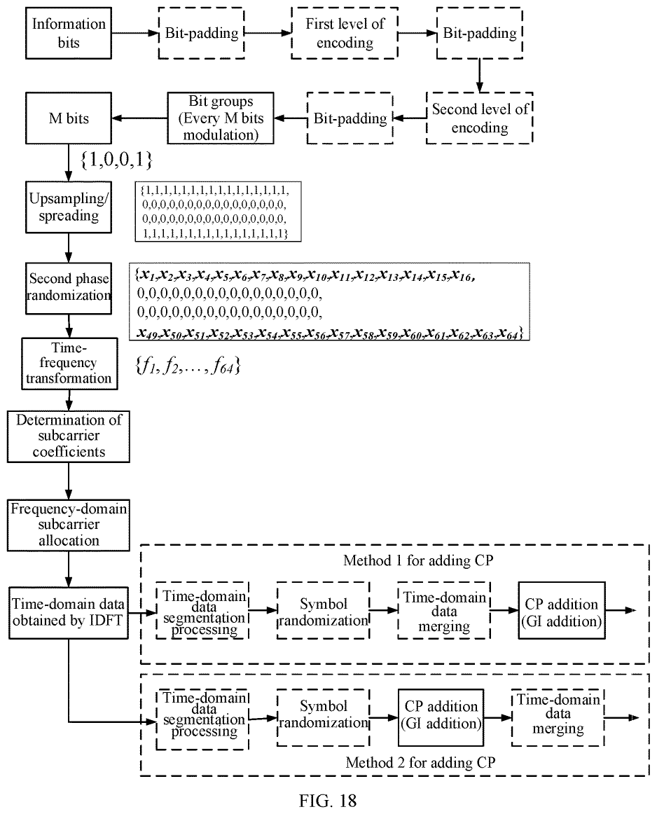

As an exemplary embodiment of Optional design 2, referring to FIG. 18, a sender device obtains M bits. For example, the sender device first obtains information bits in a sequence to be modulated, performs the first bit-padding according to requirements of the first level of encoding, and completes the first encoding after the first bit-padding; then the sender device performs the second bit-padding according to requirements of the second level of encoding, and completes the second encoding after the second bit-padding; after that, the sender device performs the third bit-padding according to the requirement that L and M are divisible, and after the third bit-padding, the information bits with the length of L are divided into bit groups to obtain the first sequences each having the length of M; and every M bits are used for subsequent OOK modulation.

It is assumed that the M bits are {1, 0, 0, 1}, upsampling/spreading is first performed on the M bits (for example, each of the M bits is repeated 16 times), to obtain the second sequence with the length of 64:
{1, 1, 1, 1, 1, 1, 1, 1, 1, 1, 1, 1, 1, 1, 1, 1, 1, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 1, 1, 1, 1, 1, 1, 1, 1, 1, 1, 1, 1, 1, 1, 1, 1, 1}.

The phase randomization sequence is determined to be {x₁, x₂, x₃, x₄, . . . , x₆₁, x₆₂, x₆₃, x₆₄}. The second phase randomization is performed on the second sequence to obtain the third sequence, i.e., {x₁, . . . , x₁₆, 0, . . . , 0, 0, . . . , 0, x₄₉, . . . , x₆₄}.

The time-frequency transformation is performed on the third sequence with the length of 64 to obtain the frequency-domain sequence with the length of 64, i.e., {f₁, f₂, . . . , f₆₄}. In an example where the number of subcarriers allocated for transmitting OOK symbols is 64 (i.e., N=64), coefficients of the 64 subcarriers are determined based on the frequency-domain sequence with the length of 64. Frequency-domain signals are generated based on the determined coefficients of the subcarriers on the N subcarriers used for signal transmission. Then, the inverse time-frequency transformation is used to obtain time-domain data of 64 samples (short for time-domain OOK symbol data).

Optionally, symbol randomization and CP addition are performed on the time-domain data of the 64 samples. Either of the two methods is used.

Method 1 for adding CP: the time-domain data of the 64 samples is segmented first according to M=4, to obtain time-domain data segments of 4 OOK symbols, and then the symbol randomization is performed on each time-domain data segment. After the symbol randomization, the 4 OOK symbols are merged, and the CP is added to the entire time-domain data after merging.

Method 2 for adding CP: the time-domain data of the 64 samples is segmented first according to M=4, to obtain time-domain data segments of 4 OOK symbols, and then the symbol randomization is performed on each time-domain data segment. After the symbol randomization, the CP is added to each of the 4 OOK symbols, and each OOK symbol corresponds a respective CP. Then, the 4 OOK symbols are merged to obtain the entire time-domain data after merging.

### Optional Design 3

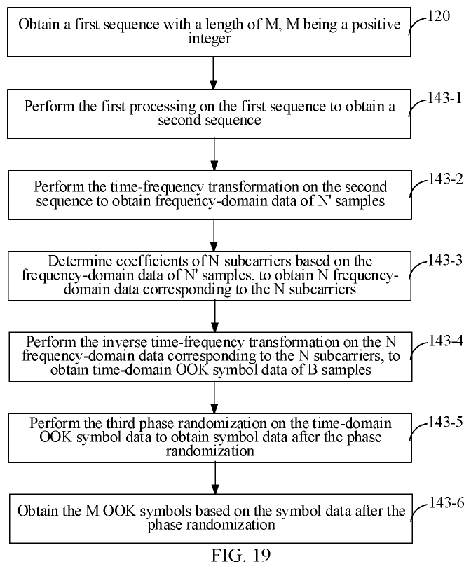

FIG. 19 shows a flowchart of an OOK modulation-based symbol generation method provided in an exemplary embodiment of the present disclosure. The method is executed by a network device, an AP, an ambient IoT device, or a terminal device, and the method includes the following steps.

In step 120, a first sequence with a length of M is obtained, M being a positive integer.

M is the number of OOK symbols transmitted within a preset duration. The preset duration is determined by the basic time-domain unit in the cellular communication system or WIFI system. In some embodiments, the preset duration is 1 OFDM symbol, and 1 OFDM symbol can transmit M OOK symbols. M is the number of OOK symbols transmitted within an OFDM symbol.

In some embodiments, the first sequence with the length of M is obtained by preprocessing a sequence to be modulated. The number of first sequences with the length of M may be one or multiple, the multiple first sequences being ordered sequentially. The embodiments describe the OOK modulation process for a single first sequence, and the OOK modulation process for multiple first sequences may be deduced by analogy.

The process of performing OOK modulation on a single first sequence to obtain M OOK symbols includes at least one of the following steps 143-1 to 143-6.

In step 143-1, the first processing is performed on the first sequence to obtain a second sequence.

The first processing is performed on the first sequence to obtain the second sequence with a length of N′.

By performing the first processing on each bit in the first sequence, the second sequence with the length of N′ is obtained, where N′≥N, and N is the number of subcarriers.

The first processing is to convert each bit (also referred to as a logical bit) in the first sequence into a sequence with a length of K, K being a positive integer greater than 1. The first processing includes at least one of upsampling or spreading. Taking spreading as an example, the spreading refers to a process of repeating each bit in a sequence K times.

In some embodiments, each bit is repeated the same number of times; or each bit is repeated a different number of times; or some bits are repeated the same number of times and some bits are repeated different numbers of times.

In some embodiments, in an example where the number of spreading times is K and each bit is repeated the same number of times, the second sequence with the length of N′ is obtained by continuously repeating each bit in the first sequence K times, where N′=K*M. In the second sequence, every K consecutive bits are obtained by repeating a single bit in the first sequence K times (which means that every K consecutive bits are obtained by upsampling or spreading).

For example, the first sequence includes 4 bits, which are {1, 0, 0, 1}, and the number of spreading times is 4. Then, the second sequence includes 16 bits, i.e., {1, 1, 1, 1, 0, 0, 0, 0, 0, 0, 0, 0, 1, 1, 1, 1}.

In some embodiments, in an example where the number of spreading times is K and the first M−1 bits are repeated the same number of times, the second sequence with the length of N′ is obtained by continuously repeating each of the first M−1 bits in the first sequence K times and repeating the last bit N′−K*(M−1) times. In the second sequence, each of the first M−1 groups of sequences (each group having K consecutive bits) is obtained by spreading a single bit in the first sequence, and the last group of sequences (having N′−K*(M−1) consecutive bits) is obtained by spreading the last bit in the first sequence.

In step 143-2, the time-frequency transformation is performed on the second sequence to obtain frequency-domain data of N′ samples.

The discrete Fourier transform is performed on the second sequence with the length of N′ to obtain the frequency-domain data of N′ samples.

In step 143-3, coefficients of N subcarriers are determined based on the frequency-domain data of N′ samples, to obtain N frequency-domain data corresponding to the N subcarriers.

When N′=N, a coefficient of a j-th subcarrier is determined based on frequency-domain data of a j-th sample, where a value of j is in a range of 0 to N−1 or in a range of 1 to N; and the N frequency-domain data corresponding to the N subcarriers are obtained.

When N′>N, the frequency-domain data of N′ samples is truncated to frequency-domain data of N samples (for example, only frequency-domain data of the first or last N samples are taken); a coefficient of a j-th subcarrier is determined based on frequency-domain data of a j-th sample, where a value of j is in a range of 0 to N−1 or in a range of 1 to N; and the N frequency-domain data corresponding to the N subcarriers are obtained.

The process of determining the coefficients of N subcarriers during transmission based on the frequency-domain data of N samples means that the frequency-domain data of N samples after the time-frequency transformation is modulated onto the N subcarriers.

In step 143-4, the inverse time-frequency transformation is performed on the N frequency-domain data corresponding to the N subcarriers, to obtain time-domain OOK symbol data of B samples.

The discrete inverse Fourier transform is performed on the N frequency-domain data corresponding to the N subcarriers, to obtain the time-domain OOK symbol data of B samples.

In some embodiments, B is greater than or equal to N. In some embodiments, B is an integer multiple of M. In some embodiments, B is a power of 2. For example, N represents 48 subcarriers, and B represents time-domain OOK symbol data of 1024 samples.

In step 143-5, the third phase randomization is performed on the time-domain OOK symbol data to obtain symbol data after the phase randomization.

In some embodiments, taking B as an integer multiple of M as an example, the time-domain OOK symbol data includes M groups of symbol data, and each group of symbol data includes symbol data of K*b samples.

In some embodiments, each of the first M−1 groups of symbol data includes symbol data of K*b samples, and the last group of symbol data includes symbol data of (N−K*(M−1))*b samples. Here, b is a positive integer, and K*b*M=B.

The time-domain OOK symbol data is obtained by performing the first processing, the time-frequency transformation, the determination of subcarrier coefficients, and the inverse time-frequency transformation on the first sequence, and each group of symbol data is obtained by processing a single bit in the first sequence.

In some embodiments, the third phase randomization may be performed in any one of the following three methods.

Method 1: the phase randomization is performed on each group of symbol data in the time-domain OOK symbol data.

The phase randomization is performed individually on each group of symbol data in the time-domain OOK symbol data.

In some embodiments, an associated phase randomization sequence is determined for each group of symbol data in the time-domain OOK symbol data, and the phase randomization sequence associated with each group of symbol data is independent; and each group of symbol data is processed using the associated phase randomization sequence. For example, point multiplication is performed on each group of symbol data and the associated phase randomization sequence.

In an example where the time-domain OOK symbol data includes M groups of symbol data, an i-th phase randomization sequence is generated for an i-th group of symbol data in the M groups of symbol data, the i-th group of symbol data is associated with the i-th phase randomization sequence, and the i-th group of symbol data is multiplied by the i-th phase randomization sequence. A value of i is in a range of 0 to M−1, or the value of i is in a range of 1 to M.

Each phase randomization sequence includes at least two phase randomization factors, and a length of each phase randomization sequence is the same as that of the symbol data associated with the phase randomization sequence. In some embodiments, the length of each phase randomization sequence is K*b. In some embodiments, the lengths of the phase randomization sequences associated with the first M−1 groups of symbol data are K*b, and the length of the phase randomization sequence associated with the last group of symbol data is (N−K*(M−1))*b. In some other embodiments, the modulus of each phase randomization factor is 1.

For example, b is 1, and the time-domain OOK symbol data includes t_{i,1}, t_{i,2}, . . . , t_{i,k} (i=1, 2, . . . , M, and k=1, 2, . . . , K); the phase randomization sequence associated with the first group of symbol data {t_{1,1}, t_{1,2}, . . . , t_{1,k}} is {x₁, x₂, x₃, x₄}, the phase randomization sequence associated with the second group of symbol data {t_{2,1}, t_{2,2}, . . . , t_{2,k}} is {x₅, x₆, x₇, x₈}, the phase randomization sequence associated with the third group of symbol data {t_{3,1}, t_{3,2}, . . . , t_{3,k}} is {x₉, x₁₀, x₁₁, x₁₂}, the phase randomization sequence associated with the fourth group of symbol data {t_{4,1}, t_{4,2}, . . . , t_{4,k}} is {x₁₃, x₁₄, x₁₅, x₁₆}, and so on.

In some embodiments, an associated phase randomization factor is determined for each group of symbol data in the time-domain OOK symbol data, and the phase randomization factor associated with each group of symbol data is independent; and each group of symbol data is processed using the associated phase randomization factor. For example, point multiplication is performed on each group of symbol data and the associated phase randomization factor.

In an example where the time-domain OOK symbol data includes M groups of symbol data, an i-th phase randomization factor is generated for an i-th group of symbol data in the M groups of symbol data, the i-th group of symbol data is associated with the i-th phase randomization factor, and the i-th group of symbol data is multiplied by the i-th phase randomization factor. A value of i is in a range of 0 to M−1, or the value of i is in a range of 1 to M.

In some embodiments, the modulus of each phase randomization factor is 1.

For example, b is 1, the time-domain OOK symbol data includes {t_{1,1}, t_{1,2}, . . . , t_{1,k}} (i=1, 2, . . . , M, and k=1, 2, . . . , K); the phase randomization sequence associated with the first group of symbol data {t_{1,1}, t_{1,2}, . . . , t_{1,k}} is {x₁}, the phase randomization sequence associated with the second group of symbol data {t_{2,1}, t_{2,2}, . . . , t_{2,k}} is {x₂}, the phase randomization sequence associated with the third group of symbol data {t_{3,1}, t_{3,2}, . . ., t_{3,k}} is {x₃}, the phase randomization sequence associated with the fourth group of symbol data {t_{4,1}, t_{4,2}, . . . , t_{4,k}} is {x₄}, and so on.

Method 2: the phase randomization is performed on each group of target symbol data in the time-domain OOK symbol data, each group of target symbol data being obtained by processing a bit with a first value in the first sequence.

The phase randomization is performed individually on each group of target symbol data in the time-domain OOK symbol data.

In some embodiments, each group of target symbol data is obtained by processing a single bit with a value of 1 in the first sequence.

In some embodiments, an associated phase randomization sequence is determined for each group of target symbol data in the time-domain OOK symbol data, and the phase randomization sequence associated with each group of target symbol data is independent; and each group of target symbol data is processed using the associated phase randomization sequence. For example, point multiplication is performed on each group of target symbol data and the associated phase randomization sequence. In an example where the time-domain OOK symbol data includes M groups of symbol data, an i-th phase randomization sequence is generated for an i-th group of target symbol data in the M groups of symbol data, the i-th group of target symbol data is associated with the i-th phase randomization sequence, and the i-th group of target symbol data is multiplied by the i-th phase randomization sequence. A value of i is in a range of 0 to D−1, or the value of i is in a range of 1 to D. D is the number of groups of target symbol data among the M groups of symbol data.

Each phase randomization sequence includes at least two phase randomization factors, and a length of each phase randomization sequence is the same as that of the symbol data associated with the phase randomization sequence. In some embodiments, the modulus of each phase randomization factor is 1.

In some embodiments, an associated phase randomization factor is determined for each group of target symbol data in the time-domain OOK symbol data, and the phase randomization factor associated with each group of target symbol data is independent; and each group of target symbol data is processed using the associated phase randomization factor. For example, point multiplication is performed on each group of target symbol data and the associated phase randomization factor. In an example where the time-domain OOK symbol data includes M groups of symbol data, an i-th phase randomization factor is generated for an i-th group of target symbol data in the M groups of symbol data, the i-th group of target symbol data is associated with the i-th phase randomization factor, and the i-th group of target symbol data is multiplied by the i-th phase randomization factor. A value of i is in a range of 0 to D−1, or the value of i is in a range of 1 to D. D is the number of groups of target symbol data among the M groups of symbol data.

In some embodiments, the modulus of each phase randomization factor is 1.

Method 3: the phase randomization is performed on symbol data of all samples in the time-domain OOK symbol data.

The phase randomization is performed on symbol data of all samples in the time-domain OOK symbol data as a whole.

In some embodiments, point multiplication is performed on the symbol data of B samples in the time-domain OOK symbol data and the phase randomization sequence with the length of B. The phase randomization sequence with the length of B includes B phase randomization factors.

In some embodiments, the modulus of each phase randomization factor is 1.

Taking B =M*K as an example, the time-domain OOK symbol data includes {t_{1,1}, t_{1,2}, . . . , t_{1,k}} (i=1, 2, . . . , M, and k=1, 2, . . . , K), and the phase randomization sequence with the length of N′=M*K is {x_{1,1}, x_{1,2}, . . . , x_{1,k}}.

The phase randomization sequence includes N′ phase randomization factors; or the phase randomization sequence is a ZC sequence; or the phase randomization sequence is an M sequence; or the phase randomization sequence is a sequence with a peak to average power ratio (PAPR) less than a threshold, also known as a low PAPR sequence.

In step 143-6, the M OOK symbols are obtained based on the symbol data after the phase randomization.

In some embodiments, each OOK symbol carries K symbol data after the phase randomization. In some embodiments, the first M−1 OOK symbols each carry K symbol data after the phase randomization, and the last OOK symbol carries N−K*(M−1) symbol data after the phase randomization.

In summary, in the method provided in the embodiments, energy flattening at the sample level is achieved by performing the third phase randomization with the symbol data of each sample in the time-domain OOK symbol data as the granularity, thereby achieving finer-grained energy flattening and improving frequency selectivity and anti-interference capability.

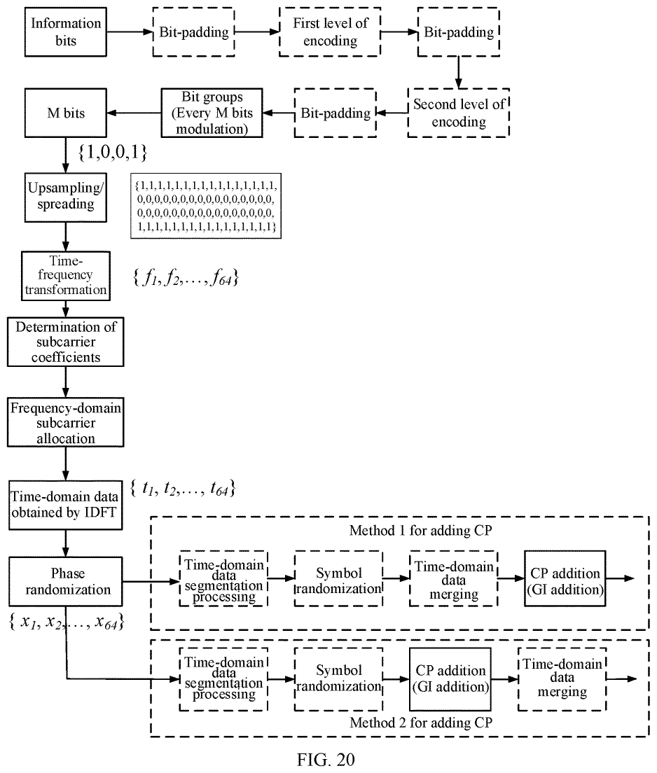

As an exemplary embodiment of Optional design 3, referring to FIG. 20, a sender device obtains M bits. For example, the sender device first obtains information bits in a sequence to be modulated, performs the first bit-padding according to requirements of the first level of encoding, and completes the first encoding after the first bit-padding; then the sender device performs the second bit-padding according to requirements of the second level of encoding, and completes the second encoding after the second bit-padding; after that, the sender device performs the third bit-padding according to the requirement that L and M are divisible, and after the third bit-padding, the information bits with the length of L are divided into bit groups to obtain the first sequences each having the length of M; and every M bits are used for subsequent OOK modulation.

It is assumed that the M bits are {1, 0, 0, 1}, upsampling/spreading is first performed on the M bits (for example, each of the M bits is repeated 16 times), to obtain the second sequence with the length of 64:
{1, 1, 1, 1, 1, 1, 1, 1, 1, 1, 1, 1, 1, 1, 1, 1, 1, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 1, 1, 1, 1, 1, 1, 1, 1, 1, 1, 1, 1, 1, 1, 1, 1, 1}.

The time-frequency transformation is performed on the second sequence with the length of 64 to obtain the frequency-domain sequence with the length of 64, i.e., {f₁, f₂, . . . , f₆₄}. In an example where the number of subcarriers allocated for transmitting OOK symbols is 64 (i.e., N=64), coefficients of the 64 subcarriers are determined based on the frequency-domain sequence with the length of 64. Frequency-domain signals are generated based on the determined coefficients of the subcarriers on the N subcarriers used for signal transmission. Then, the inverse time-frequency transformation is used to obtain time-domain data of 64 samples, i.e., {t₁, t₂, . . . , t₆₄}.

The phase randomization is performed on the time-domain data {t₁, t₂, . . . , t₆₄} using the phase randomization sequence with the length of 64, to obtain the time-domain data after the phase randomization, i.e., {x₁, x₂, . . . , x₆₄}.

Optionally, symbol randomization and CP addition are performed on the 64 time-domain data after the phase randomization. Either of the two methods is used.

Method 1 for adding CP: the 64 time-domain data after the phase randomization is segmented first according to M=4, to obtain time-domain data segments of 4 OOK symbols, and then the symbol randomization is performed on each time-domain data segment. After the symbol randomization, the 4 OOK symbols are merged, and the CP is added to the entire time-domain data after merging.

Method 2 for adding CP: the 64 time-domain data after the phase randomization is segmented first according to M=4, to obtain time-domain data segments of 4 OOK symbols, and then the symbol randomization is performed on each time-domain data segment. After the symbol randomization, the CP is added to each of the 4 OOK symbols, and each OOK symbol corresponds a respective CP. Then, the 4 OOK symbols are merged to obtain the entire time-domain data after merging.

### Optional Design 4

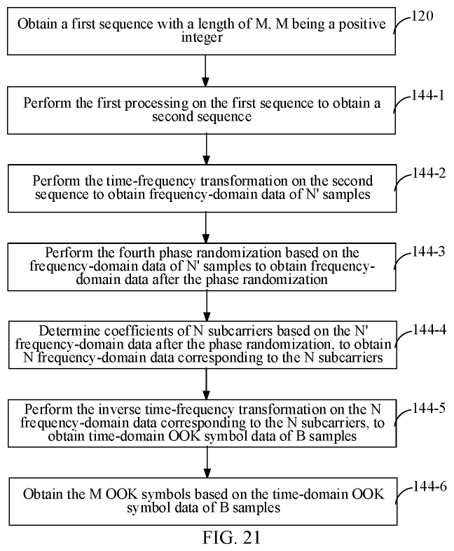

FIG. 21 shows a flowchart of an OOK modulation-based symbol generation method provided in an exemplary embodiment of the present disclosure. The method is executed by a network device, an AP, a zero-power device (e.g., an ambient IoT device), or a terminal device, and the method includes the following steps.

In step 120, a first sequence with a length of M is obtained, M being a positive integer.

M is the number of OOK symbols transmitted within a preset duration. The preset duration is determined by the basic time-domain unit in the cellular communication system or WIFI system. In some embodiments, the preset duration is 1 OFDM symbol, and 1 OFDM symbol can transmit M OOK symbols. M is the number of OOK symbols transmitted within an OFDM symbol.

In some embodiments, the first sequence with the length of M is obtained by preprocessing a sequence to be modulated. The number of first sequences with the length of M may be one or multiple, the multiple first sequences being ordered sequentially. The embodiments describe the OOK modulation process for a single first sequence, and the OOK modulation process for multiple first sequences may be deduced by analogy.

The process of performing OOK modulation on a single first sequence to obtain M OOK symbols includes at least one of the following steps 144-1 to 144-6.

In step 144-1, the first processing is performed on the first sequence to obtain a second sequence.

The first processing is performed on the first sequence to obtain the second sequence with a length of N′.

By performing the first processing on each bit in the first sequence, the second sequence with the length of N′ is obtained, where N′≥N, and N is the number of subcarriers.

The first processing is to convert each bit (also referred to as a logical bit) in the first sequence into a sequence with a length of K, K being a positive integer greater than 1. The first processing includes at least one of upsampling or spreading. Taking spreading as an example, the spreading refers to a process of repeating each bit in a sequence K times.

In some embodiments, each bit is repeated the same number of times; or each bit is repeated a different number of times; or some bits are repeated the same number of times and some bits are repeated different numbers of times.

In some embodiments, in an example where the number of spreading times is K and each bit is repeated the same number of times, the second sequence with the length of N′ is obtained by continuously repeating each bit in the first sequence K times, where N′=K*M. In the second sequence, every K consecutive bits are obtained by repeating a single bit in the first sequence K times (which means that every K consecutive bits are obtained by upsampling or spreading).

For example, the first sequence includes 4 bits, which are {1, 0, 0, 1}, and the number of spreading times is 4. Then, the second sequence includes 16 bits, i.e., {1, 1, 1, 1, 0, 0, 0, 0, 0, 0, 0, 0, 1, 1, 1, 1}.

In some embodiments, in an example where the number of spreading times is K and the first M−1 bits are repeated the same number of times, the second sequence with the length of N′ is obtained by continuously repeating each of the first M−1 bits in the first sequence K times and repeating the last bit N′−K*(M−1) times. In the second sequence, each of the first M−1 groups of sequences (each group having K consecutive bits) is obtained by spreading a single bit in the first sequence, and the last group of sequences (having N′−K*(M−1) consecutive bits) is obtained by spreading the last bit in the first sequence.

In step 144-2, the time-frequency transformation is performed on the second sequence to obtain frequency-domain data of N′ samples.

The discrete Fourier transform is performed on the second sequence with the length of N′ to obtain the frequency-domain data of N′ samples.

In step 144-3, the fourth phase randomization is performed based on the frequency-domain data of N′ samples to obtain frequency-domain data after the phase randomization.

The frequency-domain data includes M groups of frequency-domain data, each group of frequency-domain data includes frequency-domain data of K samples, or each of the first M−1 groups of frequency-domain data includes frequency-domain data of K samples, and the last group of frequency-domain data includes frequency-domain data of N′−K*(M−1) samples.

The frequency-domain data is obtained by performing the first processing and time-frequency transformation on the first sequence. Each group of frequency-domain data is obtained by performing the first processing and time-frequency transformation on a single bit in the first sequence.

In some embodiments, the fourth phase randomization may be performed in any one of the following three methods.

Method 1: the phase randomization is performed on each group of frequency-domain data in the frequency-domain data.

The phase randomization is performed individually on each group of frequency-domain data in the frequency-domain data.

In some embodiments, an associated phase randomization sequence is determined for each group of frequency-domain data in the frequency-domain data, and the phase randomization sequence associated with each group of frequency-domain data is independent; and each group of frequency-domain data is processed using the associated phase randomization sequence. For example, point multiplication is performed on each group of frequency-domain data and the associated phase randomization sequence.

In an example where the frequency-domain data includes M groups of frequency-domain data, an i-th phase randomization sequence is generated for an i-th group of frequency-domain data in the M groups of frequency-domain data, the i-th group of frequency-domain data is associated with the i-th phase randomization sequence, and the i-th group of frequency-domain data is multiplied by the i-th phase randomization sequence. A value of i is in a range of 0 to M−1, or the value of i is in a range of 1 to M.

Each phase randomization sequence includes at least two phase randomization factors, and a length of each phase randomization sequence is the same as that of the frequency-domain data associated with the phase randomization sequence. In some embodiments, the length of each phase randomization sequence is K. In some embodiments, the lengths of the phase randomization sequences associated with the first M−1 groups of frequency-domain data are K, and the length of the phase randomization sequence associated with the last group of frequency-domain data is N′−K*(M−1). In some other embodiments, the modulus of each phase randomization factor is 1.

For example, the frequency-domain data includes f_{i,1}, f_{i,2}, . . . , f_{i,k}(i=1, 2, . . . , M, and k=1, 2, . . . , K); the phase randomization sequence associated with the first group of frequency-domain data {f_{1,1}, f_{1,2}, . . . , f_{1,k}} is {x₁, x₂, x₃, x₄}, the phase randomization sequence associated with the second group of frequency-domain data {f_{2,1}, f_{2,2}, . . . , f_{2,k}} is {x₅, x₆, x₇, x₈}, the phase randomization sequence associated with the third group of frequency-domain data {f_{3,1}, f_{3,2}, . . . , f_{3,k}} is {x₉, x₁₀, x₁₁, x₁₂}, the phase randomization sequence associated with the fourth group of frequency-domain data {f_{4,1}, f_{4,2}, . . . , f_{4,k}} is {x₁₃, x₁₄, x₁₅, x₁₆}, and so on.

In some embodiments, an associated phase randomization factor is determined for each group of frequency-domain data in the frequency-domain data, and the phase randomization factor associated with each group of frequency-domain data is independent; and point multiplication is performed on each group of frequency-domain data and the associated phase randomization factor. In an example where the frequency-domain data includes M groups of frequency-domain data, an i-th phase randomization factor is generated for an i-th group of frequency-domain data in the M groups of frequency-domain data, the i-th group of frequency-domain data is associated with the i-th phase randomization factor, and the i-th group of frequency-domain data is multiplied by the i-th phase randomization factor. A value of i is in a range of 0 to M−1, or the value of i is in a range of 1 to M.

In some embodiments, the modulus of each phase randomization factor is 1.

For example, the frequency-domain data includes {f_{i,1}, f_{i,2}, . . . , f_{i,k}} (i=1, 2, . . . , M, and k=1, 2, . . . , K); the phase randomization sequence associated with the first group of frequency-domain data {f_{1,1}, f_{1,2}, . . . , f_{1,k}} is {x₁}, the phase randomization sequence associated with the second group of frequency-domain data {f_{2,1}, f_{2,2}, . . . , f_{2,k}} is {x₂}, the phase randomization sequence associated with the third group of frequency-domain data {f_{3,1}, f_{3,2}, . . . , f_{3,k}} is {x₃}, the phase randomization sequence associated with the fourth group of frequency-domain data {f_{4,1}, f_{4,2}, . . . , f_{4,k}} is {x₄}, and so on.

Method 2: the phase randomization is performed on each group of target frequency-domain data in the frequency-domain data, each group of target frequency-domain data being obtained by processing a bit with a first value in the first sequence.

The phase randomization is performed individually on each group of target frequency-domain data in the frequency-domain data.

In some embodiments, each group of target frequency-domain data is obtained by processing a single bit with a value of 1 in the first sequence.

In some embodiments, an associated phase randomization sequence is determined for each group of target frequency-domain data in the frequency-domain data, and the phase randomization sequence associated with each group of target frequency-domain data is independent; and each group of target frequency-domain data is processed using the associated phase randomization sequence. For example, point multiplication is performed on each group of target frequency-domain data and the associated phase randomization sequence. In an example where the frequency-domain data includes M groups of frequency-domain data, an i-th phase randomization sequence is generated for an i-th group of target frequency-domain data in the M groups of frequency-domain data, the i-th group of target frequency-domain data is associated with the i-th phase randomization sequence, and the i-th group of target frequency-domain data is multiplied by the i-th phase randomization sequence. A value of i is in a range of 0 to D−1, or the value of i is in a range of 1 to D. D is the number of groups of target frequency-domain data among the M groups of frequency-domain data.

Each phase randomization sequence includes at least two phase randomization factors, and a length of each phase randomization sequence is the same as that of the frequency-domain data associated with the phase randomization sequence. In some embodiments, the modulus of each phase randomization factor is 1.

In some embodiments, an associated phase randomization factor is determined for each group of target frequency-domain data in the frequency-domain data, and the phase randomization factor associated with each group of target frequency-domain data is independent; and each group of target frequency-domain data is processed using the associated phase randomization factor. For example, point multiplication is performed on each group of target frequency-domain data and the associated phase randomization factor.

In an example where the frequency-domain data includes M groups of frequency-domain data, an i-th phase randomization factor is generated for an i-th group of target frequency-domain data in the M groups of frequency-domain data, the i-th group of target frequency-domain data is associated with the i-th phase randomization factor, and the i-th group of target frequency-domain data is multiplied by the i-th phase randomization factor. A value of i is in a range of 0 to D−1, or the value of i is in a range of 1 to D. D is the number of groups of target frequency-domain data among the M groups of frequency-domain data.

In some embodiments, the modulus of each phase randomization factor is 1.

Method 3: the phase randomization is performed on frequency-domain data of all samples in the frequency-domain data.

The phase randomization is performed on the frequency-domain data of all samples in the frequency-domain data as a whole.

The frequency-domain data of N′ samples in the frequency-domain data is processed using a phase randomization sequence with a length of N′. For example, point multiplication is performed on the frequency-domain data of N′ samples in the frequency-domain data and the phase randomization sequence with the length of N′. The phase randomization sequence with the length of N′ includes N′ phase randomization factors.

In some embodiments, the modulus of each phase randomization factor is 1.

For example, the frequency-domain data includes {f_{i,1}, f_{i,2}, . . . , f_{i,k}} (i=1, 2, . . . , M, and k=1, 2, . . . , K), and the phase randomization sequence with the length of N′(N′=M*K) is {x_{i,1}, x_{i,2}, . . . , x_{i,k}}.

The phase randomization sequence includes N′ phase randomization factors; or the phase randomization sequence is a pseudo-noise (PN) sequence; or the phase randomization sequence is a ZC (discovered by Zadoff and Chu) sequence; or the phase randomization sequence is an M sequence; or the phase randomization sequence is a sequence with a peak to average power ratio (PAPR) less than a threshold, also known as a low PAPR sequence.

In step 144-4, coefficients of N subcarriers are determined based on the N′ frequency-domain data after the phase randomization, to obtain N frequency-domain data corresponding to the N subcarriers.

When N′=N, a coefficient of a j-th subcarrier is determined based on the j-th frequency-domain data after the phase randomization, where a value of j is in a range of 0 to N−1 or in a range of 1 to N; and the N frequency-domain data corresponding to the N subcarriers are obtained.

When N′>N, the N′ frequency-domain data after the phase randomization is truncated to frequency-domain data of N samples (for example, only the first or last N frequency-domain data after the phase randomization are taken); a coefficient of a j-th subcarrier is determined based on the j-th frequency-domain data after the phase randomization, where a value of j is in a range of 0 to N−1 or in a range of 1 to N; and the N frequency-domain data corresponding to the N subcarriers are obtained.

In some embodiments, the truncation of the frequency-domain data may also be performed before the fourth phase randomization, and then the fourth phase randomization is performed on the frequency-domain data of N samples.

In step 144-5, the inverse time-frequency transformation is performed on the N frequency-domain data corresponding to the N subcarriers, to obtain time-domain OOK symbol data of B samples.

The discrete inverse Fourier transform is performed on the N frequency-domain data corresponding to the N subcarriers, to obtain the time-domain OOK symbol data of B samples.

In some embodiments, B is greater than or equal to N. In some embodiments, B is an integer multiple of M. In some embodiments, B is a power of 2. For example, N represents 48 subcarriers, and B represents time-domain OOK symbol data of 1024 samples.

In step 144-6, the M OOK symbols are obtained based on the time-domain OOK symbol data of B samples.

In an example where B is an integer multiple of M, each OOK symbol carries time-domain OOK symbol data of B/M samples.

In summary, in the method provided in the embodiments, energy flattening at the subcarrier level is achieved by performing the fourth phase randomization with each sample in the frequency-domain data as the granularity, thereby improving frequency selectivity and anti-interference capability.

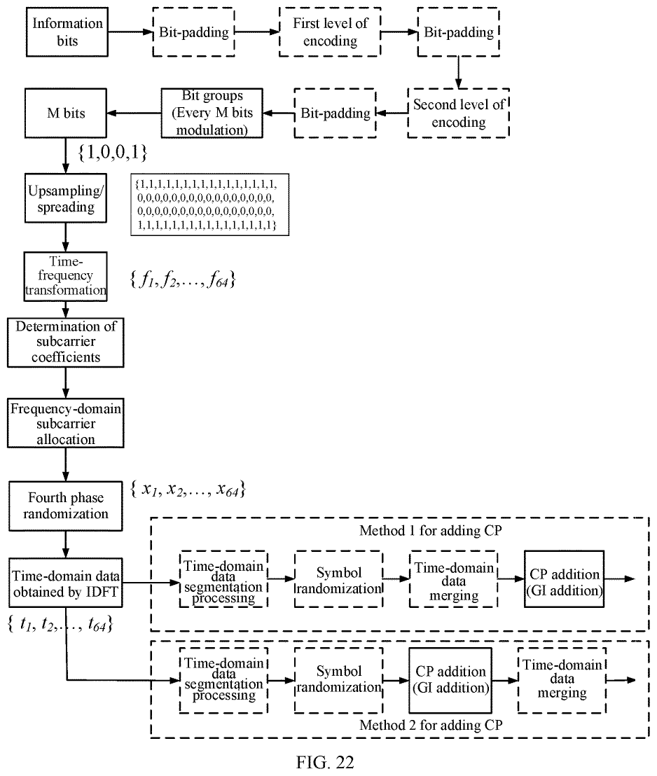

As an exemplary embodiment of Optional design 4, referring to FIG. 22, a sender device obtains M bits. For example, the sender device first obtains information bits in a sequence to be modulated, performs the first bit-padding according to requirements of the first level of encoding, and completes the first encoding after the first bit-padding; then the sender device performs the second bit-padding according to requirements of the second level of encoding, and completes the second encoding after the second bit-padding; after that, the sender device performs the third bit-padding according to the requirement that L and M are divisible, and after the third bit-padding, the information bits with the length of L are divided into bit groups to obtain the first sequences each having the length of M; and every M bits are used for subsequent OOK modulation.

It is assumed that the M bits are {1, 0, 0, 1}, upsampling/spreading is first performed on the M bits (for example, each of the M bits is repeated 16 times), to obtain the second sequence with the length of 64:
{1, 1, 1, 1, 1, 1, 1, 1, 1, 1, 1, 1, 1, 1, 1, 1, 1, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 1, 1, 1, 1, 1, 1, 1, 1, 1, 1, 1, 1, 1, 1, 1, 1, 1}.

The time-frequency transformation is performed on the second sequence with the length of 64 to obtain the frequency-domain sequence with the length of 64, i.e., {f₁, f₂, . . . , f₆₄}. In an example where the number of subcarriers allocated for transmitting OOK symbols is 64 (i.e., N=64), coefficients of the 64 subcarriers are determined based on the frequency-domain sequence with the length of 64. Frequency-domain signals are generated based on the determined coefficients of the subcarriers on the N subcarriers used for signal transmission.

The fourth phase randomization is performed on the frequency-domain signals corresponding to the 64 subcarriers using the phase randomization sequence with the length of 64, to obtain the frequency-domain data after the phase randomization, i.e., {x₁, x₂, . . . , x₆₄}. Then, the inverse time-frequency transformation is used to obtain time-domain data of 64 samples, i.e., {t₁, t₂, . . . , t₆₄}.

Optionally, symbol randomization and CP addition are performed on the 64 time-domain data after the phase randomization. Either of the two methods is used.

Method 1 for adding CP: the time-domain data of 64 samples is segmented first according to M=4, to obtain time-domain data segments of 4 OOK symbols, and then the symbol randomization is performed on each time-domain data segment. After the symbol randomization, the 4 OOK symbols are merged, and the CP is added to the entire time-domain data after merging.

Method 2 for adding CP: the time-domain data of 64 samples is segmented first according to M=4, to obtain time-domain data segments of 4 OOK symbols, and then the symbol randomization is performed on each time-domain data segment. After the symbol randomization, the CP is added to each of the 4 OOK symbols, and each OOK symbol corresponds a respective CP. Then, the 4 OOK symbols are merged to obtain the entire time-domain data after merging.

### Optional Design 5

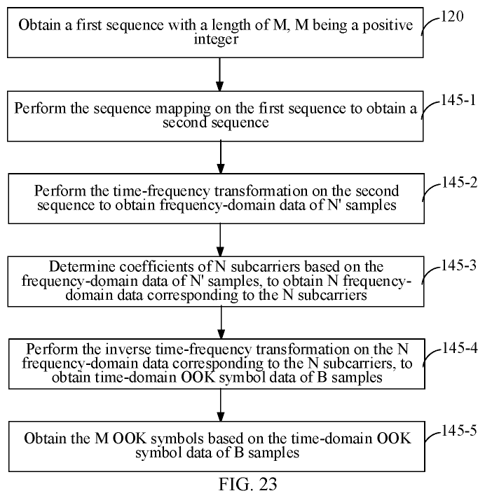

FIG. 23 shows a flowchart of an OOK modulation-based symbol generation method provided in an exemplary embodiment of the present disclosure. The method is executed by a network device, an AP, an ambient IoT device, or a terminal device, and the method includes the following steps.

In step 120, a first sequence with a length of M is obtained, M being a positive integer.

M is the number of OOK symbols transmitted within a preset duration. The preset duration is determined by the basic time-domain unit in the cellular communication system or WIFI system. In some embodiments, the preset duration is 1 OFDM symbol, and 1 OFDM symbol can transmit M OOK symbols. M is the number of OOK symbols transmitted within an OFDM symbol.

In some embodiments, the first sequence with the length of M is obtained by preprocessing a sequence to be modulated. The number of first sequences with the length of M may be one or multiple, the multiple first sequences being ordered sequentially. The embodiments describe the OOK modulation process for a single first sequence, and the OOK modulation process for multiple first sequences may be deduced by analogy.

The process of performing OOK modulation on a single first sequence to obtain M OOK symbols includes at least one of the following steps 145-1 to 145-5.

In step 145-1, the sequence mapping is performed on the first sequence to obtain a second sequence.

The first sequence includes M bits.

The sequence mapping is a mapping process that maps at least one bit in the first sequence to a phase randomization sequence. In some embodiments, the sequence mapping is a mapping process that maps each bit in the first sequence to a phase randomization sequence. In some embodiments, the sequence mapping is a mapping process that maps each of bits with a first value in the first sequence to a phase randomization sequence.

In some embodiments, each first bit in the M bits is mapped to a first mapping sequence, and each second bit in the M bits is mapped to a second mapping sequence. Here, the first bit is a bit with the first value, the second bit is a bit with a second value, and the first mapping sequence and the second mapping sequence are different phase randomization sequences.

The lengths of the first mapping sequence and the second mapping sequence are K, and K is equal to a rounded-up or rounded-down value of quotient of N divided by M.

N is the number of frequency-domain subcarriers used for generating the OOK symbols.

In some embodiments, the first mapping sequence includes K phase randomization factors; or the first mapping sequence is a ZC sequence; or the first mapping sequence is an m-sequence; or the first mapping sequence is a sequence with PAPR less than a threshold. Sequences with PAPR less than the threshold can be considered as low PAPR sequences other than the ZC sequence and m-sequence.

In some embodiments, the second mapping sequence is an all-zero sequence; or the second mapping sequence includes K phase randomization factors; or the second mapping sequence is a ZC sequence; or the second mapping sequence is an m-sequence; or the second mapping sequence is a sequence with PAPR less than a threshold.

In some embodiments, the sequence length K of each bit mapping in the first mapping sequence is first determined. Based on the number N of subcarriers allocated in the frequency-domain for generating OOK symbols and the number M of OOK symbols transmitted by each OFDM symbol, the sequence length K of each bit mapping is determined.

When N and M are divisible, K=N/M. When N and M are not divisible, K is equal to a rounded-up or rounded-down value of quotient of N divided by M (i.e., N/M).

For example, the first mapping sequence includes 4 bits, which are {1, 0, 0, 1}; the sequence associated with the first bit is seq1={x₁, x₂, x₃, x₄}, the sequence associated with the second bit is seq2={0, 0, 0, 0}, the sequence associated with the third bit is seq3={0, 0, 0, 0}, and the sequence associated with the fourth bit is seq4={x₅, x₆, x₇, x₈}.

In some embodiments, the first mapping sequences corresponding to different bits are different. In some embodiments, the first mapping sequences corresponding to different bits are the same.

In some embodiments, there are multiple candidate sequences for the first mapping sequence. When the sequence mapping is performed, the actual mapping candidate sequence is determined, based on a preset rule, for each bit with the value of 1 from multiple candidate sequences.

For example, there are 4 candidate sequences: candidate sequence 1, candidate sequence 2, candidate sequence 3, and candidate sequence 4; it is assumed that there are 8 bits with the value of 1 in the first sequence, and based on the sequential mapping rule, the candidate sequences corresponding to the bits with the value of 1 are: candidate sequence 1, candidate sequence 2, candidate sequence 3, candidate sequence 4, candidate sequence 1, candidate sequence 2, candidate sequence 3, candidate sequence 4; or based on the cyclic mapping rule, the candidate sequences corresponding to the bits with the value of 1 are: candidate sequence 1, candidate sequence 1, candidate sequence 2, candidate sequence 2, candidate sequence 3, candidate sequence 3, candidate sequence 4, candidate sequence 4. For example, when there is a need to use the first mapping sequence to carry the first information, the first mapping sequence is selected from multiple candidate sequences based on the first information to be transmitted; or the first mapping sequence is selected from multiple candidate sequences in a random manner.

In step 145-2, the time-frequency transformation is performed on the second sequence to obtain frequency-domain data of N′ samples.

The discrete Fourier transform is performed on the second sequence with the length of N′ to obtain the frequency-domain data of N′ samples.

In step 145-3, coefficients of N subcarriers are determined based on the frequency-domain data of N′ samples, to obtain N frequency-domain data corresponding to the N subcarriers.

When N′=N, a coefficient of a j-th subcarrier is determined based on frequency-domain data of a j-th sample, where a value of j is in a range of 0 to N−1 or in a range of 1 to N; and the N frequency-domain data corresponding to the N subcarriers are obtained.

When N′>N, the frequency-domain data of N′ samples is truncated to frequency-domain data of N samples (for example, only frequency-domain data of the first or last N samples are taken); a coefficient of a j-th subcarrier is determined based on frequency-domain data of a j-th sample, where a value of j is in a range of 0 to N−1 or in a range of 1 to N; and the N frequency-domain data corresponding to the N subcarriers are obtained.

In step 145-4, the inverse time-frequency transformation is performed on the N frequency-domain data corresponding to the N subcarriers, to obtain time-domain OOK symbol data of B samples.

The discrete inverse Fourier transform is performed on the N frequency-domain data corresponding to the N subcarriers, to obtain the time-domain OOK symbol data of B samples.

In some embodiments, B is greater than or equal to N. In some embodiments, B is an integer multiple of M. In some embodiments, B is a power of 2.

In step 145-5, the M OOK symbols are obtained based on the time-domain OOK symbol data of B samples.

In an example where B is an integer multiple of M, each OOK symbol carries time-domain OOK symbol data of B/M samples.

In summary, in the method provided in the embodiments, energy flattening at the subcarrier level or bit level is achieved by performing the phase randomization with the bit in the first sequence as the granularity in the sequence mapping manner, thereby improving frequency selectivity and anti-interference capability.

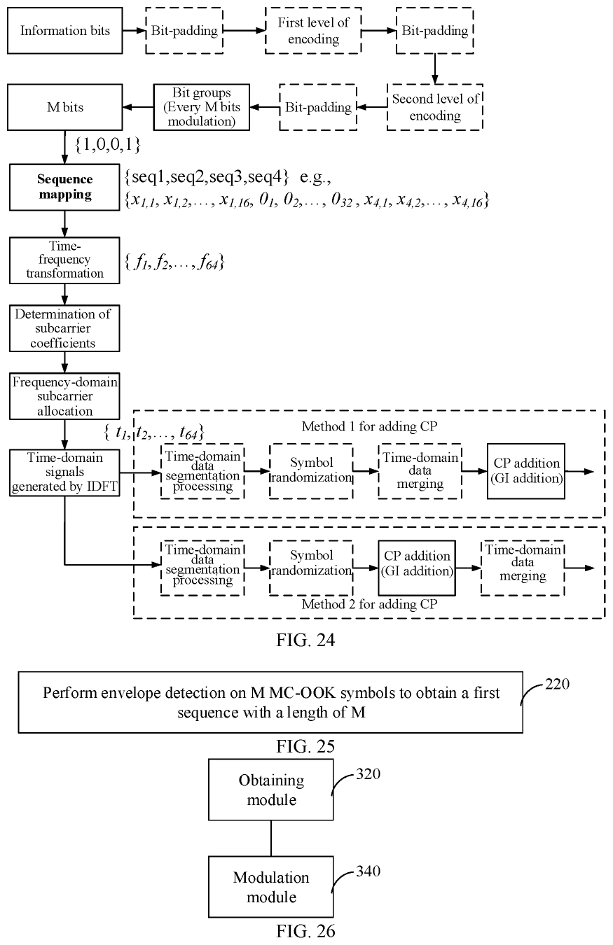

As an exemplary embodiment of Optional design 5, referring to FIG. 24, a sender device obtains M bits. For example, the sender device first obtains information bits in a sequence to be modulated, performs the first bit-padding according to requirements of the first level of encoding, and completes the first encoding after the first bit-padding; then the sender device performs the second bit-padding according to requirements of the second level of encoding, and completes the second encoding after the second bit-padding; after that, the sender device performs the third bit-padding according to the requirement that L and M are divisible, and after the third bit-padding, the information bits with the length of L are divided into bit groups to obtain the first sequences each having the length of M; and every M bits are used for subsequent OOK modulation.

It is assumed that the M bits are {1, 0, 0, 1}, and the sequence mapping is first performed on the M bits; the 1st bit is mapped to seq 1, the 2nd bit is mapped to seq 2, the 3rd bit is mapped to seq 3, the 4th bit is mapped to seq 4, and thus the second sequence with the length of 64 is obtain, i.e., {x_{1,1}, x_{1,2}, . . . , x_{1,16}, 0₁, 0₂, . . . , 0₃₂, x_{4,1}, x_{4,2}, . . . , x_{4,16}}.

The time-frequency transformation is performed on the second sequence with the length of 64 to obtain the frequency-domain sequence with the length of 64, i.e., {f₁, f₂, . . . , f₆₄}. In an example where the number of subcarriers allocated for transmitting OOK symbols is 64 (i.e., N=64), coefficients of the 64 subcarriers are determined based on the frequency-domain sequence with the length of 64. Frequency-domain signals are generated based on the determined coefficients of the subcarriers on the N subcarriers used for signal transmission. Then, the inverse time-frequency transformation is used to obtain time-domain data of 64 samples (short for time-domain OOK symbol data).

Optionally, symbol randomization and CP addition are performed on the time-domain data of the 64 samples. Either of the two methods is used.

Method 1 for adding CP: the time-domain data of the 64 samples is segmented first according to M=4, to obtain time-domain data segments of 4 OOK symbols, and then the symbol randomization is performed on each time-domain data segment. After the symbol randomization, the 4 OOK symbols are merged, and the CP is added to the entire time-domain data after merging.

Method 2 for adding CP: the time-domain data of the 64 samples is segmented first according to M=4, to obtain time-domain data segments of 4 OOK symbols, and then the symbol randomization is performed on each time-domain data segment. After the symbol randomization, the CP is added to each of the 4 OOK symbols, and each OOK symbol corresponds a respective CP. Then, the 4 OOK symbols are merged to obtain the entire time-domain data after merging.

It should be noted that the phase randomization sequence/factor mentioned in the various embodiments of the present disclosure is as follows:
It can be one or more fixed sequences/factors, which are agreed upon or predefined by the communication protocol;
It can be generated by a sequence/factor generation method, which is agreed upon or predefined by the communication protocol;
It can be generated based on sequence/factor generation parameters, and the sequence/factor generation parameters are agreed upon or predefined by the communication protocol, or the sequence/factor generation parameters are pre-configured by the network device, or periodically configured by the network device, or semi-statically configured by the network device, or dynamically configured by the network device, where the sequence/factor generation parameters include, but are not limited to: cyclic shift index, root index, etc.;
It can be a sequence determined based on terminal implementation.

Another point to note is that the phase randomization sequence mentioned in the various embodiments of the present disclosure can further be used to indicate the first information. For example, two bits/sequences are processed using a first phase randomization sequence and a second phase randomization sequence, respectively. The first phase randomization sequence is further used to indicate a type of first information, and the second phase randomization sequence is further used to indicate another type of first information, thereby achieving an effect similar to “symbiotic communication”. For example, the first phase randomization sequence is further used to indicate a first cyclic shift value, and the second phase randomization sequence is further used to indicate a second cyclic shift value. The embodiments of the present disclosure do not limit these.

In optional embodiments based on the above embodiments, the method further includes:
transmitting the M OOK symbols. The OOK symbol can also be referred to as the MC-OOK symbol.

FIG. 25 shows a flowchart of an OOK modulation-based symbol receiving method provided in an exemplary embodiment of the present disclosure. The embodiment is described by taking an example where the method is executed by a recipient device, and the recipient device can be a network device, an AP, an ambient IoT device, or a terminal device. The method includes the following steps.

In step 220, envelope detection is performed on M OOK symbols to obtain a first sequence with a length of M.

The M OOK symbols undergo phase randomization during modulation, which is the OOK modulation as shown in FIGS. 8 to 24.

In some embodiments, the recipient device is a device with a first capability; and the recipient device performs the envelope detection on the M OOK symbols to obtain the first sequence with the length of M.

In some embodiments, the recipient device is a device with a second capability; and the recipient device not only performs the envelope detection on the M OOK symbols to obtain the first sequence with the length of M, but also detects the phase randomization sequence in the M OOK symbols, and determines first information associated with the phase randomization sequence based on the detected phase randomization sequence.

In some embodiments, the recipient device has two receivers: a first-stage receiver and a second-stage receiver. The first-stage receiver is configured to perform the envelope detection on the M OOK symbols to obtain the first sequence with the length of M. The second-stage receiver is configured to detect the phase randomization sequence in the M OOK symbols, and determine the first information associated with the phase randomization sequence based on the detected phase randomization sequence.

The device provided in the embodiments of the present disclosure can be applied to uplink data transmission (ambient IoT device=>network device/AP), downlink data transmission (network device/AP=>ambient IoT device), and sidelink data transmission. The sidelink data transmission includes at least one of the following four forms: ambient IoT device=>other terminal device, other terminal device=>ambient IoT device, ambient IoT device=>ambient IoT device, or other terminal device=>other terminal device.

In some embodiments, the device provided in the embodiments of the present disclosure can be applied not only to the ambient IoT device, but also to the LP-WUR/WUS scenario. That is, the LP-WUS signal transmitted by the network device to the LP-WUR may also use the device provided in the embodiments of the present disclosure.

FIG. 26 shows a structural block diagram of an OOK modulation-based symbol generation device provided in an exemplary embodiment of the present disclosure. The generation device can be implemented as part of a network device, an AP, an ambient IoT device, or a terminal device, and includes an obtaining module 320 and a modulation module 340.

The obtaining module 320 is configured to obtain a first sequence with a length of M, M being a positive integer.

M is the number of OOK symbols transmitted within a preset duration. The preset duration is determined by the basic time-domain unit in the cellular communication system or WIFI system. In some embodiments, the preset duration is 1 OFDM symbol, and 1 OFDM symbol can transmit M OOK symbols. M is the number of OOK symbols transmitted within an OFDM symbol.

In some embodiments, M may be agreed upon by a protocol, or configured by a network device, or determined by a terminal device based on a preset mapping relationship.

In some embodiments, there are multiple candidate values for M, e.g., M={1, 2, 4, 6, 8}.

In some embodiments, referring to FIG. 9, the sequence to be modulated is a sequence with a length of L, and the sequence to be modulated is preprocessed according to the principle of every M bits forming a single first sequence, to obtain multiple first sequences, each first sequence including M bits. OOK modulation is performed on each first sequence.

The modulation module 340 is configured to perform OOK modulation on the first sequence to obtain M OOK symbols.

The OOK modulation is a process of modulating a digital sequence into a wireless signal with an MC-OOK waveform. The OOK modulation is performed on the first sequence to obtain M OOK symbols.

The OOK modulation includes performing phase randomization during modulation. The phase randomization is a process of processing the first sequence or intermediate data using a phase randomization factor or a phase randomization sequence. The intermediate data is intermediate process data generated during the OOK modulation of the first sequence.

In the embodiments, the phase randomization is added in the OOK modulation process, which can flatten the spectrum energy and improve frequency selectivity and anti-interference capability.

In some embodiments, referring to FIG. 9, the OOK modulation includes at least one of:
first processing (upsampling/spreading), time-frequency transformation, determination of subcarrier coefficients, or inverse time-frequency transformation.

The first processing is to convert each bit (also referred to as a logical bit) or element in a sequence into a sequence with a length of K, K being a positive integer greater than 1. The first processing includes at least one of upsampling or spreading. Taking spreading as an example, the spreading refers to a process of repeating each bit or element in a sequence K times. For example, a sequence is {1, 0, 0, 1}, a spreading factor K is equal to 4 (i.e., K=4), and then a second sequence is {1, 1, 1, 1, 0, 0, 0, 0, 0, 0, 0, 0, 1, 1, 1, 1}.

The time-frequency transformation, also known as discrete Fourier transform (DFT), refers to a process of transforming a sequence in the time-domain into frequency-domain data of a plurality of samples.

The determination of subcarrier coefficients refers to a process of determining coefficients of multiple subcarriers during transmission based on the frequency-domain data of the plurality of samples. That is, the determination of subcarrier coefficients is a process of modulating the frequency-domain data after the time-frequency transformation onto the multiple subcarriers.

The inverse time-frequency transformation, also known as inverse DFT (IDFT), refers to a process of converting the frequency-domain data of the plurality of samples into time-domain data of the plurality of samples.

In the embodiments of the present disclosure, the phase randomization is further added in the OOK modulation process. In some embodiments, there may be multiple optional designs for processing timing of the phase randomization.

Optional design 1: the phase randomization is performed before the first processing.

First phase randomization, the first processing, the time-frequency transformation, the determination of subcarrier coefficients, and the inverse time-frequency transformation are sequentially performed on the first sequence to obtain M OOK symbols.

Optional design 2: the phase randomization is performed after the first processing and before the time-frequency transformation.

The first processing, second phase randomization, the time-frequency transformation, the determination of subcarrier coefficients, and the inverse time-frequency transformation are sequentially performed on the first sequence to obtain the M OOK symbols.

Optional design 3: the phase randomization is performed after the inverse time-frequency transformation.

The first processing, the time-frequency transformation, the determination of subcarrier coefficients, the inverse time-frequency transformation, and third phase randomization are sequentially performed on the first sequence to obtain the M OOK symbols.

Optional design 4: the phase randomization is performed after the determination of subcarrier coefficients and before the inverse time-frequency transformation.

The first processing, the time-frequency transformation, the determination of subcarrier coefficients, fourth phase randomization, and the inverse time-frequency transformation are sequentially performed on the first sequence to obtain the M OOK symbols.

Optional design 5: the phase randomization is incorporated into the first processing, and sequence mapping is used to complete the first processing.

The sequence mapping, the time-frequency transformation, the determination of subcarrier coefficients, and the inverse time-frequency transformation are sequentially performed on the first sequence to obtain the M OOK symbols. The sequence mapping is a mapping process that maps bits in the first sequence to a phase randomization sequence.

In some embodiments, optional design 3 can also be combined with optional design 1, optional design 2, optional design 4 and optional design 5 to form new embodiments. That is, after the inverse time-frequency transformation in optional design 1, optional design 2, optional design 4 and optional design 5, the third phase randomization is performed.

Optional design 6: the first phase randomization, the first processing, the time-frequency transformation, the determination of subcarrier coefficients, the inverse time-frequency transformation, and the third phase randomization are sequentially performed on the first sequence to obtain the M OOK symbols.

Optional design 7: the first processing, the second phase randomization, the time-frequency transformation, the determination of subcarrier coefficients, the inverse time-frequency transformation, and the third phase randomization are sequentially performed on the first sequence to obtain the M OOK symbols.

Optional design 8: the first processing, the time-frequency transformation, the determination of subcarrier coefficients, the fourth phase randomization, the inverse time-frequency transformation, and the third phase randomization are sequentially performed on the first sequence to obtain the M OOK symbols.

Optional design 9: the sequence mapping, the time-frequency transformation, the determination of subcarrier coefficients, the inverse time-frequency transformation, and the third phase randomization are sequentially performed on the first sequence to obtain the M OOK symbols.

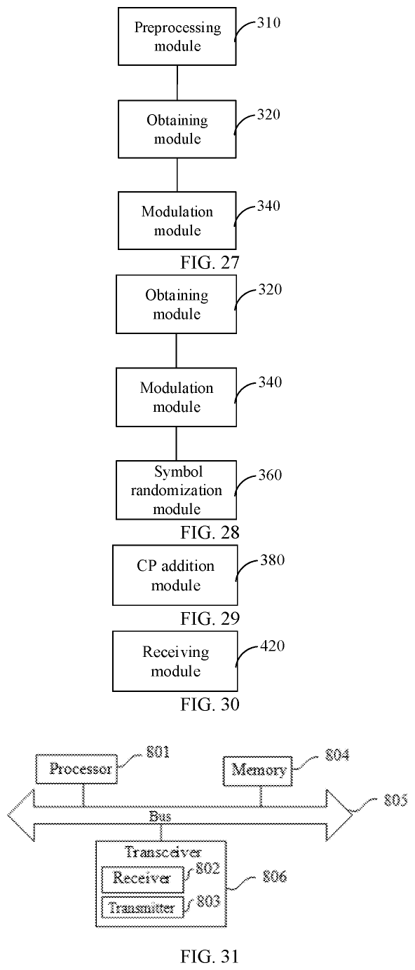

In a further embodiment based on the embodiment shown in FIG. 26, the first sequence with the length of M is obtained by preprocessing a sequence to be modulated, which has a length of L. As shown in FIG. 27, the above device further includes:
a preprocessing module 310, configured to process the sequence to be modulated with the length of L into at least one first sequence, L being greater than or equal to M.

The sequence to be modulated can be of any length. Normally, L is greater than or equal to M, but the possibility of L being less than M cannot be ruled out.

In some embodiments, the sequence to be modulated with the length of L is any one of the following sequences:
an original sequence;
a first encoded sequence obtained by encoding the original sequence;
a first padding sequence with a length being an integer multiple of M obtained by performing bit-padding on the original sequence;
a second padding sequence with a length being an integer multiple of M obtained by performing bit-padding on the first encoded sequence;
a second encoded sequence obtained by encoding the first padding sequence;
a sequence obtained by interleaving the original sequence;
a sequence obtained by interleaving the first encoded sequence;
a sequence obtained by interleaving the first padding sequence;
a sequence obtained by interleaving the second padding sequence; or
a sequence obtained by interleaving the second encoded sequence.

Bit-padding refers to a process of adding a bit with a preset value to the beginning or end of a sequence, e.g., adding a bit with a value of 0 or a bit with a value of 1 to the end of the sequence.

Interleaving is a process that swaps or scrambles bits located at different bit positions in a sequence. For symbols that are adjacent before interleaving, after interleaving, the minimum distance between the symbols is referred to as the interleaving depth; and for symbols that are adjacent after interleaving, before interleaving, the minimum distance between the symbols is referred to as the interleaving width.

In some embodiments, M is agreed upon by a communication protocol, or configured by a network device, or determined based on a preset mapping relationship. For example, different values of M are used depending on different lengths of L. For example, L is less than 200, and M=2; or L is greater than 200 and less than 400, and M=4. In some embodiments, the value(s) of M include at least one of 1, 2, 4, 6, or 8.

In some embodiments, in a case where L is an integer multiple of M, the sequence to be modulated with the length of L is divided into a plurality of first sequences according to a dividing manner of every M bits.

In some embodiments, in a case where L is not an integer multiple of M, the sequence to be modulated with the length of L is processed into a sequence with a length of L′, L′ being an integer multiple of M; and the sequence with the length of L′ is divided into a plurality of sequences with the length of M. For example, the sequence to be modulated with the length of L is processed into the sequence with the length of L′ through bit-padding and/or encoding.

In some embodiments, the value of M can be changed or adjusted to enable L to be an integer multiple of M. That is, in a case where L is not an integer multiple of M, M is updated to be a divisor of L.

In summary, in the device provided in the embodiments, variable rate is achieved by flexibly controlling the value of M. M=2 represents 1 OFDM symbol transmitting 2 OOK symbols; M=4 represents 1 OFDM symbol transmitting 4 OOK symbols; and M=8 represents 1 OFDM symbol transmitting 8 OOK symbols. That is, when the duration of an OFDM symbol is the same, the transmission rates of OOK symbols are different depending on different values of M.

In a further embodiment based on the above embodiment shown in FIG. 26 or 27, as shown in FIG. 28, the device further includes:
a symbol randomization module 360, configured to perform symbol randomization (symbol randomizer) on m OOK symbols.

The symbol randomization can effectively eliminate spectral lines in PSD. In a case where multiple OOK symbols are transmitted for the duration of each OFDM symbol, m OOK symbols are generated each time through allocated N subcarriers.

In some embodiments, referring to FIG. 12, the symbol randomization may be performed using either of the following two methods.

Method 1: the symbol randomization is performed on each of the m OOK symbols.

The symbol randomization is performed individually on each of the m OOK symbols.

The m OOK symbols undergo the symbol randomization symbol by symbol. That is, a first OOK symbol undergoes the symbol randomization first, and then a second OOK symbol undergoes the symbol randomization; after that, a third OOK symbol undergoes the symbol randomization, and so on.

Method 2: the OOK symbols are divided into first-type symbols and second-type symbols, and the symbol randomization is performed on each of the first-type symbols in the m OOK symbols.

The first-type symbol is an OOK symbol corresponding to a bit with a first value, also known as an “OOK-on” symbol. The second-type symbol is an OOK symbol corresponding to a bit with a second value, also known as an “OOK-off” symbol. For example, the first value is 1, and the second value is 0.

The “OOK-on” symbols in the m OOK symbols undergo the symbol randomization symbol by symbol.

In some embodiments, referring to FIG. 16, the symbol randomization module 360 is further configured to: perform signal segmentation on an entire time-domain signal corresponding to the m OOK symbols, to obtain time-domain signal segments corresponding to the m OOK symbols; perform the symbol randomization on the time-domain signal segments corresponding to the m OOK symbols on a per symbol basis or on a per “OOK-on” symbol basis; and merge the time-domain signal segments (after undergoing the symbol randomization) corresponding to the m OOK symbols.

In some embodiments, the symbol randomization includes at least one of the following operations:
phase randomization;
cyclic shift; or
symbol inversion.

In the symbol randomization process, the phase randomization means that point multiplication is performed on a time-domain signal segment corresponding to a single OOK symbol and a phase randomization sequence, and the phase randomization sequences associated with different OOK symbols are the same or different. The cyclic shift refers to a process of cyclically shifting a time-domain signal segment corresponding to a single OOK symbol, and the cyclic shift values associated with different OOK symbols are the same or different. The symbol inversion means that the symbol inversion or (pseudo) random symbol inversion is performed on a time-domain signal segment corresponding to a single OOK symbol.

### Phase Randomization

Optionally, different OOK symbols use the same phase randomization sequence, and the modulus of each phase randomization factor in the phase randomization sequence is 1. Optionally, different OOK symbols use different phase randomization sequences, and the modulus of each phase randomization factor in the phase randomization sequence is 1. Optionally, some OOK symbols use the same phase randomization sequence, and other OOK symbols use different phase randomization sequences.

In some embodiments, OOK symbols belonging to different groups use different phase randomization sequences, and each group of OOK symbols includes M OOK symbols.

In some embodiments, different phase randomization sequences are obtained by cyclically shifting the same initial phase randomization sequence. Different OOK symbols use the same initial randomization sequence, and when the phase randomization is implemented in practice, the initial randomization sequence undergoes different cyclic shifts, and the cyclically shifted phase randomization sequences are used for processing.

In some embodiments, the phase randomization sequence used is updated on a per OOK symbol basis, or the phase randomization sequence used is updated on a per “OOK-On” symbol basis, or the phase randomization sequence used is updated every M OOK symbols.

### Cyclic Shift

Optionally, different OOK symbols use the same cyclic shift value; or different OOK symbols use different cyclic shift values; or different “OOK-On” symbols use different cyclic shift values; or OOK symbols belonging to different groups use different cyclic shift values, OOK symbols belonging to the same group use the same cyclic shift value, and each group of OOK symbols includes M OOK symbols.

In some embodiments, the cyclic shift values used for different OOK symbols are determined based on a pseudo-random manner. In the case where the cyclic shift values are determined using the pseudo-random manner, the cyclic shift values used for different OOK symbols are completely different, or are partially the same and partially different, or are all the same, each of which may occur.

### Symbol Inversion

Optionally, different OOK symbols use random symbol inversion; or different OOK symbols use regular symbol inversion; or OOK symbols belonging to different groups use random symbol inversion, OOK symbols belonging to the same group use the same symbol inversion, and each group of OOK symbols includes M OOK symbols.

For example, the random symbol inversion may be that a pseudo-random generator is used to generate “1” and “−1”, to determine whether to perform the phase inversion on the OOK symbol. For example, point multiplication is performed on the time-domain signal segment corresponding to the OOK symbol and “1” or “−1” determined by the pseudo-random generator.

For example, the regular symbol inversion may be that the symbol inversion is performed at intervals on “OOK-On” symbols. For example, the (2k+1)-th OOK-On symbol undergoes the phase inversion, while the 2k-th OOK-On symbol does not undergo the phase inversion.

In summary, in the device provided in the embodiments, spectral lines in PSD can be eliminated by using the symbol randomization. In some communication systems (e.g., 802.11) that require the elimination of spectral lines, after processing the OOK symbols through the above symbol randomization, the spectral lines in PSD can be eliminated to meet the communication requirements of these communication systems, and thus ambient IoT devices can be deployed in these communication systems.

In a further embodiment based on the above embodiment shown in any one of FIGS. 26 to 28, as shown in FIG. 29, the device further includes:
a CP addition module 380, configured to add a CP/GI to each of the M OOK symbols, or add a CP/GI to the M OOK symbols as a whole.

In some embodiments, as shown in Method 1 of FIG. 14, after performing time-domain segmentation (and symbol randomization) on the M OOK symbols, signal merging is performed first, and then the CP/GI is added at the beginning of the entire time-domain signal corresponding to the M OOK symbols.

In some embodiments, as shown in Method 2 of FIG. 14, after performing time-domain segmentation (and symbol randomization) on the M OOK symbols, the CP/GI is added to the time-domain signal segment corresponding to each OOK symbol, and then signal merging is performed on the time-domain signal segments corresponding to the M OOK symbols.

In summary, in the device provided in the embodiments, multipath transmission interference received during the transmission of OOK symbols can be reduced or eliminated by adding the CP/GI to each symbol or to the symbols as a whole, thereby improving the reception quality of OOK symbols.

In a further embodiment based on the above embodiment shown in any one of FIGS. 26 to 29, various optional designs are introduced as follows.

### Optional Design 1

The modulation module 340 is configured to perform the first phase randomization on the first sequence to obtain a second sequence.

The first sequence includes M bits.

In some embodiments, the first phase randomization may be performed in any one of the following three methods.

Method 1: the phase randomization is performed on each of the M bits.

The phase randomization is performed individually on each of the M bits, with the bit as the execution granularity. An associated phase randomization factor is generated individually for each of the M bits, and the phase randomization factor associated with each bit is independent; each bit is processed based on the associated phase randomization factor. For example, each bit is multiplied by the associated phase randomization factor.

In some embodiments, an i-th phase randomization factor is generated for an i-th bit in the M bits, the i-th bit is associated with the i-th phase randomization factor, and the i-th bit is multiplied by the i-th phase randomization factor. A value of i is in a range of 0 to M−1, or the value of i is in a range of 1 to M.

In some embodiments, the modulus of each phase randomization factor is 1. Each phase randomization factor can be any one of the following: 1, −1, or a complex number containing both a real part and an imaginary part.

For example, the first sequence includes 4 bits, which are {1, 0, 0, 1}; the phase randomization factor associated with the first bit is x₁, the phase randomization factor associated with the second bit is x₂, the phase randomization factor associated with the third bit is x₃, and the phase randomization factor associated with the fourth bit is x₄. Then, the second sequence is {x₁, 0, 0, x₄}.

Method 2: the phase randomization is performed on each target bit in the M bits, the target bit being a bit with a first value.

In some embodiments, the target bit is a bit with a value of 1. Since a bit with a value of 0 will still be 0 after being multiplied by a phase randomization factor, it may be considered that the phase randomization is performed only on the bit(s) with the value of 1.

The phase randomization is performed individually on each target bit in the M bits, with the target bit as the execution granularity. An associated phase randomization factor is generated individually for each target bit in the M bits, and the phase randomization factor associated with each target bit is independent; and each target bit is multiplied by the associated phase randomization factor. For example, an associated phase randomization factor is generated individually for each bit with the value of 1 among the M bits, and each bit with the value of 1 is multiplied by its associated phase randomization factor.

In some embodiments, the modulus of each phase randomization factor is 1. Each phase randomization factor can be any one of the following: 1, −1, or a complex number containing both a real part and an imaginary part.

For example, the first sequence includes 4 bits, which are {1, 0, 0, 1}, and 2 bits have the value of 1; the phase randomization factor associated with the first bit with the value of 1 is x₁, and the phase randomization factor associated with the second bit with the value of 1 is x₂. Then, the second sequence is {x₁, 0, 0, x₂}.

Method 3: the phase randomization is performed on the M bits.

The phase randomization is performed on the M bits as a whole. The M bits are processed using a phase randomization sequence with a length of M. For example, point multiplication is performed on the M bits and the phase randomization sequence with the length of M. The phase randomization sequence with the length of M includes M phase randomization factors.

In some embodiments, the modulus of each phase randomization factor is 1. Each phase randomization factor can be any one of the following: 1, −1, or a complex number containing both a real part and an imaginary part.

For example, the first sequence includes 4 bits, which are {1, 0, 0, 1}, and the phase randomization sequence with the length of M is {x₁, x₂, x₃, x₄}. Then, the second sequence is {x₁, 0, 0, x₄}.

The phase randomization sequence includes M phase randomization factors; or the phase randomization sequence is a PN sequence; or the phase randomization sequence is a ZC sequence; or the phase randomization sequence is an m-sequence; or the phase randomization sequence is a sequence with a peak to average power ratio (PAPR) less than a threshold, also known as a low PAPR sequence.

The modulation module 340 is configured to perform the first processing on the second sequence to obtain a third sequence with a length of N′.

By performing the first processing on each element in the second sequence, the third sequence with the length of N′ is obtained, where N′≥N, and N is the number of subcarriers.

The first processing is to convert each element in the second sequence into a sequence with a length of K, K being a positive integer greater than 1. The first processing includes at least one of upsampling or spreading. Taking spreading as an example, the spreading refers to a process of repeating each element in a sequence K times.

In some embodiments, each element is repeated the same number of times; or each element is repeated a different number of times; or some elements are repeated the same number of times and some elements are repeated different numbers of times.

In some embodiments, in an example where the number of spreading times is K and each element is repeated the same number of times, the third sequence with the length of N′ is obtained by continuously repeating each element in the second sequence K times, where N′=K*M. In the third sequence, every K consecutive elements are obtained by repeating a single element in the second sequence K times.

In some embodiments, in an example where the number of spreading times is K and the first M−1 elements are repeated the same number of times, the third sequence with the length of N′(N′=K*M) is obtained by continuously repeating each of the first M−1 elements in the second sequence K times and repeating the last element N′−K*(M−1) times. In the third sequence, each of the first M−1 groups of sequences (each group having K consecutive elements) is obtained by spreading a single element in the second sequence, and the last group of sequences (having N′−K*(M−1) consecutive elements) is obtained by spreading the last element in the second sequence.

The modulation module 340 is configured to perform the time-frequency transformation on the third sequence to obtain frequency-domain data of N′ samples.

The discrete Fourier transform is performed on the third sequence with the length of N′ to obtain the frequency-domain data of N′ samples.

The modulation module 340 is configured to determine coefficients of N subcarriers based on the frequency-domain data of N′ samples, to obtain N frequency-domain data corresponding to the N subcarriers.

When N′=N, a coefficient of a j-th subcarrier is determined based on frequency-domain data of a j-th sample, where a value of j is in a range of 0 to N−1 or in a range of 1 to N; and the N frequency-domain data corresponding to the N subcarriers are obtained.

When N′>N, the frequency-domain data of N′ samples is truncated to frequency-domain data of N samples (for example, only frequency-domain data of the first or last N samples are taken); a coefficient of a j-th subcarrier is determined based on frequency-domain data of a j-th sample, where a value of j is in a range of 0 to N−1 or in a range of 1 to N; and the N frequency-domain data corresponding to the N subcarriers are obtained.

The process of determining the coefficients of N subcarriers during transmission based on the frequency-domain data of N samples means that the frequency-domain data of N samples after the time-frequency transformation is modulated onto the N subcarriers.

The modulation module 340 is configured to perform the inverse time-frequency transformation on the N frequency-domain data corresponding to the N subcarriers, to obtain time-domain OOK symbol data of B samples.

The discrete inverse Fourier transform is performed on the N frequency-domain data corresponding to the N subcarriers, to obtain the time-domain OOK symbol data of B samples.

In some embodiments, B is an integer multiple of N. For example, N represents 48 subcarriers, and B represents time-domain OOK symbol data of 1024 samples.

The modulation module 340 is configured to obtain the M OOK symbols based on the time-domain OOK symbol data of B samples.

Each OOK symbol carries time-domain OOK symbol data of B/M samples.

In summary, in the device provided in the embodiments, energy flattening at the subcarrier level or bit level is achieved by performing the first phase randomization with the bit in the first sequence as the granularity, thereby improving frequency selectivity and anti-interference capability.

### Optional Design 2

The modulation module 340 is configured to perform the first processing on the first sequence to obtain a second sequence.

The first processing is performed on the first sequence to obtain the second sequence with a length of N′.

By performing the first processing on each bit in the first sequence, the second sequence with the length of N′ is obtained, where N′≥N, and N is the number of subcarriers.

The first processing is to convert each bit (also referred to as a logical bit) in the first sequence into a sequence with a length of K, K being a positive integer greater than 1. The first processing includes at least one of upsampling or spreading. Taking spreading as an example, the spreading refers to a process of repeating each bit in a sequence K times.

In some embodiments, each bit is repeated the same number of times; or each bit is repeated a different number of times; or some bits are repeated the same number of times and some bits are repeated different numbers of times.

In some embodiments, in an example where the number of spreading times is K and each bit is repeated the same number of times, the second sequence with the length of N′ is obtained by continuously repeating each bit in the first sequence K times, where N′=K*M. In the second sequence, every K consecutive bits are obtained by repeating a single bit in the first sequence K times (which means that every K consecutive bits are obtained by upsampling or spreading).

For example, the first sequence includes 4 bits, which are {1, 0, 0, 1}, and the number of spreading times is 4. Then, the second sequence includes 16 bits, i.e., {1, 1, 1, 1, 0, 0, 0, 0, 0, 0, 0, 0, 1, 1, 1, 1}.

In some embodiments, in an example where the number of spreading times is K and the first M−1 bits are repeated the same number of times, the second sequence with the length of N′(N′=K*M) is obtained by continuously repeating each of the first M−1 bits in the first sequence K times and repeating the last bit N′−K*(M−1) times. In the second sequence, each of the first M−1 groups of sequences (each group having K consecutive bits) is obtained by spreading a single bit in the first sequence, and the last group of sequences (having N′−K*(M−1) consecutive bits) is obtained by spreading the last bit in the first sequence.

The modulation module 340 is configured to perform the second phase randomization on the second sequence to obtain a third sequence.

The second sequence includes M groups of sequences, and each group of sequences includes K bits, or each of the first M−1 groups of sequences includes K bits, and the last group of sequences includes N′−K*(M−1) bits.

The second sequence is obtained by performing the first processing on the first sequence, and each group of sequences is obtained by performing the first processing on a single bit in the first sequence.

In some embodiments, the second phase randomization may be performed in any one of the following three methods.

Method 1: the phase randomization is performed on each group of sequences in the second sequence.

The phase randomization is performed individually on each group of sequences in the second sequence.

In some embodiments, an associated phase randomization sequence is determined for each group of sequences in the second sequence, and the phase randomization sequence associated with each group of sequences is independent; each group of sequences is processed using the associated phase randomization sequence. For example, point multiplication is performed on each group of sequences and the associated phase randomization sequence.

In an example where the second sequence includes M groups of sequences, an i-th phase randomization sequence is generated for an i-th group of sequences in the M groups of sequences, the i-th group of sequences is associated with the i-th phase randomization sequence, and the i-th group of sequences is multiplied by the i-th phase randomization sequence. A value of i is in a range of 0 to M−1, or the value of i is in a range of 1 to M.

Each phase randomization sequence includes at least two phase randomization factors, and a length of each phase randomization sequence is the same as that of the group of sequences associated with the phase randomization sequence. In some embodiments, the length of each phase randomization sequence is K. In some embodiments, the lengths of the phase randomization sequences associated with the first M−1 groups of sequences are K, and the length of the phase randomization sequence associated with the last group of sequences is N′−K*(M−1). In some other embodiments, the modulus of each phase randomization factor is 1.

For example, the second sequence includes 16 bits, which are {1, 1, 1, 1, 0, 0, 0, 0, 0, 0, 0, 0, 1, 1, 1, 1}; the phase randomization sequence associated with the first group of sequences {1, 1, 1, 1} is {x₁, x₂, x₃, x₄}, the phase randomization sequence associated with the second group of sequences {0, 0, 0, 0} is {x₅, x₆, x₇, x₈}, the phase randomization sequence associated with the third group of sequences {0, 0, 0, 0} is {x₉, x₁₀, x₁₁, x₁₂}, and the phase randomization sequence associated with the fourth group of sequences {1, 1, 1, 1} is {x₁₃, x₁₄, x₁₅, x₁₆}. Then, the second sequence after the phase randomization is {x₁, x₂, x₃, x₄, 0, 0, 0, 0, 0, 0, 0, 0, x₁₃, x₁₄, x₁₅, x₁₆}.

In some embodiments, an associated phase randomization factor is determined for each group of sequences in the second sequence, and the phase randomization factor associated with each group of sequences is independent; each group of sequences is processed using the associated phase randomization factor. For example, point multiplication is performed on each group of sequences and the associated phase randomization factor. In an example where the second sequence includes M groups of sequences, an i-th phase randomization factor is generated for an i-th group of sequences in the M groups of sequences, the i-th group of sequences is associated with the i-th phase randomization factor, and the i-th group of sequences is multiplied by the i-th phase randomization factor. A value of i is in a range of 0 to M−1, or the value of i is in a range of 1 to M.

In some embodiments, the modulus of each phase randomization factor is 1.

For example, the second sequence includes 16 bits, which are {1, 1, 1, 1, 0, 0, 0, 0, 0, 0, 0, 0, 1, 1, 1, 1}; the phase randomization factor associated with the first group of sequences {1, 1, 1, 1} is {x₁}, the phase randomization factor associated with the second group of sequences {0, 0, 0, 0} is {x₂}, the phase randomization factor associated with the third group of sequences {0, 0, 0, 0} is {x₃}, and the phase randomization factor associated with the fourth group of sequences {1, 1, 1, 1} is {x₄}. Then, the second sequence after the phase randomization is {x₁, x₁, x₁, x₁, 0,0, 0, 0, 0, 0, 0, 0, x₄, x₄, x₄, x₄}.

Method 2: the phase randomization is performed on each group of target sequences in the second sequence, the group of target sequences being a bit sequence with a first value.

The phase randomization is performed on each group of target sequences in the second sequence.

In some embodiments, an associated phase randomization sequence is determined for each group of target sequences in the second sequence, and the phase randomization sequence associated with each group of target sequences is independent; and each group of target sequences is processed using the associated phase randomization sequence. For example, point multiplication is performed on each group of target sequences and the associated phase randomization sequence.

In an example where the second sequence includes M groups of sequences, an i-th phase randomization sequence is generated for an i-th group of target sequences in the M groups of sequences, the i-th group of target sequences is associated with the i-th phase randomization sequence, and the i-th group of target sequences is multiplied by the i-th phase randomization sequence. A value of i is in a range of 0 to D−1, or the value of i is in a range of 1 to D. D is the number of groups of target sequences with the first value among the M groups of sequences.

Each phase randomization sequence includes at least two phase randomization factors, and a length of each phase randomization sequence is the same as that of the sequence associated with the phase randomization sequence. In some embodiments, the modulus of each phase randomization factor is 1.

For example, the second sequence includes 16 bits, which are {1, 1, 1, 1, 0, 0, 0, 0, 0, 0, 0, 0, 1, 1, 1, 1}, the first and fourth groups of sequences each are a sequence with the value of 1, i.e., {1, 1, 1, 1}; the phase randomization sequence associated with the first group of sequences {1, 1, 1, 1} is {x₁, x₂, x₃, x₄}, and the phase randomization sequence associated with the fourth group of sequences {1, 1, 1, 1} is {x₅, x₆, x₇, x₈}. Then, the second sequence after the phase randomization is {x₁, x₂, x₃, x₄, 0, 0, 0, 0, 0, 0, 0, 0, x₅, x₆, x₇, x₈}.

In some embodiments, an associated phase randomization factor is determined for each group of target sequences in the second sequence, and the phase randomization factor associated with each group of target sequences is independent; and each group of target sequences is processed using the associated phase randomization factor. For example, point multiplication is performed on each group of target sequences and the associated phase randomization factor.

In an example where the second sequence includes M groups of sequences, an i-th phase randomization factor is generated for an i-th group of target sequences in the M groups of sequences, the i-th group of target sequences is associated with the i-th phase randomization factor, and the i-th group of target sequences is multiplied by the i-th phase randomization factor. A value of i is in a range of 0 to D−1, or the value of i is in a range of 1 to D. D is the number of groups of target sequences with the first value among the M groups of sequences.

In some embodiments, the modulus of each phase randomization factor is 1.

For example, the second sequence includes 16 bits, which are {1, 1, 1, 1, 0, 0, 0, 0, 0, 0, 0, 0, 1, 1, 1, 1}; the phase randomization factor associated with the first group of sequences {1, 1, 1, 1} is {x₁}, and the phase randomization factor associated with the fourth group of sequences {1, 1, 1, 1} is {x₂}. Then, the second sequence after the phase randomization is {x₁, x₁, x₁, x₁, 0, 0, 0, 0, 0, 0, 0, 0, x₂, x₂, x₂, x₂}.

Method 3: the phase randomization is performed on all bits in the second sequence.

In some embodiments, the phase randomization is performed on all bits in the second sequence as a whole.

The N′ bits in the second sequence are processed using a phase randomization sequence with a length of N′. For example, point multiplication is performed on the N′ bits in the second sequence and the phase randomization sequence with the length of N′. The phase randomization sequence with the length of N′ includes N′ phase randomization factors.

In some embodiments, the modulus of each phase randomization factor is 1.

For example, the second sequence includes 4 bits, which are {1, 0, 0, 1}, and the phase randomization sequence with the length of N′ is {x₁, x₂, x₃, x₄}. Then, the second sequence is {x₁, 0, 0, x₄}.

The phase randomization sequence includes N′ phase randomization factors; or the phase randomization sequence is a ZC sequence; or the phase randomization sequence is an N′ sequence; or the phase randomization sequence is a sequence with a peak to average power ratio (PAPR) less than a threshold, also known as a low PAPR sequence.

The modulation module 340 is configured to perform the time-frequency transformation on the third sequence to obtain frequency-domain data of N′ samples.

The discrete Fourier transform is performed on the third sequence with the length of N′ to obtain the frequency-domain data of N′ samples.

The modulation module 340 is configured to determine coefficients of N subcarriers based on the frequency-domain data of N′ samples, to obtain N frequency-domain data corresponding to the N subcarriers.

When N′=N, a coefficient of a j-th subcarrier is determined based on frequency-domain data of a j-th sample, where a value of j is in a range of 0 to N−1 or in a range of 1 to N; and the N frequency-domain data corresponding to the N subcarriers are obtained.

When N′>N, the frequency-domain data of N′ samples is truncated to frequency-domain data of N samples (for example, only frequency-domain data of the first or last N samples are taken); a coefficient of a j-th subcarrier is determined based on frequency-domain data of a j-th sample, where a value of j is in a range of 0 to N−1 or in a range of 1 to N; and the N frequency-domain data corresponding to the N subcarriers are obtained.

The process of determining the coefficients of N subcarriers during transmission based on the frequency-domain data of N samples means that the frequency-domain data of N samples after the time-frequency transformation is modulated onto the N subcarriers.

The modulation module 340 is configured to perform the inverse time-frequency transformation on the N frequency-domain data corresponding to the N subcarriers, to obtain time-domain OOK symbol data of B samples.

The discrete inverse Fourier transform is performed on the N frequency-domain data corresponding to the N subcarriers, to obtain the time-domain OOK symbol data of B samples.

In some embodiments, B is an integer multiple of N. For example, N represents 48 subcarriers, and B represents time-domain OOK symbol data of 1024 samples.

The modulation module 340 is configured to obtain the M OOK symbols based on the time-domain OOK symbol data of B samples.

Each OOK symbol carries time-domain OOK symbol data of B/M samples.

In summary, in the device provided in the embodiments, energy flattening at the subcarrier level or bit level is achieved by performing the second phase randomization with the bit in the second sequence as the granularity, thereby improving frequency selectivity and anti-interference capability.

### Optional Design 3

The modulation module 340 is configured to perform the first processing on the first sequence to obtain a second sequence.

The first processing is performed on the first sequence to obtain the second sequence with a length of N′.

By performing the first processing on each bit in the first sequence, the second sequence with the length of N′ is obtained, where N′≥N, and N is the number of subcarriers.

The first processing is to convert each bit (also referred to as a logical bit) in the first sequence into a sequence with a length of K, K being a positive integer greater than 1. The first processing includes at least one of upsampling or spreading. Taking spreading as an example, the spreading refers to a process of repeating each bit in a sequence K times.

In some embodiments, each bit is repeated the same number of times; or each bit is repeated a different number of times; or some bits are repeated the same number of times and some bits are repeated different numbers of times.

In some embodiments, in an example where the number of spreading times is K and each bit is repeated the same number of times, the second sequence with the length of N′ is obtained by continuously repeating each bit in the first sequence K times, where N′=K*M. In the second sequence, every K consecutive bits are obtained by repeating a single bit in the first sequence K times (which means that every K consecutive bits are obtained by upsampling or spreading).

For example, the first sequence includes 4 bits, which are {1, 0, 0, 1}, and the number of spreading times is 4. Then, the second sequence includes 16 bits, i.e., {1, 1, 1, 1, 0, 0, 0, 0, 0, 0, 0, 0, 1, 1, 1, 1}.

In some embodiments, in an example where the number of spreading times is K and the first M−1 bits are repeated the same number of times, the second sequence with the length of N′(N′=K*M) is obtained by continuously repeating each of the first M−1 bits in the first sequence K times and repeating the last bit N′−K*(M−1) times. In the second sequence, each of the first M−1 groups of sequences (each group having K consecutive bits) is obtained by spreading a single bit in the first sequence, and the last group of sequences (having N′−K*(M−1) consecutive bits) is obtained by spreading the last bit in the first sequence.

The modulation module 340 is configured to perform the time-frequency transformation on the second sequence to obtain frequency-domain data of N′ samples.

The discrete Fourier transform is performed on the second sequence with the length of N′ to obtain the frequency-domain data of N′ samples.

The modulation module 340 is configured to determine coefficients of N subcarriers based on the frequency-domain data of N′ samples, to obtain N frequency-domain data corresponding to the N subcarriers.

When N′=N, a coefficient of a j-th subcarrier is determined based on frequency-domain data of a j-th sample, where a value of j is in a range of 0 to N−1 or in a range of 1 to N; and the N frequency-domain data corresponding to the N subcarriers are obtained.

When N′>N, the frequency-domain data of N′ samples is truncated to frequency-domain data of N samples (for example, only frequency-domain data of the first or last N samples are taken); a coefficient of a j-th subcarrier is determined based on frequency-domain data of a j-th sample, where a value of j is in a range of 0 to N−1 or in a range of 1 to N; and the N frequency-domain data corresponding to the N subcarriers are obtained.

The process of determining the coefficients of N subcarriers during transmission based on the frequency-domain data of N samples means that the frequency-domain data of N samples after the time-frequency transformation is modulated onto the N subcarriers.

The modulation module 340 is configured to perform the inverse time-frequency transformation on the N frequency-domain data corresponding to the N subcarriers, to obtain time-domain OOK symbol data of B samples.

The discrete inverse Fourier transform is performed on the N frequency-domain data corresponding to the N subcarriers, to obtain the time-domain OOK symbol data of B samples.

In some embodiments, B is an integer multiple of N. For example, N represents 48 subcarriers, and B represents time-domain OOK symbol data of 1024 samples.

The modulation module 340 is configured to perform the third phase randomization on the time-domain OOK symbol data to obtain symbol data after the phase randomization.

The time-domain OOK symbol data includes M groups of symbol data, and each group of symbol data includes symbol data of K*b samples, or each of the first M−1 groups of symbol data includes symbol data of K*b samples, and the last group of symbol data includes symbol data of (N−K*(M−1))*b samples. Here, b is a positive integer, and K*b*M=B.

The time-domain OOK symbol data is obtained by performing the first processing, the time-frequency transformation, the determination of subcarrier coefficients, and the inverse time-frequency transformation on the first sequence, and each group of symbol data is obtained by processing a single bit in the first sequence.

In some embodiments, the third phase randomization may be performed in any one of the following three methods.

Method 1: the phase randomization is performed on each group of symbol data in the time-domain OOK symbol data.

The phase randomization is performed individually on each group of symbol data in the time-domain OOK symbol data.

In some embodiments, an associated phase randomization sequence is determined for each group of symbol data in the time-domain OOK symbol data, and the phase randomization sequence associated with each group of symbol data is independent; and each group of symbol data is processed using the associated phase randomization sequence. For example, point multiplication is performed on each group of symbol data and the associated phase randomization sequence.

In an example where the time-domain OOK symbol data includes M groups of symbol data, an i-th phase randomization sequence is generated for an i-th group of symbol data in the M groups of symbol data, the i-th group of symbol data is associated with the i-th phase randomization sequence, and the i-th group of symbol data is multiplied by the i-th phase randomization sequence. A value of i is in a range of 0 to M−1, or the value of i is in a range of 1 to M.

Each phase randomization sequence includes at least two phase randomization factors, and a length of each phase randomization sequence is the same as that of the symbol data associated with the phase randomization sequence. In some embodiments, the length of each phase randomization sequence is K*b. In some embodiments, the lengths of the phase randomization sequences associated with the first M−1 groups of symbol data are K*b, and the length of the phase randomization sequence associated with the last group of symbol data is (N−K*(M−1))*b. In some other embodiments, the modulus of each phase randomization factor is 1.

For example, b is 1, and the time-domain OOK symbol data includes t_{i,1}, t_{i,2}, . . . , t_{i,k} (i=1, 2, . . . , M, and k=1, 2, . . . , K); the phase randomization sequence associated with the first group of symbol data {t_{1,1}, t_{1,2}, . . . , t_{1,k}} is {x₁, x₂, x₃, x₄}, the phase randomization sequence associated with the second group of symbol data {t_{2,1}, t_{2,2}, . . . , t_{2,k}} is {x₅, x₆, x₇, x₈}, the phase randomization sequence associated with the third group of symbol data {t_{3,1}, t_{3,2}, . . . , t_{3,k}} is {x₉, x₁₀, x₁₁, x₁₂}, the phase randomization sequence associated with the fourth group of symbol data {t_{4,1}, t_{4,2}, . . . , t_{4,k}} is {x₁₃, x₁₄, x₁₅, x₁₆}, and so on.

In some embodiments, an associated phase randomization factor is determined for each group of symbol data in the time-domain OOK symbol data, and the phase randomization factor associated with each group of symbol data is independent; and each group of symbol data is processed using the associated phase randomization factor. For example, point multiplication is performed on each group of symbol data and the associated phase randomization factor.

In an example where the time-domain OOK symbol data includes M groups of symbol data, an i-th phase randomization factor is generated for an i-th group of symbol data in the M groups of symbol data, the i-th group of symbol data is associated with the i-th phase randomization factor, and the i-th group of symbol data is multiplied by the i-th phase randomization factor. A value of i is in a range of 0 to M−1, or the value of i is in a range of 1 to M.

In some embodiments, the modulus of each phase randomization factor is 1.

For example, b is 1, the time-domain OOK symbol data includes {t_{i,1}, t_{i,2}, . . . , t_{i,k}} (i=1, 2, . . . , M, and k=1, 2, . . . , K); the phase randomization sequence associated with the first group of symbol data {t_{1,1}, t_{1,2}, . . . , t_{1,k}} is {x₁}, the phase randomization sequence associated with the second group of symbol data {t_{2,1}, t_{2,2}, . . . , t_{2,k}} is {x₂}, the phase randomization sequence associated with the third group of symbol data {t_{3,1}, t_{3,2}, . . . , t_{3,k}} is {x₃}, the phase randomization sequence associated with the fourth group of symbol data {t_{4,1}, t_{4,2}, . . . , t_{4,k}} is {x₄}, and so on.

Method 2: the phase randomization is performed on each group of target symbol data in the time-domain OOK symbol data, each group of target symbol data being obtained by processing a bit with a first value in the first sequence.

The phase randomization is performed individually on each group of target symbol data in the time-domain OOK symbol data.

In some embodiments, each group of target symbol data is obtained by processing a single bit with a value of 1 in the first sequence.

In some embodiments, an associated phase randomization sequence is determined for each group of target symbol data in the time-domain OOK symbol data, and the phase randomization sequence associated with each group of target symbol data is independent; and each group of target symbol data is processed using the associated phase randomization sequence. For example, point multiplication is performed on each group of target symbol data and the associated phase randomization sequence. In an example where the time-domain OOK symbol data includes M groups of symbol data, an i-th phase randomization sequence is generated for an i-th group of target symbol data in the M groups of symbol data, the i-th group of target symbol data is associated with the i-th phase randomization sequence, and the i-th group of target symbol data is multiplied by the i-th phase randomization sequence. A value of i is in a range of 0 to D−1, or the value of i is in a range of 1 to D. D is the number of groups of target symbol data among the M groups of symbol data.

Each phase randomization sequence includes at least two phase randomization factors, and a length of each phase randomization sequence is the same as that of the symbol data associated with the phase randomization sequence. In some embodiments, the modulus of each phase randomization factor is 1.

In some embodiments, an associated phase randomization factor is determined for each group of target symbol data in the time-domain OOK symbol data, and the phase randomization factor associated with each group of target symbol data is independent; and each group of target symbol data is processed using the associated phase randomization factor. For example, point multiplication is performed on each group of target symbol data and the associated phase randomization factor. In an example where the time-domain OOK symbol data includes M groups of symbol data, an i-th phase randomization factor is generated for an i-th group of target symbol data in the M groups of symbol data, the i-th group of target symbol data is associated with the i-th phase randomization factor, and the i-th group of target symbol data is multiplied by the i-th phase randomization factor. A value of i is in a range of 0 to D−1, or the value of i is in a range of 1 to D. D is the number of groups of target symbol data among the M groups of symbol data.

In some embodiments, the modulus of each phase randomization factor is 1.

Method 3: the phase randomization is performed on symbol data of all samples in the time-domain OOK symbol data.

The phase randomization is performed on symbol data of all samples in the time-domain OOK symbol data as a whole.

In some embodiments, point multiplication is performed on the symbol data of B samples in the time-domain OOK symbol data and the phase randomization sequence with the length of B. The phase randomization sequence with the length of B includes B phase randomization factors.

In some embodiments, the modulus of each phase randomization factor is 1.

Taking B=M*K as an example, the time-domain OOK symbol data includes {t_{i,1}, t_{i,2}, . . . , t_{i,k}} (i=1, 2, . . . , M, and k=1, 2, . . . , K), and the phase randomization sequence with the length of N′=M*K is {x_{i,1}, x_{i,2}, . . . , x_{i,k}}.

The phase randomization sequence includes N′ phase randomization factors; or the phase randomization sequence is a ZC sequence; or the phase randomization sequence is an M sequence; or the phase randomization sequence is a sequence with a peak to average power ratio (PAPR) less than a threshold, also known as a low PAPR sequence.

The modulation module 340 is configured to obtain the M OOK symbols based on the symbol data after the phase randomization.

In some embodiments, each OOK symbol carries K symbol data after the phase randomization. In some embodiments, the first M−1 OOK symbols each carry K symbol data after the phase randomization, and the last OOK symbol carries N−K*(M−1) symbol data after the phase randomization.

In summary, in the device provided in the embodiments, energy flattening at the sample level is achieved by performing the third phase randomization with the symbol data of each sample in the time-domain OOK symbol data as the granularity, thereby achieving finer-grained energy flattening and improving frequency selectivity and anti-interference capability.

### Optional Design 4

The modulation module 340 is configured to perform the first processing on the first sequence to obtain a second sequence.

The first processing is performed on the first sequence to obtain the second sequence with a length of N′.

By performing the first processing on each bit in the first sequence, the second sequence with the length of N′ is obtained, where N′≥N, and N is the number of subcarriers.

The first processing is to convert each bit (also referred to as a logical bit) in the first sequence into a sequence with a length of K, K being a positive integer greater than 1. The first processing includes at least one of upsampling or spreading. Taking spreading as an example, the spreading refers to a process of repeating each bit in a sequence K times.

In some embodiments, each bit is repeated the same number of times; or each bit is repeated a different number of times; or some bits are repeated the same number of times and some bits are repeated different numbers of times.

In some embodiments, in an example where the number of spreading times is K and each bit is repeated the same number of times, the second sequence with the length of N′ is obtained by continuously repeating each bit in the first sequence K times, where N′=K*M. In the second sequence, every K consecutive bits are obtained by repeating a single bit in the first sequence K times (which means that every K consecutive bits are obtained by upsampling or spreading).

For example, the first sequence includes 4 bits, which are {1, 0, 0, 1}, and the number of spreading times is 4. Then, the second sequence includes 16 bits, i.e., {1, 1, 1, 1, 0, 0, 0, 0, 0, 0, 0, 0, 1, 1, 1, 1}.

In some embodiments, in an example where the number of spreading times is K and the first M−1 bits are repeated the same number of times, the second sequence with the length of N′(N′=K*M) is obtained by continuously repeating each of the first M−1 bits in the first sequence K times and repeating the last bit N′−K*(M−1) times. In the second sequence, each of the first M−1 groups of sequences (each group having K consecutive bits) is obtained by spreading a single bit in the first sequence, and the last group of sequences (having N′−K*(M−1) consecutive bits) is obtained by spreading the last bit in the first sequence.

The modulation module 340 is configured to perform the time-frequency transformation on the second sequence to obtain frequency-domain data of N′ samples.

The discrete Fourier transform is performed on the second sequence with the length of N′ to obtain the frequency-domain data of N′ samples.

The modulation module 340 is configured to perform the fourth phase randomization based on the frequency-domain data of N′ samples to obtain frequency-domain data after the phase randomization.

The frequency-domain data includes M groups of frequency-domain data, each group of frequency-domain data includes frequency-domain data of K samples, or each of the first M−1 groups of frequency-domain data includes frequency-domain data of K samples, and the last group of frequency-domain data includes frequency-domain data of N′−K*(M−1) samples.

The frequency-domain data is obtained by performing the first processing and time-frequency transformation on the first sequence. Each group of frequency-domain data is obtained by performing the first processing and time-frequency transformation on a single bit in the first sequence.

In some embodiments, the fourth phase randomization may be performed in any one of the following three methods.

Method 1: the phase randomization is performed on each group of frequency-domain data in the frequency-domain data.

The phase randomization is performed individually on each group of frequency-domain data in the frequency-domain data.

In some embodiments, an associated phase randomization sequence is determined for each group of frequency-domain data in the frequency-domain data, and the phase randomization sequence associated with each group of frequency-domain data is independent; and each group of frequency-domain data is processed using the associated phase randomization sequence. For example, point multiplication is performed on each group of frequency-domain data and the associated phase randomization sequence.

In an example where the frequency-domain data includes M groups of frequency-domain data, an i-th phase randomization sequence is generated for an i-th group of frequency-domain data in the M groups of frequency-domain data, the i-th group of frequency-domain data is associated with the i-th phase randomization sequence, and the i-th group of frequency-domain data is multiplied by the i-th phase randomization sequence. A value of i is in a range of 0 to M−1, or the value of i is in a range of 1 to M.

Each phase randomization sequence includes at least two phase randomization factors, and a length of each phase randomization sequence is the same as that of the frequency-domain data associated with the phase randomization sequence. In some embodiments, the length of each phase randomization sequence is K. In some embodiments, the lengths of the phase randomization sequences associated with the first M−1 groups of frequency-domain data are K, and the length of the phase randomization sequence associated with the last group of frequency-domain data is N′−K*(M−1). In some other embodiments, the modulus of each phase randomization factor is 1.

For example, the frequency-domain data includes f_{i,1}, f_{i,2}, . . . , f_{i,k} (i=1, 2, . . . , M, and k=1, 2, . . . , K); the phase randomization sequence associated with the first group of frequency-domain data {f_{1,1}, f_{1,2}, . . . , f_{1,k}} is {x₁, x₂, x₃, x₄}, the phase randomization sequence associated with the second group of frequency-domain data {f_{2,1}, f_{2,2}, . . . , f_{2,k}} is {x₅, x₆, x₇, x₈}, the phase randomization sequence associated with the third group of frequency-domain data {f_{3,1}, f_{3,2}, . . . , f_{3,k}} is {x₉, x₁₀, x₁₁, x₁₂}, the phase randomization sequence associated with the fourth group of frequency-domain data {f_{4,1}, f_{4,2}, . . . , f_{4,k}} is {x₁₃, x₁₄, x₁₅, x₁₆}, and so on.

In some embodiments, an associated phase randomization factor is determined for each group of frequency-domain data in the frequency-domain data, and the phase randomization factor associated with each group of frequency-domain data is independent; and point multiplication is performed on each group of frequency-domain data and the associated phase randomization factor. In an example where the frequency-domain data includes M groups of frequency-domain data, an i-th phase randomization factor is generated for an i-th group of frequency-domain data in the M groups of frequency-domain data, the i-th group of frequency-domain data is associated with the i-th phase randomization factor, and the i-th group of frequency-domain data is multiplied by the i-th phase randomization factor. A value of i is in a range of 0 to M−1, or the value of i is in a range of 1 to M.

In some embodiments, the modulus of each phase randomization factor is 1.

For example, the frequency-domain data includes {f_{i,1}, f_{i,2}, . . . , f_{i,k}} (i =1, 2, . . . , M, and k=1, 2, . . . , K); the phase randomization sequence associated with the first group of frequency-domain data {f_{1,1}, f_{1,2}, . . . , f_{1,k}} is {x₁}, the phase randomization sequence associated with the second group of frequency-domain data {f_{2,1}, f_{2,2}, . . . , f_{2,k}} is {x₂}, the phase randomization sequence associated with the third group of frequency-domain data {f_{3,1}, f_{3,2}, . . . , f_{3,k}} is {x₃}, the phase randomization sequence associated with the fourth group of frequency-domain data {f_{4,1}, f_{4,2}, . . . , f_{4,k}} is {x₄}, and so on.

Method 2: the phase randomization is performed on each group of target frequency-domain data in the frequency-domain data, each group of target frequency-domain data being obtained by processing a bit with a first value in the first sequence.

The phase randomization is performed individually on each group of target frequency-domain data in the frequency-domain data.

In some embodiments, each group of target frequency-domain data is obtained by processing a single bit with a value of 1 in the first sequence.

In some embodiments, an associated phase randomization sequence is determined for each group of target frequency-domain data in the frequency-domain data, and the phase randomization sequence associated with each group of target frequency-domain data is independent; and each group of target frequency-domain data is processed using the associated phase randomization sequence. For example, point multiplication is performed on each group of target frequency-domain data and the associated phase randomization sequence. In an example where the frequency-domain data includes M groups of frequency-domain data, an i-th phase randomization sequence is generated for an i-th group of target frequency-domain data in the M groups of frequency-domain data, the i-th group of target frequency-domain data is associated with the i-th phase randomization sequence, and the i-th group of target frequency-domain data is multiplied by the i-th phase randomization sequence. A value of i is in a range of 0 to D−1, or the value of i is in a range of 1 to D. D is the number of groups of target frequency-domain data among the M groups of frequency-domain data.

Each phase randomization sequence includes at least two phase randomization factors, and a length of each phase randomization sequence is the same as that of the frequency-domain data associated with the phase randomization sequence. In some embodiments, the modulus of each phase randomization factor is 1.

In some embodiments, an associated phase randomization factor is determined for each group of target frequency-domain data in the frequency-domain data, and the phase randomization factor associated with each group of target frequency-domain data is independent; and each group of target frequency-domain data is processed using the associated phase randomization factor. For example, point multiplication is performed on each group of target frequency-domain data and the associated phase randomization factor.

In an example where the frequency-domain data includes M groups of frequency-domain data, an i-th phase randomization factor is generated for an i-th group of target frequency-domain data in the M groups of frequency-domain data, the i-th group of target frequency-domain data is associated with the i-th phase randomization factor, and the i-th group of target frequency-domain data is multiplied by the i-th phase randomization factor. A value of i is in a range of 0 to D−1, or the value of i is in a range of 1 to D. D is the number of groups of target frequency-domain data among the M groups of frequency-domain data.

In some embodiments, the modulus of each phase randomization factor is 1.

Method 3: the phase randomization is performed on frequency-domain data of all samples in the frequency-domain data.

The phase randomization is performed on the frequency-domain data of all samples in the frequency-domain data as a whole.

The frequency-domain data of N′ samples in the frequency-domain data is processed using a phase randomization sequence with a length of N′. For example, point multiplication is performed on the frequency-domain data of N′ samples in the frequency-domain data and the phase randomization sequence with the length of N′. The phase randomization sequence with the length of N′ includes N′ phase randomization factors.

In some embodiments, the modulus of each phase randomization factor is 1.

For example, the frequency-domain data includes {f_{i,1}, f_{i,2}, . . . , f_{i,k}} (i=1, 2, . . . , M, and k=1, 2, . . . , K), and the phase randomization sequence with the length of N″(N″=M*K) is {x_{i,1}, x_{i,2}, . . . , x_{i,k}}.

The phase randomization sequence includes N′ phase randomization factors; or the phase randomization sequence is a PN sequence; or the phase randomization sequence is a ZC sequence; or the phase randomization sequence is an M sequence; or the phase randomization sequence is a sequence with a peak to average power ratio (PAPR) less than a threshold, also known as a low PAPR sequence.

The modulation module 340 is configured to determine coefficients of N subcarriers based on the N′ frequency-domain data after the phase randomization, to obtain N frequency-domain data corresponding to the N subcarriers.

When N′=N, a coefficient of a j-th subcarrier is determined based on the j-th frequency-domain data after the phase randomization, where a value of j is in a range of 0 to N−1 or in a range of 1 to N; and the N frequency-domain data corresponding to the N subcarriers are obtained.

When N′>N, the N′ frequency-domain data after the phase randomization is truncated to frequency-domain data of N samples (for example, only the first or last N frequency-domain data after the phase randomization are taken); a coefficient of a j-th subcarrier is determined based on the j-th frequency-domain data after the phase randomization, where a value of j is in a range of 0 to N−1 or in a range of 1 to N; and the N frequency-domain data corresponding to the N subcarriers are obtained.

In some embodiments, the truncation of the frequency-domain data may also be performed before the fourth phase randomization, and then the fourth phase randomization is performed on the frequency-domain data of N samples.

The modulation module 340 is configured to perform the inverse time-frequency transformation on the N frequency-domain data corresponding to the N subcarriers, to obtain time-domain OOK symbol data of B samples.

The discrete inverse Fourier transform is performed on the N frequency-domain data corresponding to the N subcarriers, to obtain the time-domain OOK symbol data of B samples.

In some embodiments, B is an integer multiple of N. For example, N represents 48 subcarriers, and B represents time-domain OOK symbol data of 1024 samples.

The modulation module 340 is configured to obtain the M OOK symbols based on the time-domain OOK symbol data of B samples.

Each OOK symbol carries time-domain OOK symbol data of B/M samples.

In summary, in the device provided in the embodiments, energy flattening at the subcarrier level is achieved by performing the fourth phase randomization with each sample in the frequency-domain data as the granularity, thereby improving frequency selectivity and anti-interference capability.

### Optional Design 5

The modulation module 340 is configured to perform the sequence mapping on the first sequence to obtain a second sequence.

The first sequence includes M bits.

The sequence mapping is a mapping process that maps at least one bit in the first sequence to a phase randomization sequence. In some embodiments, the sequence mapping is a mapping process that maps each bit in the first sequence to a phase randomization sequence. In some embodiments, the sequence mapping is a mapping process that maps each of bits with a first value in the first sequence to a phase randomization sequence.

In some embodiments, each first bit in the M bits is mapped to a first mapping sequence, and each second bit in the M bits is mapped to a second mapping sequence. Here, the first bit is a bit with the first value, the second bit is a bit with a second value, and the first mapping sequence and the second mapping sequence are different phase randomization sequences.

The lengths of the first mapping sequence and the second mapping sequence are K, and K is equal to a rounded-up or rounded-down value of quotient of N divided by M.

N is the number of frequency-domain subcarriers used for generating the OOK symbols.

In some embodiments, the first mapping sequence includes K phase randomization factors; or the first mapping sequence is a ZC sequence; or the first mapping sequence is an m-sequence; or the first mapping sequence is a sequence with PAPR less than a threshold. Sequences with PAPR less than the threshold can be considered as low PAPR sequences other than the ZC sequence and m-sequence.

In some embodiments, the second mapping sequence is an all-zero sequence; or the second mapping sequence includes K phase randomization factors; or the second mapping sequence is a ZC sequence; or the second mapping sequence is an m-sequence; or the second mapping sequence is a sequence with PAPR less than a threshold.

In some embodiments, the sequence length K of each bit mapping in the first mapping sequence is first determined. Based on the number N of subcarriers allocated in the frequency-domain for generating OOK symbols and the number M of OOK symbols transmitted by each OFDM symbol, the sequence length K of each bit mapping is determined.

When N and M are divisible, K=N/M. When N and M are not divisible, K is equal to a rounded-up or rounded-down value of quotient of N divided by M (i.e., N/M).

For example, the first mapping sequence includes 4 bits, which are {1, 0, 0, 1}; the sequence associated with the first bit is seq1={x₁, x₂, x₃, x₄}, the sequence associated with the second bit is seq2={0, 0, 0, 0}, the sequence associated with the third bit is seq3={0, 0, 0, 0}, and the sequence associated with the fourth bit is seq4={x₅, x₆, x₇, x₈}.

In some embodiments, the first mapping sequences corresponding to different bits are different. In some embodiments, the first mapping sequences corresponding to different bits are the same.

In some embodiments, there are multiple candidate sequences for the first mapping sequence. When the sequence mapping is performed, the actual mapping candidate sequence is determined, based on a preset rule, for each bit with the value of 1 from multiple candidate sequences.

For example, there are 4 candidate sequences: candidate sequence 1, candidate sequence 2, candidate sequence 3, and candidate sequence 4; it is assumed that there are 8 bits with the value of 1 in the first sequence, and based on the sequential mapping rule, the candidate sequences corresponding to the bits with the value of 1 are: candidate sequence 1, candidate sequence 2, candidate sequence 3, candidate sequence 4, candidate sequence 1, candidate sequence 2, candidate sequence 3, candidate sequence 4; or based on the cyclic mapping rule, the candidate sequences corresponding to the bits with the value of 1 are: candidate sequence 1, candidate sequence 1, candidate sequence 2, candidate sequence 2, candidate sequence 3, candidate sequence 3, candidate sequence 4, candidate sequence 4. For example, when there is a need to use the first mapping sequence to carry the first information, the first mapping sequence is selected from multiple candidate sequences based on the first information to be transmitted; or the first mapping sequence is selected from multiple candidate sequences in a random manner.

The modulation module 340 is configured to perform the time-frequency transformation on the second sequence to obtain frequency-domain data of N′ samples.

The discrete Fourier transform is performed on the third sequence with the length of N′ to obtain the frequency-domain data of N′ samples.

The modulation module 340 is configured to determine coefficients of N subcarriers based on the frequency-domain data of N′ samples, to obtain N frequency-domain data corresponding to the N subcarriers.

When N′=N, a coefficient of a j-th subcarrier is determined based on frequency-domain data of a j-th sample, where a value of j is in a range of 0 to N−1 or in a range of 1 to N; and the N frequency-domain data corresponding to the N subcarriers are obtained.

When N′>N, the frequency-domain data of N′ samples is truncated to frequency-domain data of N samples (for example, only frequency-domain data of the first or last N samples are taken); a coefficient of a j-th subcarrier is determined based on frequency-domain data of a j-th sample, where a value of j is in a range of 0 to N−1 or in a range of 1 to N; and the N frequency-domain data corresponding to the N subcarriers are obtained.

The modulation module 340 is configured to perform the inverse time-frequency transformation on the N frequency-domain data corresponding to the N subcarriers, to obtain time-domain OOK symbol data of N samples.

The discrete inverse Fourier transform is performed on the N frequency-domain data corresponding to the N subcarriers, to obtain the time-domain OOK symbol data of N samples.

The modulation module 340 is configured to obtain the M OOK symbols based on the time-domain OOK symbol data of N samples.

Each OOK symbol carries time-domain OOK symbol data of K samples.

In summary, in the device provided in the embodiments, energy flattening at the subcarrier level or bit level is achieved by performing the phase randomization with the bit in the first sequence as the granularity in the sequence mapping manner, thereby improving frequency selectivity and anti-interference capability.

It should be noted that the phase randomization sequence/factor mentioned in the various embodiments of the present disclosure is as follows:
It can be one or more fixed sequences/factors, which are agreed upon or predefined by the communication protocol;
It can be generated by a sequence/factor generation method, which is agreed upon or predefined by the communication protocol;
It can be generated based on sequence/factor generation parameters, and the sequence/factor generation parameters are agreed upon or predefined by the communication protocol, or the sequence/factor generation parameters are pre-configured by the network device, or periodically configured by the network device, or semi-statically configured by the network device, or dynamically configured by the network device, where
the sequence/factor generation parameters include, but are not limited to: cyclic shift index, root index, etc.;
It can be a sequence determined based on terminal implementation.

Another point to note is that the phase randomization sequence mentioned in the various embodiments of the present disclosure can further be used to indicate the first information. For example, two bits/sequences are processed using a first phase randomization sequence and a second phase randomization sequence, respectively. The first phase randomization sequence is further used to indicate a type of first information, and the second phase randomization sequence is further used to indicate another type of first information, thereby achieving an effect similar to “symbiotic communication”.

In optional embodiments based on the above embodiments, the device further includes:
a transmitting module for transmitting the M OOK symbols.

FIG. 30 is a structural block diagram of an OOK modulation-based symbol receiving device provided in an exemplary embodiment of the present disclosure. The embodiment is described by taking an example where the method is executed by a recipient device, and the recipient device can be a network device, an AP, an ambient IoT device, or a terminal device. The device includes:
a receiving module 420, configured to perform envelope detection on M OOK symbols to obtain a first sequence with a length of Mₒ

The M OOK symbols undergo phase randomization during modulation, which is the OOK modulation as shown in FIGS. 8 to 24.

In some embodiments, the recipient device is a device with a first capability; and the recipient device performs the envelope detection on the M OOK symbols to obtain the first sequence with the length of M.

In some embodiments, the recipient device is a device with a second capability; and the recipient device not only performs the envelope detection on the M OOK symbols to obtain the first sequence with the length of M, but also detects the phase randomization sequence in the M OOK symbols, and determines first information associated with the phase randomization sequence based on the detected phase randomization sequence.

In some embodiments, the recipient device has two receivers: a first-stage receiver and a second-stage receiver. The first-stage receiver is configured to perform the envelope detection on the M OOK symbols to obtain the first sequence with the length of M. The second-stage receiver is configured to detect the phase randomization sequence in the M OOK symbols, and determine the first information associated with the phase randomization sequence based on the detected phase randomization sequence.

It should be noted that the device provided in the above embodiments is only illustrated by the division of the above functional modules when implementing its functions. In actual applications, the above functions may be assigned to different functional modules according to actual needs, that is, the content structure of the device may be divided into different functional modules to complete all or part of the functions described above.

Regarding the device in the above embodiments, the specific manner in which each module performs its operation has been described in detail in the embodiments related to the method, and will not be described in detail here.

FIG. 31 shows a schematic structural diagram of a communication device (an ambient IoT device, a terminal device, or a network device) provided in an embodiment of the present disclosure. The communication device may include: a processor 801, a receiver 802, a transmitter 803, a memory 804, and a bus 805.

The processor 801 includes one or more processing cores. The processor 801 executes various functional applications and information processing by running software programs and modules.

The receiver 802 and the transmitter 803 can be implemented as a transceiver 806, and the transceiver 806 can be a communication chip.

The memory 804 is connected to the processor 801 via the bus 805. The memory 804 can be configured to store a computer program, and the processor 801 is configured to execute the computer program to implement the various steps executed by the ambient IoT device, the terminal device, or the network device in the above method embodiments. The transceiver 806 can include the transmitter and the receiver. The transmitter is configured to implement the steps or functions related to transmission in the above method, the receiver is configured to implement the steps or functions related to reception in the above method, and the processor 801 is configured to implement the remaining steps or functions other than the transmission and reception.

In addition, the memory 804 may be implemented by any type of volatile or non-volatile storage device or a combination thereof, and the volatile or non-volatile storage device includes but is not limited to: RAM (random-access memory), ROM (read-only memory), EPROM (erasable programmable read-only memory), EEPROM (electrically erasable programmable read-only memory), flash memory or another solid-state storage technology, CD-ROM (compact disc read-only memory), DVD (digital video disc) or another optical storage, magnetic tape cassette, magnetic tape, or disk storage or another magnetic storage device.

The embodiments of the present disclosure further provide a computer-readable storage medium, the storage medium stores a computer program, and the non-transitory computer program is configured to be executed by a processor in the ambient IoT device, the terminal device, or the network device, to implement the various steps in the OOK modulation-based symbol generation method or the OOK modulation-based symbol receiving method.

In some embodiments, the non-transitory computer-readable storage medium may include ROM (read-only memory), RAM (random-access memory), SSD (solid state drive), or optical disc. RAMs may include ReRAM (resistance random access memory) and DRAM (dynamic random access memory).

The embodiments of the present disclosure further provide a chip, and the chip includes a programmable logic circuit and/or program instructions. When run on a terminal or a network device, the chip is configured to implement the OOK modulation-based symbol generation method or the OOK modulation-based symbol receiving method.

The embodiments of the present disclosure further provide a computer program product or computer program, the computer program product or computer program includes computer instructions stored in a non-transitory computer-readable storage medium; a processor of the terminal or network device reads the computer instructions from the non-transitory computer-readable storage medium and executes the computer instructions, to implement the OOK modulation-based symbol generation method or the OOK modulation-based symbol receiving method.

Those skilled in the art will recognize that, in one or more of the above examples, the functions described in the embodiments of the present disclosure may be implemented by hardware, software, firmware or any combination thereof. When implemented using software, these functions may be stored in a non-transitory computer-readable medium or may be transmitted as one or more instructions or codes on a non-transitory computer-readable medium. Computer-readable media include computer storage media and communication media, and the communication media include any medium that facilitates the transfer of computer programs from one place to another. The non-transitory storage medium may be any available medium that can be accessed by a general-purpose or special-purpose computer.

The above descriptions are merely exemplary embodiments of the present disclosure and are not intended to limit the present disclosure. Any modifications, equivalent substitutions, and improvements made within the spirit and principles of the present disclosure should be included within the protection scope of the present disclosure.

What is claimed is:

1. An on off keying (OOK) modulation-based symbol generation method, comprising:
obtaining a first sequence with a length of M, M being a positive integer; and
performing OOK modulation on the first sequence to obtain M OOK symbols;
wherein the OOK modulation comprises performing phase randomization during modulation.

2. The method according to claim 1, wherein performing OOK modulation on the first sequence to obtain M OOK symbols, comprises:
performing, on the first sequence, first phase randomization, first processing, time-frequency transformation, determination of subcarrier coefficients, and inverse time-frequency transformation in sequence to obtain the M OOK symbols; or
performing, on the first sequence, first processing, second phase randomization, time-frequency transformation, determination of subcarrier coefficients, and inverse time-frequency transformation in sequence to obtain the M OOK symbols; or
performing, on the first sequence, sequence mapping, time-frequency transformation, determination of subcarrier coefficients, and inverse time-frequency transformation in sequence to obtain the M OOK symbols, the sequence mapping being a mapping process that maps bits in the first sequence to a phase randomization sequence; or
performing, on the first sequence, first processing, time-frequency transformation, determination of subcarrier coefficients, inverse time-frequency transformation, and third phase randomization in sequence to obtain the M OOK symbols; or
performing, on the first sequence, first phase randomization, first processing, time-frequency transformation, determination of subcarrier coefficients, inverse time-frequency transformation, and third phase randomization in sequence to obtain the M OOK symbols; or
performing, on the first sequence, first processing, second phase randomization, time-frequency transformation, determination of subcarrier coefficients, inverse time-frequency transformation, and third phase randomization in sequence to obtain the M OOK symbols; or
performing, on the first sequence, sequence mapping, time-frequency transformation, determination of subcarrier coefficients, and inverse time-frequency transformation in sequence to obtain the M OOK symbols to obtain the M OOK symbols and third phase randomization, the sequence mapping being a mapping process that maps bits in the first sequence to a phase randomization sequence;
wherein the first processing is processing of converting each logical bit in the first sequence into a sequence with a length of K, and K is a positive integer greater than 1.

3. The method according to claim 2, wherein the first sequence comprises M bits;
the sequence mapping comprises:
mapping each first bit in the M bits to a first mapping sequence, and mapping each second bit in the M bits to a second mapping sequence;
wherein the first bit is a bit with a first value, and the second bit is a bit with a second value.

4. The method according to claim 3, wherein lengths of the first mapping sequence and the second mapping sequence are K, and K is equal to a rounded-up or rounded-down value of quotient of N divided by M;
wherein N is a number of frequency-domain subcarriers used for generating the OOK symbols.

5. The method according to claim 3, wherein
the first mapping sequence comprises K phase randomization factors; or
the first mapping sequence is a PN sequence; or
the first mapping sequence is a ZC sequence; or
the first mapping sequence is an m-sequence; or
the first mapping sequence is a sequence with PAPR less than a threshold.

6. The method according to claim 3, wherein
the second mapping sequence is an all-zero sequence; or
the second mapping sequence comprises K phase randomization factors; or
the second mapping sequence is a PN sequence; or
the second mapping sequence is a ZC sequence; or
the second mapping sequence is an m-sequence; or
the second mapping sequence is a sequence with PAPR less than a threshold.

7. The method according to claim 1, wherein the method further comprises:
adding a CP/GI to each of the M OOK symbols; or
adding a CP/GI to the M OOK symbols as a whole;
wherein the method further comprises:
processing a sequence with a length of L into at least one first sequence;
wherein L is greater than or equal to M.

8. The method according to claim 7, wherein the sequence with the length of L is any one of the following sequences:
an original sequence;
a first encoded sequence obtained by encoding the original sequence;
a first padding sequence with a length being an integer multiple of M obtained by performing bit-padding on the original sequence;
a second padding sequence with a length being an integer multiple of M obtained by performing bit-padding on the encoded sequence;
a second encoded sequence obtained by encoding the first padding sequence;
a sequence obtained by interleaving the original sequence;
a sequence obtained by interleaving the first encoded sequence;
a sequence obtained by interleaving the first padding sequence;
a sequence obtained by interleaving the second padding sequence; or
a sequence obtained by interleaving the second encoded sequence.

9. The method according to claim 1, wherein
M is agreed upon by a communication protocol; or
M is configured by the network device; or
M is determined based on a preset mapping relationship;
wherein a value of M comprises at least one of 1, 2, 4, 6, or 8.

10. A terminal, comprising: a memory, and a processor, wherein the memory is configured to store a program, and the program, when executed by the processor, enables the terminal to perform:
obtaining a first sequence with a length of M, M being a positive integer; and
performing OOK modulation on the first sequence to obtain M OOK symbols;
wherein the OOK modulation comprises performing phase randomization during modulation.

11. The terminal according to claim 10, wherein performing OOK modulation on the first sequence to obtain M OOK symbols, comprises:
performing, on the first sequence, first phase randomization, first processing, time-frequency transformation, determination of subcarrier coefficients, and inverse time-frequency transformation in sequence to obtain the M OOK symbols; or
performing, on the first sequence, first processing, second phase randomization, time-frequency transformation, determination of subcarrier coefficients, and inverse time-frequency transformation in sequence to obtain the M OOK symbols; or
performing, on the first sequence, sequence mapping, time-frequency transformation, determination of subcarrier coefficients, and inverse time-frequency transformation in sequence to obtain the M OOK symbols, the sequence mapping being a mapping process that maps bits in the first sequence to a phase randomization sequence; or
performing, on the first sequence, first processing, time-frequency transformation, determination of subcarrier coefficients, inverse time-frequency transformation, and third phase randomization in sequence to obtain the M OOK symbols; or
performing, on the first sequence, first phase randomization, first processing, time-frequency transformation, determination of subcarrier coefficients, inverse time-frequency transformation, and third phase randomization in sequence to obtain the M OOK symbols; or
performing, on the first sequence, first processing, second phase randomization, time-frequency transformation, determination of subcarrier coefficients, inverse time-frequency transformation, and third phase randomization in sequence to obtain the M OOK symbols; or
performing, on the first sequence, sequence mapping, time-frequency transformation, determination of subcarrier coefficients, and inverse time-frequency transformation in sequence to obtain the M OOK symbols to obtain the M OOK symbols and third phase randomization, the sequence mapping being a mapping process that maps bits in the first sequence to a phase randomization sequence;
wherein the first processing is processing of converting each logical bit in the first sequence into a sequence with a length of K, and K is a positive integer greater than 1.

12. The terminal according to claim 11, wherein the first sequence comprises M bits, and the first phase randomization comprises:
performing the phase randomization on each of the M bits; or
performing the phase randomization on target bit(s) in the M bits; or
performing the phase randomization on the M bits.

13. The terminal according to claim 11, wherein the second phase randomization comprises:
performing the phase randomization on each group of sequences in the second sequence, wherein the second sequence is obtained by performing the first processing on the first sequence, and each group of sequences is obtained by performing the first processing on a single bit in the first sequence; or
performing the phase randomization on each group of target sequences in the second sequence, wherein the second sequence is obtained by performing the first processing on the first sequence; the second sequence comprises at least one group of sequences, and each group of sequences is obtained by performing the first processing on a bit in the first sequence; and the group of target sequences is a sequence obtained by performing the first processing on a target bit with a first value in the first sequence; or
performing the phase randomization on all bits in the second sequence, wherein the second sequence is obtained by performing the first processing on the first sequence.

14. The terminal according to claim 11, wherein the first sequence comprises M bits;
the sequence mapping comprises:
mapping each first bit in the M bits to a first mapping sequence, and mapping each second bit in the M bits to a second mapping sequence;
wherein the first bit is a bit with a first value, and the second bit is a bit with a second value.

15. The terminal according to claim 14, wherein lengths of the first mapping sequence and the second mapping sequence are K, and K is equal to a rounded-up or rounded-down value of quotient of N divided by M;
wherein N is a number of frequency-domain subcarriers used for generating the OOK symbols.

16. The terminal according to claim 14, wherein
the first mapping sequence comprises K phase randomization factors; or
the first mapping sequence is a PN sequence; or
the first mapping sequence is a ZC sequence; or
the first mapping sequence is an m-sequence; or
the first mapping sequence is a sequence with PAPR less than a threshold; and/or
wherein the second mapping sequence is an all-zero sequence; or
the second mapping sequence comprises K phase randomization factors; or
the second mapping sequence is a PN sequence; or
the second mapping sequence is a ZC sequence; or
the second mapping sequence is an m-sequence; or
the second mapping sequence is a sequence with PAPR less than a threshold.

17. The terminal according to claim 11, wherein the program, when executed by the processor, enables the terminal further to perform:
adding a CP/GI to each of the M OOK symbols, or adding a CP/GI to the M OOK symbols as a whole; and
processing a sequence with a length of L into at least one first sequence, wherein L is greater than or equal to M.

18. The terminal according to claim 17, wherein the sequence with the length of L is any one of the following sequences:
an original sequence;
a first encoded sequence obtained by encoding the original sequence;
a first padding sequence with a length being an integer multiple of M obtained by performing bit-padding on the original sequence;
a second padding sequence with a length being an integer multiple of M obtained by performing bit-padding on the encoded sequence;
a second encoded sequence obtained by encoding the first padding sequence;
a sequence obtained by interleaving the original sequence;
a sequence obtained by interleaving the first encoded sequence;
a sequence obtained by interleaving the first padding sequence;
a sequence obtained by interleaving the second padding sequence; or
a sequence obtained by interleaving the second encoded sequence.

19. The terminal according to claim 10, wherein
M is agreed upon by a communication protocol; or
M is configured by the network device; or
M is determined based on a preset mapping relationship;
wherein a value of M comprises at least one of 1, 2, 4, 6, or 8.

20. A chip, wherein the chip comprises a programmable logic circuit and/or program instructions, and when run on a terminal or a network device, the chip is configured to perform:
obtaining a first sequence with a length of M, M being a positive integer; and
performing OOK modulation on the first sequence to obtain M OOK symbols;
wherein the OOK modulation comprises performing phase randomization during modulation.
